(19) United States
(12) Patent Application Publication
(10) Pub. No.: US 2026/0303775 A1
(43) Pub. Date: Oct. 1, 2026

(54) ELECTRONIC DEVICE AND OPERATING METHOD OF THE SAME

(71) Applicant: SAMSUNG ELECTRIONICS CO., LTD., Suwon-si (KR)

(72) Inventors: Youngjin JO, Suwon-si (KR); Jaesung LEE, Suwon-si (KR); Hanjin PARK, Suwon-si (KR); Youngmin KIM, Suwon-si (KR); Daeyeong KIM, Suwon-si (KR)

(73) Assignee: SAMSUNG ELECTRIONICS CO., LTD., Suwon-si (KR)

(21) Appl. No.: 19/639,971

(22) Filed: Apr. 6, 2026

Related U.S. Application Data
(63) Continuation of application No. PCT/KR2026/004745, filed on Mar. 25, 2026.

(30) Foreign Application Priority Data
Mar. 28, 2025 (KR) 10-2025-0040479

(51) Int. Cl. H04N 13/344; G01M 11/02; H04N 13/00; H04N 13/327; H04N 13/383; H04N 13/398

(52) U.S. Cl. CPC H04N 13/344; G01M 11/0228; H04N 13/327; H04N 13/383; H04N 13/398; H04N 2013/0081

(57) ABSTRACT

An electronic device is configured to: obtain a depth map corresponding to an input image, segment the depth map into a plurality of depth areas, determine, based on a lens formula, focal lengths of a plurality of lenses corresponding to each of the plurality of depth areas, obtain voltage values to be applied to the plurality of lenses, respectively, based on the determined focal lengths of the plurality of lenses, and provide an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

### CROSS-REFERENCE TO RELATED APPLICATIONS

This application is a Continuation application of International Application PCT/KR2026/004745 filed on Mar. 25, 2026, which claims benefit of Korean Patent Application No. 10-2025-0040479, filed on Mar. 28, 2025, at the Korean Intellectual Property Office, the disclosures of which are incorporated herein in their entireties by reference.

### BACKGROUND

### 1. Field

The disclosure relates to an electronic device, an operating method of the electronic device, and a computer-readable recording medium having recorded thereon a program for executing the operating method on a computer. More particularly, the disclosure relates to an electronic device capable of providing a three-dimensional (3D) image, an operating method of the electronic device, and a computer-readable recording medium having recorded thereon a program for executing the operating method on a computer.

### 2. Description of Related Art

With advancements in electronic technologies, various types of electronic devices are being developed and supplied. An electronic device including a display apparatus for displaying an image has rapidly advanced in recent years.

As the electronic device has advanced, types of an image displayed on the electronic device have become varied. An electronic device capable of displaying not only a two-dimensional (2D) image but also displaying a three-dimensional (3D) image is being developed.

Recently, in order to display a 3D image, an electronic device and method for displaying the 3D image by using a refractive characteristic of a liquid crystal lens, including a lenticular lens or the like, have been proposed. An electronic device has been developed that provides a user with a stereoscopic image by using a liquid crystal lens to provide different images to the user's left and right eyes, respectively.

### SUMMARY

In one or more examples, an electronic device for providing a three-dimensional (3D) image includes: a display; a lens array comprising a plurality of lenses; at least one processor; and memory storing a plurality of instructions, in which the plurality of instructions, when executed by the at least one processor individually or collectively, cause the electronic device to: obtain a depth map corresponding to an input image, segment the depth map into a plurality of depth areas, determine, based on a lens formula, focal lengths of a plurality of lenses corresponding to each of the plurality of depth areas, obtain voltage values to be applied to the plurality of lenses, respectively, based on the determined focal lengths of the plurality of lenses, and provide an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

According to an aspect of the disclosure, an operating method of an electronic device for providing a three-dimensional (3D) image and including a display and a lens array comprising a plurality of lenses, the operating method including: obtaining a depth map corresponding to an input image; segmenting the depth map into a plurality of depth areas, based on a plurality of depth sections; determining, based on a lens formula, focal lengths of a plurality of lenses corresponding to each of the plurality of depth areas; obtaining voltage values to be applied to the plurality of lenses, respectively, based on the determined focal lengths of the plurality of lenses; and providing an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

According to an aspect of the disclosure, a non-transitory computer-readable recording medium having instructions stored therein, which when executed by a processor in an electronic device cause the electronic device to execute a method including: obtaining a depth map corresponding to an input image; segmenting the depth map into a plurality of depth areas, based on a plurality of depth sections; determining, based on a lens formula, focal lengths of a plurality of lenses corresponding to each of the plurality of depth areas; obtaining voltage values to be applied to the plurality of lenses, respectively, based on the determined focal lengths of the plurality of lenses; and providing an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

The technical features aimed to be achieved in the disclosure are not limited to the aforementioned features, and other unstated technical features will be clearly understood by one of ordinary skill in the art in view of descriptions below.

### BRIEF DESCRIPTION OF DRAWINGS

The disclosure will now be described more fully through the detailed descriptions below with reference to the accompanying drawings, in which reference numerals denote structural elements.

FIG. 1 is a diagram for describing an operation of an electronic device according to one or more embodiments of the disclosure.

FIG. 2 is a block diagram for describing a configuration of an electronic device according to one or more embodiments of the disclosure.

FIG. 3 is a flowchart for describing operations of an electronic device according to one or more embodiments of the disclosure.

FIG. 4A is a diagram for describing an operation in which an electronic device extracts and segments a depth map into a plurality of depth areas, according to one or more embodiments of the disclosure.

FIG. 4B is a diagram for describing an operation in which an electronic device segments a depth map into a plurality of depth areas, according to one or more embodiments of the disclosure.

FIG. 5 is a diagram for describing an operation in which an electronic device determines focal lengths of a plurality of lenses, according to one or more embodiments of the disclosure.

FIG. 6A is a diagram for describing a configuration of a lens array of an electronic device according to one or more embodiments of the disclosure.

FIG. 6B is a diagram for describing a configuration of a lens array of an electronic device according to one or more embodiments of the disclosure.

FIG. 6C is a diagram for describing an operation in which an electronic device obtains voltage values to be applied to a plurality of lenses, according to one or more embodiments of the disclosure.

FIG. 6D is a diagram for describing an operation in which an electronic device obtains voltage values to be applied to a plurality of lenses, according to one or more embodiments of the disclosure.

FIG. 7 is a diagram for describing an operation in which an electronic device provides an image that is represented in multiple depths over a plurality of different focal planes, according to one or more embodiments of the disclosure.

FIG. 8 is a flowchart for describing an operation in which an electronic device displays a corrected image, according to one or more embodiments of the disclosure.

FIG. 9 is a flowchart for describing an operation in which an electronic device displays a corrected image, according to one or more embodiments of the disclosure.

FIG. 10 is a flowchart for describing an operation in which an electronic device changes a range of depth areas, according to one or more embodiments of the disclosure.

FIG. 11A is a diagram illustrating an example of consecutive frames included in an input image, according to one or more embodiments of the disclosure.

FIG. 11B is a flowchart for describing a method, performed by an electronic device, of changing a range of depth areas, according to one or more embodiments of the disclosure.

FIG. 12 is a flowchart for describing an operation in which an electronic device changes a range of depth areas or a depth area corresponding to a reference point, according to one or more embodiments of the disclosure.

FIG. 13 is a diagram for describing an operation in which an electronic device changes a range of depth areas, according to one or more embodiments of the disclosure.

FIG. 14A is a diagram for describing an operation in which an electronic device changes a depth area corresponding to a reference point, according to one or more embodiments of the disclosure.

FIG. 14B is a diagram for describing an operation in which an electronic device changes a depth area corresponding to a reference point, according to one or more embodiments of the disclosure.

FIG. 15 is a flowchart for describing an operation in which an electronic device corrects a focal length of a lens, based on an off-axis angle, according to one or more embodiments of the disclosure.

FIG. 16 is a flowchart for describing an operation in which an electronic device corrects focal lengths of a plurality of lenses, based on off-axis angles at the plurality of lenses, according to one or more embodiments of the disclosure.

FIG. 17 is a flowchart for describing an operation in which an electronic device applies voltage to a plurality of segmented electrodes included in a lens array, according to one or more embodiments of the disclosure.

FIG. 18A is a diagram for describing a plurality of segmented electrodes included in a lens array of an electronic device, according to one or more embodiments of the disclosure.

FIG. 18B is a diagram for describing an operation in which an electronic device applies voltage to a plurality of segmented electrodes, according to one or more embodiments of the disclosure.

FIG. 19A is a diagram for describing a plurality of segmented electrodes included in a lens array of an electronic device, according to one or more embodiments of the disclosure.

FIG. 19B is a diagram for describing a plurality of segmented electrodes included in a lens array of an electronic device, according to one or more embodiments of the disclosure.

FIG. 20A is a diagram for describing a plurality of lenticular lenses included in a lens array of an electronic device, according to one or more embodiments of the disclosure.

FIG. 20B is a diagram for describing a plurality of lenticular lenses included in a lens array of an electronic device, according to one or more embodiments of the disclosure.

FIG. 21 is a flowchart for describing an operation in which an electronic device displays corrected images based on temporal multiplexing, according to one or more embodiments of the disclosure.

FIG. 22A is a flowchart for describing an operation in which an electronic device displays corrected images based on temporal multiplexing, according to one or more embodiments of the disclosure.

FIG. 22B is a flowchart for describing an operation in which an electronic device displays corrected images based on temporal multiplexing, according to one or more embodiments of the disclosure.

FIG. 23 is a block diagram for describing a configuration of an electronic device according to one or more embodiments of the disclosure.

FIG. 24A is a diagram for describing an operation in which an electronic device provides an image, according to one or more embodiments of the disclosure.

FIG. 24B illustrates an example of an image displayed via an electronic device, according to one or more embodiments of the disclosure.

FIG. 25A is a diagram for describing a configuration of an electronic device according to one or more embodiments of the disclosure.

FIG. 25B is a diagram for describing a configuration of a polarization control array of an electronic device, according to one or more embodiments of the disclosure.

FIG. 25C is a diagram for describing voltage control of a polarization control array and a lens array of an electronic device, according to one or more embodiments of the disclosure.

FIG. 26 is a diagram for describing a configuration of an electronic device according to one or more embodiments of the disclosure.

### DETAILED DESCRIPTION

Terms used in the disclosure will be briefly described, and then an embodiment of the disclosure will be described in detail.

Throughout the disclosure, the expression “or” is inclusive and not exclusive, as long as there is no particular opposing recitation. Thus, the expression “A or B” may refer to “A, B, or both” as long as it is not inconsistent with the context.

As used in the disclosure, the expression “at least one of a, b, or c” may indicate only a, only b, only c, both a and b, both a and c, both b and c, all of a, b, and c, or variations thereof.

Although the terms used in the disclosure are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used in the disclosure are not merely designations of the terms, but the terms are defined based on the meaning of the terms and content throughout the disclosure.

As used herein, the singular forms “a,” “an,” and “the” may include the plural forms as well, unless the context clearly indicates otherwise. All the terms used in the present specification, including technical and scientific terms, may have the same meanings as those generally understood by one of skill in the art of the disclosure.

Also, in the disclosure, when a part “includes” or “comprises” an element, unless there is a particular description contrary thereto, the part can further include other elements, not excluding the other elements. Also, the terms such as “ . . . unit,” “module,” or the like used in the disclosure indicate a unit, which processes at least one function or operation, and the unit may be implemented by hardware or software, or by a combination of hardware and software.

The expression “configured to (or set to)” used in the disclosure may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “system configured to . . . ” may mean that the system is “capable of . . . ” along with other devices or parts. For example, “a processor configured (or set) to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in memory.

Also, in the disclosure, it should be understood that when elements are “connected” or “coupled” to each other, the elements may be directly connected or coupled to each other, but may alternatively be connected or coupled to each other with an element therebetween, unless specified otherwise.

It should be understood that blocks in each flowchart, and combinations of flowcharts may be performed by one or more computer programs including computer-executable instructions. The one or more computer programs may be all stored in a single memory unit, or may be divided and stored in a plurality of different memory units.

The specification uses the terms of degree including “substantially” or “about.” In one or more examples, when specifying that a parameter X may be substantially the same as parameter Y, the term “substantially” may be understood as X being within 10% of Y. In one or more examples, when specifying that a parameter is about X, the term “about” may be understood as being within 10% of X.

All functions or operations described herein may be performed by a single processor or a combination of processors.

Hereinafter, embodiments of the disclosure will be described in detail with reference to the accompanying drawings to allow one of skill in the art to easily carry out the embodiments. However, an embodiment of the disclosure may be embodied in many different forms and should not be construed as being limited to the embodiment of the disclosure set forth herein. In addition, in the drawings, parts irrelevant to the description are omitted to clearly describe an embodiment of the disclosure, and like elements are denoted by like reference numerals throughout the disclosure.

Hereinafter, embodiments of the disclosure will be described in detail with reference to the drawings.

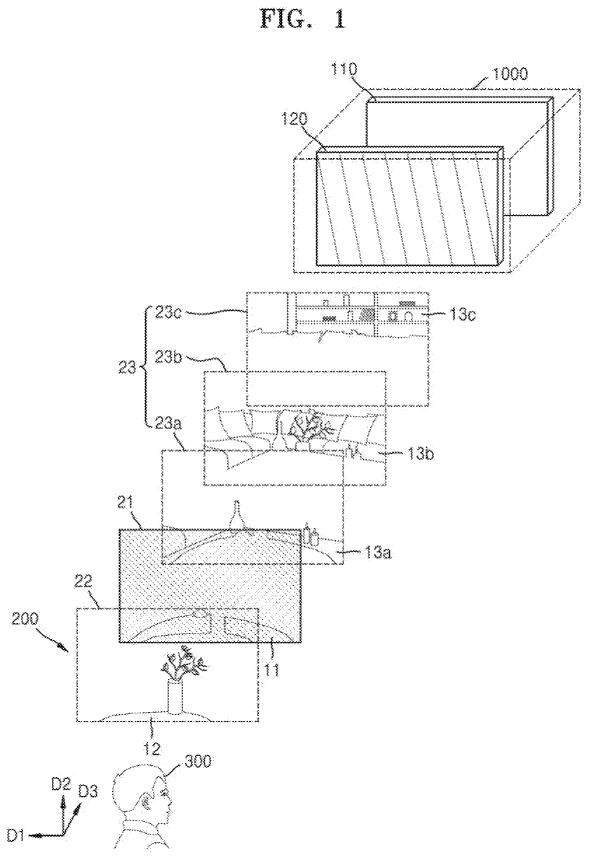

FIG. 1 is a diagram for describing an operation of an electronic device 1000 according to an embodiment of the disclosure.

Referring to FIG. 1, the electronic device 1000 according to an embodiment of the disclosure may be a device for providing an image 200 to a user 300.

In an embodiment of the disclosure, the electronic device 1000 may be implemented as various types of the electronic device 1000, such as a mobile device, a smart phone, a monitor, a laptop computer, a tablet personal computer (PC), a wearable device, a head-mounted display (HMD) device, or a digital signage.

In an embodiment of the disclosure, the electronic device 1000 may include a display 110 and a lens array 120. In an embodiment of the disclosure, the electronic device 1000 may display an image 200 via the display 110. In an embodiment of the disclosure, the image 200 provided by the electronic device 1000 may be an image capable of providing a three-dimensional (3D) effect to the user 300 who is using the electronic device 1000. In one or more examples, an image capable of providing a 3D effect to the user 300 may be expressed as a 3D image.

In an embodiment of the disclosure, the image 200 provided to the user 300 may include images that are provided by being refracted into two or more different views by the lens array 120.

In an embodiment of the disclosure, the lens array 120 may include a lenticular lens including a plurality of lenses. In one or more examples, a lenticular lens may be an array of lenses designed so that when viewed from different angles, different parts of an image are shown. In an embodiment of the disclosure, each of the plurality of lenses may provide images refracted into two or more different views. A plurality of input images displayed on the display 110 may be refracted via the lenticular lens and then may be provided as the image 200 to the user 300.

In an embodiment of the disclosure, the plurality of input images may be images obtained by photographing a real-world object from different views, respectively. However, the disclosure is not limited thereto, and the plurality of input images may be images generated to provide an image of an object at different views, respectively.

In one or more examples, a ‘view’ may correspond to a position at which the user 300 may view another side of an object included in the image 200 provided via the electronic device 1000. However, the disclosure is not limited thereto, and a ‘view’ may correspond to positions of a left eye and right eye of the user 300 which may watch other surfaces of an object included in the image 200 provided via the electronic device 1000.

In an embodiment of the disclosure, in two input images obtained from adjacent views, a position of a first pixel having a particular depth value and included in any one first input image may be different from a position of a second pixel in a second input image, the second pixel corresponding to a first pixel included in the second input image. In an embodiment of the disclosure, a difference between positions of two pixels within two input images obtained from adjacent views, the two pixels corresponding to each other and having particular depth values within the two input images, may be defined as “disparity.”

In an embodiment of the disclosure, the image 200 provided via the electronic device 1000 may be provided so that the user 300 may view different sides of the object included in the image 200 at a plurality of views, according to respective positions of the user 300 looking at the electronic device 1000. In an embodiment of the disclosure, the image 200 provided by the electronic device 1000 to the user 300 may vary according to positions of the user 300. In one or more examples, as a plurality of images having disparity are provided to the user 300 as a position of the user 300 changes, the user 300 may feel a 3D effect from the image 200 provided by the electronic device 1000.

In an embodiment of the disclosure, there may be disparity between images respectively provided to the left eye and right eye of the user 300. In an embodiment of the disclosure, the electronic device 1000 may provide images having disparity therebetween to the left eye and right eye of the user 300. In an embodiment of the disclosure, the user 300 may feel a 3D effect from the image 200 by feeling binocular disparity via the images with disparity respectively provided to the left eye and right eye.

Hereinafter, for convenience of descriptions, the plurality of input images will now be described as two input images obtained from views corresponding to the left eye and right eye of the user 300. In addition, the electronic device 1000 will be described as providing the image 200 to the left eye and right eye of the user 300 via the display 110 and the lens array 120.

In an embodiment of the disclosure, each of the two input images may include at least one an object having various depth values. In this regard, the object may include various things such as people, animals, objects, and natural objects, and is not limited to any one of them. A depth value of the object included in each of the two input images may be a reference value (e.g., “0”), or may have a value less than the reference value or greater than the reference value.

An object 11 having a depth value of the reference value may be perceived by the user 300 as being located on a plane parallel to the electronic device 1000 (e.g., a screen of the electronic device 1000) in the image 200. The plane parallel to the electronic device 1000 may be a plane defined by a first direction D1 and a second direction D2. A normal line direction perpendicular to the plane defined by the first direction D1 and the second direction D2 may be a third direction D3.

An object 12 having a depth less than a depth of the reference value may be perceived by the user 300 as being located closer to the user 300 than the electronic device 1000 in the image 200. Objects 13a, 13b, and 13c, each having depths greater than the reference value, may be perceived by the user 300 as being located farther from the user 300 than the electronic device 1000 in the image 200.

In an embodiment of the disclosure, an angle at which the plurality of input images are respectively refracted via the plurality of view areas of the lens array 120 may be determined based on characteristics of the display 110 (e.g., a resolution, sizes of the plurality of pixels, an arrangement thereof, etc.), characteristics of the lens array 120 (e.g., a refractive index, shapes of lenses, an arrangement thereof, etc.), an arrangement relation between the display 110 and the lens array 120, or any other suitable characteristics known to one of ordinary skill in the art.

In one or more embodiments of the disclosure, the lens array 120 may provide a plurality of focal planes 21, 22, and 23 (also referred to as the first, second, and third focal planes 21, 22, and 23) located at different depths. A ‘focal plane’ may indicate a plane on which light that has passed through a lens is focused or collected, and an image of an object may be clearly formed on the place (focal plane).

In an embodiment of the disclosure, the plurality of lenses included in the lens array 120 may provide different focal planes 21, 22, and 23. In the disclosure, the different focal planes 21, 22, and 23 may indicate the focal planes 21, 22, and 23 formed at different depths. In one or more examples, the different focal planes 21, 22, and 23 may indicate focal planes 21, 22, and 23 of which distances from the user 300 to the electronic device 1000 in the third direction D3 are different from each other. The plurality of lenses included in the lens array 120 are capable of electrically changing a focal length. For example, an array of the plurality of lenses included in the lens array 120 may be changed according to voltage. Therefore, the plurality of lenses included in the lens array 120 may have different focal lengths to provide the different focal planes 21, 22, and 23.

In an embodiment of the disclosure, some of the plurality of lenses may form the first focal plane 21. The object 11 having the depth of the reference value may be displayed on the first focal plane 21.

In an embodiment of the disclosure, some of the plurality of lenses may form the second focal plane 22. The second focal plane 22 may be formed closer to the user 300 than the display 110. For example, the second focal plane 22 may be formed closer to the user 300 than the first focal plane 21. The object 12 having the depth less than the reference value may be displayed on the second focal plane 22.

FIG. 1 illustrates an example in which the second focal plane 22 is formed at a single depth. However, as understood by one of ordinary skill in the art, the embodiments of the disclosure are not limited to these configurations. For example, the second focal plane 22 may be formed as a plurality of focal planes located at different depths.

In one or more embodiments of the disclosure, some of the plurality of lenses may form the third focal plane 23. The third focal plane 23 may be formed farther from the user 300 than the display 110. That is, the third focal plane 23 may be formed farther from the user 300 than the first focal plane 21. The objects 13a, 13b, and 13c having depths greater than the reference value may be displayed on the third focal plane 23.

FIG. 1 illustrates an example in which the third focal plane 23 is formed as three focal planes 23a, 23b, and 23c located at different depths, but an embodiment of the disclosure is not limited thereto. For example, the third focal plane 23 may be formed at a single depth, and the number of a plurality of focal planes located at different depths may vary.

In one or more embodiments of the disclosure, the electronic device 1000 may provide the focal planes 21, 22, and 23 having different depths, and thus, may display the image 200 having multiple depths over the focal planes 21, 22, and 23. Accordingly, the electronic device 1000 may improve a resolution in an entire depth range, and may provide clear images of objects in all depths in the image 200.

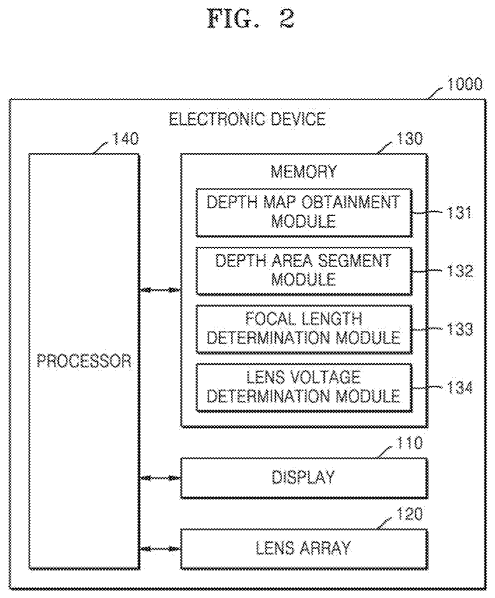

FIG. 2 is a block diagram for describing a configuration of the electronic device 1000 according to an embodiment of the disclosure.

Referring to FIG. 2, in an embodiment of the disclosure, the electronic device 1000 may include the display 110, the lens array 120, memory 130, and a processor 140. The electronic device 1000 may be embodied with more elements than the elements shown in FIG. 2 or may be embodied with fewer elements than the shown elements. The display 110, the lens array 120, the memory 130, and the processor 140 may be electrically and/or physically connected to each other.

The display 110 may display various types of content such as text, images, videos, icons, or symbols. According to an embodiment of the disclosure, the display 110 may include at least one of a liquid-crystal display (LCD), a light-emitting diode (LED) display, an organic LED (OLED) display, a micro-LED display, a digital micromirror device (DMD), or a liquid-crystal-on-silicon (LCoS) display. However, the disclosure is not limited thereto, and the display 110 may include other types of displays capable of providing an output image to a user.

The lens array 120 may include a viewing zone separator such as a liquid-crystal lens, which allows a user to view different images according to viewing positions. The liquid-crystal lens may include a plurality of lenses. For example, the plurality of lenses may be a plurality of lenticular lenses. The lens array 120 may include a plurality of lenticular lenses having different pattern angles to achieve a precise parallax.

In an embodiment of the disclosure, the plurality of lenses included in the lens array 120 may include liquid-crystal materials aligned in a particular direction. An array form of the liquid-crystal materials included in the plurality of lenses may vary according to voltage applied to the lens array 120. Accordingly, a refractive index of the plurality of lenses may vary according to voltage applied thereto. Therefore, focal lengths of the plurality of lenses may vary according to the voltage applied thereto.

In an embodiment of the disclosure, lenses to which voltage is not applied may provide a two-dimensional (2D) image to a user. In the disclosure, the 2D image may indicate an image perceived by the user as being located on a plane parallel to the electronic device 1000 (e.g., a screen of the electronic device 1000). The liquid-crystal lens may further include a resin layer covering the plurality of lenses. A refractive index of lenses to which voltage is not applied may be substantially equal to a refractive index of the resin layer. Accordingly, light that passes through the lenses to which voltage is not applied may not be refracted in the lens array 120, and thus, may provide a 2D image to the user.

In an embodiment of the disclosure, lenses to which voltage is applied may provide a 3D image to the user. A refractive index of the lenses to which voltage is applied may change differently from the refractive index of the resin layer. Accordingly, light that passes through the lenses to which voltage is applied may be refracted in the lens array 120, and thus, may provide a 3D image to the user.

In an embodiment of the disclosure, the electronic device 1000 may control, with respect to each of the plurality of lenses, voltage to be applied to the plurality of lenses. The electronic device 1000 may set focal lengths of the plurality of lenses to differ according to an image to be output. Therefore, the electronic device 1000 may provide an image represented with multiple depths over focal planes located at different depths.

In an embodiment of the disclosure, the liquid-crystal lens may further include the resin layer covering the plurality of lenses, and the liquid-crystal materials may be included in the resin layer. An array form of the liquid-crystal materials included in the resin layer may vary according to voltage applied to the lens array 120. Accordingly, a refractive index of the resin layer may vary based on voltage applied to each area of the resin layer. Therefore, as a refraction degree of light that passes through the plurality of lenses varies based on voltage applied to each area of the resin layer varies, focal lengths of the plurality of lenses may also vary according to each area.

In an embodiment of the disclosure, the memory 130 may include at least one of flash memory-type memory, hard disk-type memory, multimedia card micro-type memory, card-type memory (e.g., SD or XD memory), random-access memory (RAM), static RAM (SRAM), read-only memory (ROM), electrically erasable programmable ROM (EEPROM), programmable ROM (PROM), mask ROM, flash ROM, a hard disk drive (HDD), or a solid-state drive (SSD). Instructions or program code for performing functions or operations of the electronic device 1000 may be stored in the memory 130. Instructions, algorithms, data structures, program code, and application programs stored in the memory 130 may be implemented in a programming or scripting language, such as C, C++, Java, or assembler.

In an embodiment of the disclosure, the memory 130 may store various types of modules that may be used to provide an output image to a user via the display 110. For example, the memory 130 may store a depth map obtainment module, a depth area segment module, a focal length determination module, and a lens voltage determination module. However, the modules shown in FIG. 2 are not essential modules. More modules than those shown in FIG. 2 may be stored in the memory 130.

A ‘module’ included in the memory 130 may refer to a unit that processes a function or operation performed by the processor 140. A ‘module’ included in the memory 130 may be implemented as software, such as instructions, algorithms, data structures, or program code. In one or more examples, a ‘module’ may be hardware with circuitry configured to perform the functions of the module.

In an embodiment of the disclosure, a depth map obtainment module 131 may be configured of instructions or program code related to an operation or function for obtaining a depth map, based on an input image. For example, the depth map obtainment module 131 may be configured of instructions or program code related to an operation or function for obtaining a depth map, based on a plurality of input images corresponding to a plurality of viewpoints. In one or more examples, the depth map obtainment module 131 may be configured of instructions or program code related to an operation or function for obtaining a depth map, based on a plurality of input images corresponding to a single viewpoint. However, the disclosure is not limited thereto, and the depth map obtainment module 131 may be configured of various instructions or program code configured to perform an operation of obtaining a depth map based on an input image.

In an embodiment of the disclosure, the depth map obtainment module 131 may include an artificial intelligence (AI) model. The AI model included in the depth map obtainment module 131 may include a machine learning or deep learning model. In an embodiment of the disclosure, the AI model included in the depth map obtainment module 131 may include a convolutional neural network (CNN) or a transformer, and may be an AI model trained to infer a depth map including depth information by receiving the plurality of input images as an input.

However, in an embodiment of the disclosure, the electronic device 1000 may receive a depth map corresponding to an input image via an input/output interface or a communication interface.

In an embodiment of the disclosure, a depth area segment module 132 may include instructions or program code related to an operation or function for segmenting a depth map into a plurality of depth areas. For example, the depth area segment module 132 may determine a plurality of depth sections, based on the depth map. The depth area segment module 132 may segment the depth map into the plurality of depth areas, based on the determined plurality of depth sections.

In an embodiment of the disclosure, a focal length determination module 133 may include instructions or program code related to an operation or function for determining focal lengths of a plurality of lenses corresponding to each of the plurality of depth areas. For example, the focal length determination module 133 may determine a focal length of a lens, which corresponds to each depth area, based on the lens formula.

The lens formula provides a mathematical relation among a focal length of a lens, a distance between an object and the lens, and a distance between an image and the lens. The focal length determination module 133 may include instructions or program code for calculating a focal length of a lens by using Equation 1 below.

$$\frac{1}{f} = \frac{1}{{d}_{0}} + \frac{1}{{d}_{i}} \qquad Equation 1$$

In the above formula, f indicates a focal length of a lens, d₀ indicates a distance between lenses (also referred to as an object distance), and dᵢ indicates a distance between an image and a lens (also referred to as an image distance).

In an embodiment of the disclosure, a lens voltage determination module 134 may include instructions or program code related to an operation or function for determining voltage values to be respectively applied to the plurality of lenses, based on the focal lengths of the plurality of lenses. For example, the lens voltage determination module 134 may determine the voltage values to be respectively applied to the plurality of lenses to allow the plurality of lenses to each have a determined focal length. For example, the lens voltage determination module 134 may determine voltage to be applied to the plurality of lenses, in consideration of a change in a refractive index of a lens according to applied voltage or a change in the refractive index of the resin layer according to the applied voltage.

The processor 140 may include at least one of a CPU, a microprocessor, a graphics processing unit, an application processor (AP), an application-specific integrated circuit (ASIC), a digital signal processor (DSP), a digital signal processing device (DSPD), a programmable logic device (PLD), a field-programmable gate array (FPGA), a neural processing unit, or a dedicated artificial intelligence processor designed with a hardware structure specialized for training and processing of an AI model, but is not limited thereto.

In an embodiment of the disclosure, the processor 140 may execute various types of modules stored in the memory 130. In an embodiment of the disclosure, the processor 140 may execute the depth map obtainment module 131, the depth area segment module 132, the focal length determination module 133, and the lens voltage determination module 134 which are stored in the memory 130. In an embodiment of the disclosure, the processor 140 may execute at least one instruction configuring the various types of modules stored in the memory 130.

The processor 140 may execute at least one instruction stored in the memory 130 to control all operations of the electronic device 1000.

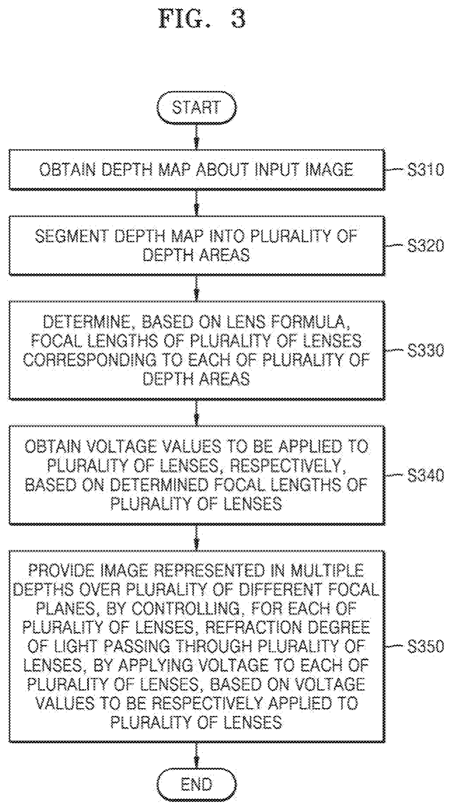

FIG. 3 is a flowchart for describing operations of the electronic device 1000 according to an embodiment of the disclosure.

Referring to FIG. 3, a method, performed by the electronic device 1000, of providing a 3D image may include operations S310 to S350. In an embodiment of the disclosure, operations S310 to S350 may be executed by at least one processor included in the electronic device 1000. The method, performed by the electronic device 1000, of providing a 3D image is not limited to what are shown in FIG. 3, and in one or more embodiments of the disclosure, operation not shown in FIG. 3 may be further included or some operations may be omitted.

In operation S310 of FIG. 3, the electronic device 1000, according to an embodiment of the disclosure, may obtain a depth map about an input image (e.g., a depth map corresponding to an input image). For example, the input image may be an RGB image. The RGB image is a digital image format that represents color by combining red, green, and blue, and each pixel may be composed of values that indicate the intensity of three colors. For example, each color intensity may be allocated 8 bits with values ranging from 0 to 255.

In an embodiment of the disclosure, the electronic device 1000 may obtain a depth map in a rendering process. The rendering process may indicate a process of converting a 3D scene into a 2D image. The electronic device 1000 may calculate and store a depth value of a pixel while projecting the 3D scene onto a 2D plane, and thus, may obtain the depth map about the input image.

In an embodiment of the disclosure, the electronic device 1000 may obtain a plurality of input images corresponding to a plurality of viewpoints. For example, the electronic device 1000 may obtain an image corresponding to a left eye and an image corresponding to a right eye. The electronic device 1000 may generate the depth map, based on disparity between the plurality of input images, focal lengths of a plurality of cameras capturing the plurality of input images, and a distance between the plurality of cameras.

In an embodiment of the disclosure, the electronic device 1000 may receive a stereo image as an input image, and may determine depth information based on the stereo image. The stereo image includes different-viewpoint images (e.g., a left image and a right image) obtained via two or more cameras. Viewpoint images may refer to images captures at different positions (or viewpoints) in the same time. The stereo image may be obtained by, for example, a stereo camera.

In one or more embodiments of the disclosure, the electronic device 1000 may determine depth information based on a multi-view image including three or more viewpoint images. However, hereinafter, for convenience of descriptions, an embodiment will now be mainly described, in which depth information is obtained based on a stereo image configured of two viewpoint images.

The electronic device 1000 may find feature points in the stereo image, and may perform matching between feature points corresponding thereto. For example, the electronic device 1000 may find feature points in the stereo image, based on a neural network model, and may perform matching between feature points corresponding thereto. The electronic device 1000 may calculate a depth value of each pixel, based on disparity that is a difference between positions of the feature points corresponding thereto. As a disparity value increases, the electronic device 1000 may determine that feature points are located close to a user.

In one or more embodiments of the disclosure, the electronic device 1000 may infer a depth map from a plurality of input images corresponding to a plurality of viewpoints, by using an AI model. In this case, the AI model may include a machine learning model or a deep learning model. The AI model may have been trained to infer the depth map by receiving a plurality of input images corresponding to a plurality of viewpoints as an input.

For example, the AI model may receive a plurality of input images and camera parameters of the input images as an input and may infer a depth map in a ray tracing process, by using a deep learning-based Neural Radiance Fields (NeRF) scheme.

In an embodiment of the disclosure, the electronic device 1000 may obtain an input image corresponding to a single viewpoint. The electronic device 1000 may generate a depth map by estimating a depth from the input image with the single viewpoint.

In an embodiment of the disclosure, the electronic device 1000 may infer a depth map from an input image corresponding to a single viewpoint, by using an AI model. In this case, the AI model may include a machine learning model or a deep learning model. The AI model may have been trained to infer a depth map by receiving an input image corresponding to a single viewpoint as an input.

For example, the AI model may receive an input image corresponding to a single viewpoint as an input and may infer a relative depth of an object in the input image, by using a deep learning-based monocular depth estimation scheme. The AI model may use a monodepth estimation scheme, a densedepth estimation scheme, a fastdepth estimation scheme, etc. as examples of the monocular depth estimation scheme.

The monodepth estimation scheme may use a model pre-trained based on a neural network-based learning scheme (e.g., a self-supervised learning scheme) by using data of a stereo-images pair. The AI model may estimate the depth map from the input image with the single viewpoint, by using the monodepth estimation scheme.

The densedepth estimation scheme may use a model pre-trained based on a neural network-based learning scheme (e.g., a self-supervised learning scheme) by using data of an image-depth pair. The AI model may estimate a dense depth map from the input image with the single viewpoint, by using the densedepth estimation scheme. The dense depth map indicates a depth map including depth information for all pixels.

The fastdepth estimation scheme may use a neural network that is relatively light-weighted. The AI model may estimate the depth map in real time from the input image with the single viewpoint, by using the fastdepth estimation scheme. In one or more examples, the models for each of the monodepth estimation scheme, densedepth estimation, and fastdepth estimation scheme may be different from each other and trained separately. In one or more examples, at least two of the monodepth estimation scheme, densedepth estimation, or fastdepth estimation scheme may use a same model.

In one or more embodiments of the disclosure, the electronic device 1000 may extract the depth form the input image corresponding to the single viewpoint, by using Depth from Defocus (DfD) scheme using blurriness in a focus. A camera lens may be in focus at a particular distance, and at other distances, the focus may become blurred (or, a blur effect phenomenon). In this case, a blurriness degree may vary according to a distance between an object and a camera, and more particularly, may vary according to how far the object is distant from a focal plane. The electronic device 1000 may estimate depth information of an object, based on a blurriness degree in the input image corresponding to the single viewpoint.

In one or more embodiments of the disclosure, the electronic device 1000 may generate the depth map from the input image corresponding to the single viewpoint, by using a structured light scheme. The electronic device 1000 may receive, as an input image, an image captured while an optical pattern is projected thereto. The electronic device 1000 may extract the depth information, based on a distortion degree of the optical pattern projected onto the object.

In an embodiment of the disclosure, the electronic device 1000 may receive a depth map corresponding to an input image, via an input/output interface or a communication interface. For example, the electronic device 1000 may receive a grayscale depth map or a color depth map which is obtained via a Time of Flight (ToF) camera. Alternatively, the electronic device 1000 may receive a depth map obtained by using the structured light scheme. Alternatively, for example, the electronic device 1000 may receive, as an input image, an RGB-D image by obtaining the RGB-D image via the ToF camera, the RGB-D image being obtained by adding depth information to an RGG image.

In one or more embodiments of the disclosure, the electronic device 1000 may generate a depth map for each frame of 3D content. Here, each frame of 3D content may be an input image. For frames of consecutive scenes, the electronic device 1000 may generate a depth map of a current frame by correcting a depth value of a previous frame.

In operation S320 of FIG. 3, the electronic device 1000, according to an embodiment of the disclosure, may segment a depth map into a plurality of depth areas.

In an embodiment of the disclosure, the electronic device 1000 may set a plurality of depth sections based on a depth value of each pixel obtained via the depth map. The electronic device 1000 may segment the depth map into the plurality of depth areas, according to each depth section, based on the plurality of depth sections.

In an embodiment of the disclosure, the plurality of depth areas may include two or more of a first depth area, a second depth area, and a third depth area. In the disclosure, the first depth area may be an area having a depth of a reference value in the depth map. In the disclosure, the second depth area may be an area having a depth less than the reference value in the depth map. In the disclosure, the third depth area may be an area having a depth greater than the reference value in the depth map.

The second depth area may be provided as one depth area defined according to one depth section, or may be provided as a plurality of depth areas defined according to a plurality of depth sections. The third depth area may be provided as one depth area defined according to one depth section, or may be provided as a plurality of depth areas defined according to a plurality of depth sections.

In an embodiment of the disclosure, the electronic device 1000 may adjust the number of depth sections or the number of depth areas to be segmented, according to a bit depth in a depth map. The bit depth in the depth map indicates a value represented in bits with respect to depth information that each pixel in an image may represent. When the bit depth in the depth map increases, the number of depths that may be represented by each pixel may increase. For example, when the bit depth in the depth map is 2 bits, four depths may be represented by each pixel, and when the bit depth in the depth map is 3 bits, eight depths may be represented by each pixel. An interval between depth sections may be set to be regular or irregular.

In an embodiment of the disclosure, the electronic device 1000 may change a range of a plurality of depth areas, based on movement of at least one object in consecutive frames included in an input image.

In an embodiment of the disclosure, the electronic device 1000 may change the range of a plurality of depth areas or may change a depth area corresponding to a reference point, based on a user input.

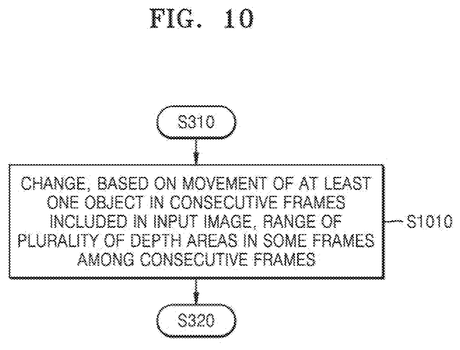

An operation in which the electronic device 1000 changes a range of a plurality of depth areas or changes a depth area corresponding to a reference point will be described in detail below with reference to FIGS. 10 to 12.

In operation S330 of FIG. 3, the electronic device 1000 according to an embodiment of the disclosure may determine, based on the lens formula, focal lengths of a plurality of lenses corresponding to each of the plurality of depth areas. The lens formula provides a mathematical relation among a focal length of a lens, a distance between lenses, and a distance between an image and a lens. The electronic device 1000 may calculate, by using Equation 1 described above, a focal length of a lens based on a distance between an object and the lens, and a distance between an image and the lens.

In an embodiment of the disclosure, the plurality of lenses may include two or more of a first lens (or a first lens area) corresponding to a first depth area, a second lens (or a second lens area) corresponding to a second depth area, and a third lens (or a third lens area) corresponding to a third depth area.

In an embodiment of the disclosure, the electronic device 1000 may determine a focal length of at least one first lens (or a first lens area) corresponding to a first depth area. An image in which an object included in the first depth area is displayed may pass through the at least one first lens and may be provided to a user. The electronic device 1000 may determine the focal length of the first lens so as to allow a focal plane of the first lens to be located at the display 110.

In an embodiment of the disclosure, the electronic device 1000 may determine a focal length of at least one second lens (or a second lens area) corresponding to a second depth area. An image in which an object included in the second depth area is displayed may pass through the at least one second lens and may be provided to the user. The electronic device 1000 may determine the focal length of the second lens so as to allow a focal plane of the second lens to be located closer to the user than the display 110.

In an embodiment of the disclosure, the electronic device 1000 may determine a focal length of at least one third lens (or a third lens area) corresponding to a third depth area. An image in which an object included in the third depth area is displayed may pass through the at least one third lens and may be provided to the user. The electronic device 1000 may determine the focal length of the third lens so as to allow a focal plane of the third lens to be located farther from the user than the display 110.

In operation S340 of FIG. 3, the electronic device 1000 according to an embodiment of the disclosure may obtain voltage values to be applied to the plurality of lenses, respectively, based on the determined focal lengths of the plurality of lenses.

In an embodiment of the disclosure, the electronic device 1000 may determine voltage values to be applied to two or more of the first lens (or the first lens area), the second lens (or the second lens area), or the third lens (or the third lens area). In order to allow each lens or each lens depth to have a corresponding focal length, the electronic device 1000 may determine voltage values to be applied to respective lenses or respective lens areas may be determined.

According to an embodiment of the disclosure, the electronic device 1000 may determine a first voltage value to be applied to the first lens so as to allow the focal plane of the first lens to be located at the display 110.

According to an embodiment of the disclosure, the electronic device 1000 may determine a second voltage value to be applied to the second lens so as to allow the focal plane of the second lens to be located closer to the user than the display 110.

According to an embodiment of the disclosure, the electronic device 1000 may determine a third voltage value to be applied to the third lens so as to allow the focal plane of the third lens to be located farther from the user than the display 110.

For example, the electronic device 1000 may determine not to apply a voltage to the first lens. That is, the electronic device 1000 may determine the first voltage value to be 0V. When voltage is not applied to the first lens, a focal plane of the first lens cannot be located at the display 110. The electronic device 1000 may determine the second voltage value to be a voltage value greater than the third voltage value.

Alternatively, for example, the electronic device 1000 may determine the first voltage value to be a voltage value at which a liquid-crystal array of the first lens has a maximum alignment angle. The electronic device 1000 may determine each of the second voltage value and the third voltage value to be a voltage value less than the first voltage value. The electronic device 1000 may determine the second voltage value to be a voltage value less than the third voltage value.

The electronic device 1000 may determine the second voltage value to be applied to the second lens, such that the second lens may have a focal length less than a distance between the display 110 and the lens array 120. As a relatively-low voltage value is applied to the second lens compared to the third lens, a refraction degree of light that passes through the second lens may be small. Accordingly, the second lens may have a focal length that is relatively great compared to the third lens.

The electronic device 1000 may determine the third voltage value to be applied to the third lens, such that the third lens may have a focal length greater than the distance between the display 110 and the lens array 120. As a relatively-high voltage value is applied to the third lens compared to the second lens, a refraction degree of light that passes through the third lens may be great. Accordingly, the third lens may have a focal length that is relatively small compared to the second lens.

In operation S350 of FIG. 3, the electronic device 1000 according to an embodiment of the disclosure may provide an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

When different voltage is applied to each of the plurality of lenses, a liquid-crystal array of each of the plurality of lenses may vary according to a voltage value applied thereto. Therefore, a refraction degree of light that passes through each of the plurality of lenses may vary.

In an embodiment of the disclosure, the electronic device 1000 may not apply a voltage to the first lens (or the first lens area). Therefore, as a liquid-crystal array in the first lens is maintained, a refractive index of the first lens may be changelessly maintained. Accordingly, when light passes through the first lens, the light may maintain its straight path without being refracted, and thus, may provide a 2D image to a user.

In an embodiment of the disclosure, the electronic device 1000 may apply the third voltage value determined in operation S340 to the second lens (or the second lens area). Therefore, as a liquid-crystal array in the second lens is changed, a refractive index of the second lens may be changed. Accordingly, light that passes through the second lens may be refracted, and thus, may provide a 3D image to the user.

As the third voltage value is applied to the second lens, a focal length of the second lens may be set to be less than the distance between the display 110 and the lens array 120. Accordingly, a focal plane of the second lens may be set to be located closer to the user than the display 110. Here, an image of an input image which corresponds to the second depth area may be displayed on the focal plane of the second lens. In other words, an object having a depth smaller than a reference value may be displayed on the focal plane of the second lens. The electronic device 1000 displays the object having a depth smaller than the reference value to be close to the focal plane, thereby increasing a sharpness of the object having a depth smaller than the reference value.

In an embodiment of the disclosure, the electronic device 1000 may apply the second voltage value determined in operation S304 to the third lens. Therefore, as a liquid-crystal array in the third lens is changed, a refractive index of the third lens may be changed. Accordingly, light that passes through the third lens may be refracted, and thus, may provide a 3D image to the user.

As the second voltage value is applied to the third lens, a focal length of the third lens may be set to be greater than the distance between the display 110 and the lens array 120. Accordingly, a focal plane of the third lens may be set to be located farther from the user than the display 110. In one or more examples, an image of the input image which corresponds to the third depth area may be displayed on the focal plane of the third lens. In other words, an object having a depth greater than the reference value may be displayed on the focal plane of the third lens. The electronic device 1000 displays the object having a depth greater than the reference value to be close to the focal plane, thereby increasing a sharpness of the object having a depth greater than the reference value.

According to an embodiment of the disclosure, the electronic device 1000 may display an image having multiple depths over a plurality of focal planes, by providing the focal planes having different depths. Accordingly, the electronic device 1000 may improve a resolution in an entire depth range, and objects at all depths in an image may be clearly provided.

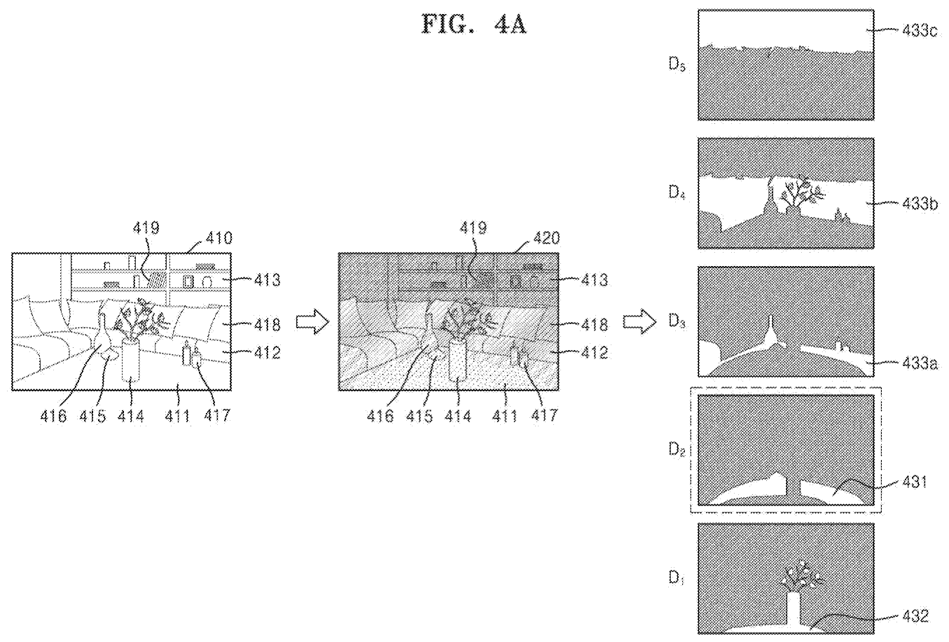

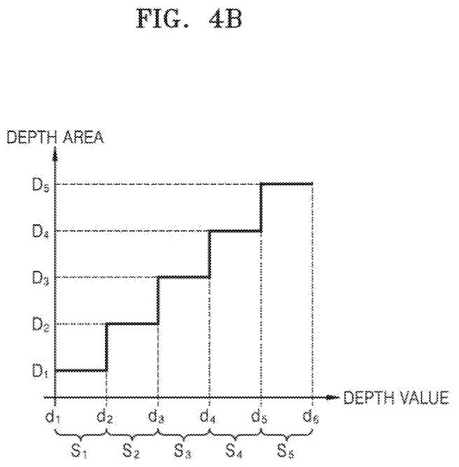

With reference to FIGS. 4A to 7, each operation will now be described in detail.

FIG. 4A is a diagram for describing an operation in which the electronic device 1000 extracts and segments a depth map into a plurality of depth areas, according to an embodiment of the disclosure. FIG. 4B is a diagram for describing an operation in which the electronic device 1000 segments a depth map into a plurality of depth areas, according to an embodiment of the disclosure.

Referring to FIG. 4A, in an embodiment of the disclosure, the electronic device 1000 may obtain an input image 410. The input image 410 may be an RGB image. FIG. 4A illustrates an example in which the electronic device 1000 obtains the input image 410 corresponding to a single viewpoint, however, the electronic device 1000 may obtain a plurality of input images corresponding to a plurality of viewpoints.

The input image 410 may include one or more objects. For example, the input image 410 may include a table 411, a sofa 412, a bookcase 413, a vase 414, potteries 415 and 416, and a candle 417 which are placed on the table 411, cushions 418 placed on the sofa 412, and books 419 placed in the bookcase 413. A part of the sofa 412 and the cushions 418 placed on the sofa 412 may be located behind the table 411. The bookcase 413, and the books 419 placed in the bookcase 413 may be located behind the sofa 412 and the cushions 418 placed on the sofa 412.

In an embodiment of the disclosure, the electronic device 1000 may generate, from the input image 410, a depth map 420 for the input image 410. In the depth map 420, depth information may be represented in grayscale. In the depth map 420, an object located at a close distance (e.g., having a small depth) may be represented as close to a green color, and an object located at a remote distance (e.g., having a great depth) may be represented as close to a black color. According to an embodiment of the disclosure, the electronic device 1000 may obtain the depth map 420 for the input image 410 from an external device (e.g.: a server). For example, the electronic device 1000 may request the depth map 420 by transmitting the input image 410 to the server, and may receive, from the server, the depth map 420 that the server has generated.

In an embodiment of the disclosure, the electronic device 1000 may segment the depth map 420 into a plurality of depth areas 411, 412, 433a, 433b, and 433c. Referring to FIGS. 4A and 4B, an example in which the depth map 420 is segmented 1 into the five depth areas 411, 412, 433a, 433b, and 433c is shown, but the disclosure is not limited thereto.

First, as shown in FIG. 4B, according to an embodiment of the disclosure, the electronic device 1000 may set a plurality of depth sections S₁, S₂, S₃, S₄, and S₅. For example, the electronic device 1000 may set five depth sections including the first to fifth sections S₁, S₂, S₃, S₄, and S₅. When the depth map 420 is represented in a range of a first depth d₁ to a sixth depth d₆ (e.g., 0 to 255), the electronic device 1000 may segment a depth of the depth map 420 into the first section S₁ greater than or equal to the first depth d₁, but less than the second depth d₂, the second section S₂ greater than or equal to the second depth d₂, but less than the third depth d₃, the third section S₃ greater than or equal to the third depth d₃ but less than the fourth depth d₄, the fourth section S₄ greater than or equal to the fourth depth d₄ but less than the fifth depth d₅, and the fifth section S₅ greater than or equal to the fifth depth d₅ but less than the sixth depth d₆.

In an embodiment of the disclosure, the electronic device 1000 may segment the plurality of depth sections S₁, S₂, S₃, S₄, and S₅ into regular sections. In this regard, the depth sections S₁, S₂, S₃, S₄, and S₅ may be segmented into the regular sections, based on diopter units. Alternatively, the depth sections S₁, S₂, S₃, S₄, and S₅ may be segmented into the regular sections, based on meters.

In an embodiment of the disclosure, the electronic device 1000 may segment the plurality of depth sections S₁, S₂, S₃, S₄, and S₅ into irregular sections. Here, the electronic device 1000 may segment a plurality of depth sections at intervals in which visual fatigue may be minimum, in consideration of viewer's cognitive characteristics. Alternatively, the electronic device 1000 may segment the plurality of depth sections at intervals in which a viewer's sense of 3D immersion may be increased.

The electronic device 1000 may determine an area of the depth map 420 which corresponds to a depth of the first section S₁ as a first area D₁. The electronic device 1000 may determine an area of the depth map 420 which corresponds to a depth of the second section S₂ as a second area D₂. The electronic device 1000 may determine an area of the depth map 420 which corresponds to a depth of the third section S₃ as a third area D₃. The electronic device 1000 may determine an area of the depth map 420 which corresponds to a depth of the fourth section S₄ as a fourth area D₄. The electronic device 1000 may determine an area of the depth map 420 which corresponds to a depth of the fifth section S₅ as a fifth area D₅.

As shown in FIG. 4A, the electronic device 1000 may segment the depth map 420 into the plurality of areas D₁, D₂, D₃, D₄, and D₅, based on the plurality of depth sections S₁, S₂, S₃, S₄, and S₅. For example, the electronic device 1000 may segment the depth map 420 into the plurality of areas D₁, D₂, D₃, D₄, and D₅ that respectively correspond to the plurality of depth sections S₁, S₂, S₃, S₄, and S₅.

The first area D₁ corresponding to the first section S₁ may include a part of the table 411 which is located at a close distance, and the vase 414 placed on the table 411. The second area D₂ corresponding to the second section S₂ may include a part of the table 411 which is located at a medium distance, and the pottery 415 placed on the table 411. The third area D₃ corresponding to the third section S₃ may include a remaining part of the table 411 which is located at a remote distance, the large pottery 416 and the candle 417 which are placed on the table 411, and a part of the sofa 412 which is located at a close distance. The fourth area D₄ corresponding to the fourth section S₄ may include a remaining part of the sofa 412 which is located at a remote distance and the cushions 418 placed on the sofa 412. The fifth area D₅ corresponding to the fifth section S₅ may include the bookcase 413 and the books 419 placed in the bookcase 413.

In an embodiment of the disclosure, the electronic device 1000 may determine each of the first to fifth areas D₁, D₂, D₃, D₄, and D₅ that are segmented from the depth map 420 as a corresponding depth area among a first depth area 431, a second depth area 432, and a third depth area 433.

The electronic device 1000 may determine an area including a depth of a reference value as the first depth area 431. The depth of the reference value may be determined as a depth at which a focus is formed. For example, when the input image 410 is an image captured via a camera, the depth of the reference value may be determined to be a depth at which a focus of the camera is correct. For example, as the depth of the reference value is included in the second section S₂, the electronic device 1000 may determine the second area D₂ as the first depth area 431.

The electronic device 1000 may determine an area having a depth smaller than the reference value as the second depth area 432. The depth smaller than the reference value may correspond to a depth closer than the depth of the reference value. For example, the electronic device 1000 may determine the first area D₁ having a depth smaller than the second area D₂ as the second depth area 432.

The electronic device 1000 may determine an area having a depth greater than the reference value as the third depth area 433. The depth greater than the reference value may correspond to a depth located farther than the depth of the reference value. According to an embodiment of the disclosure, the third depth area 433 may be provided as a plurality of depth areas 433a, 433b, and 433c which correspond to different depth sections. For example, the electronic device 1000 may determine the third area D₃, the fourth area D₄, and the fifth area D₅ which have a depth greater than the second area D₂ as the third depth area 433. In the disclosure, the third depth area 433 corresponding to the third area D₃ may be referred to as the 3-1 depth area 433a, the third depth area 433 corresponding to the fourth area D₄ may be referred to as the 3-2 depth area 433b, and the third depth area 433 corresponding to the fifth area D₅ may be referred to as the 3-3 depth area 433c.

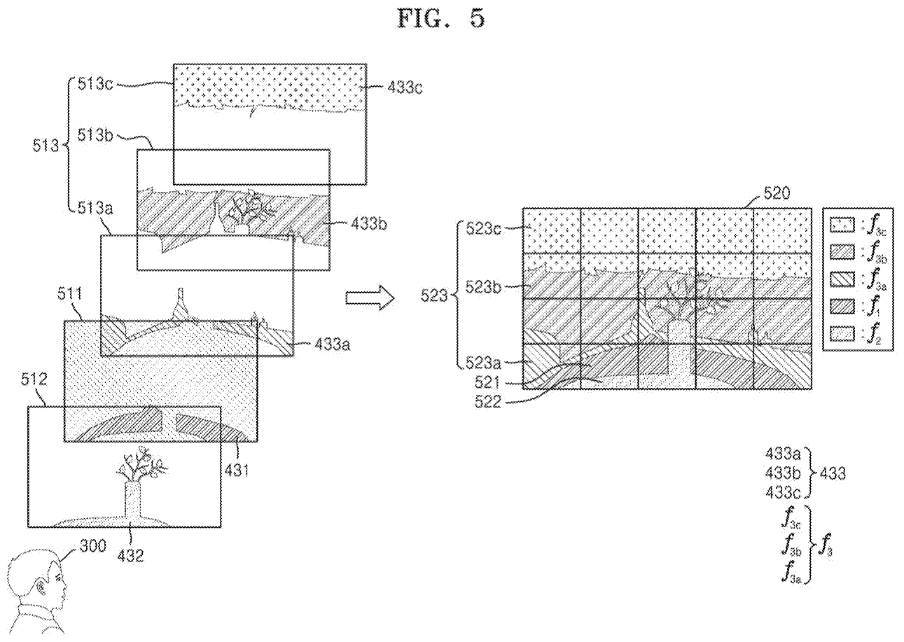

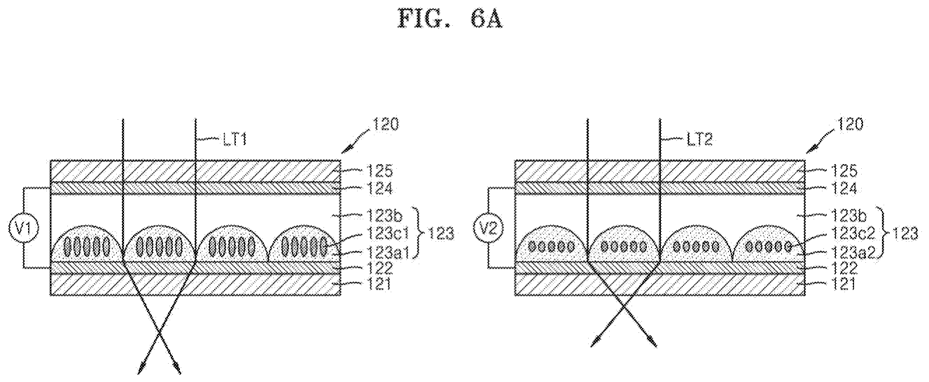

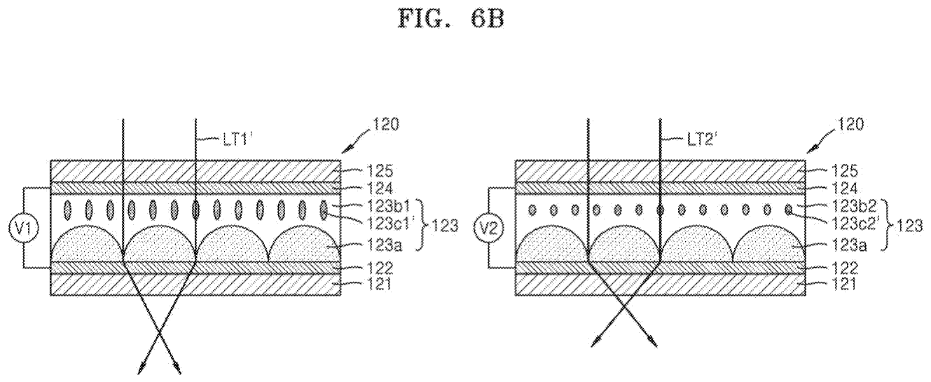

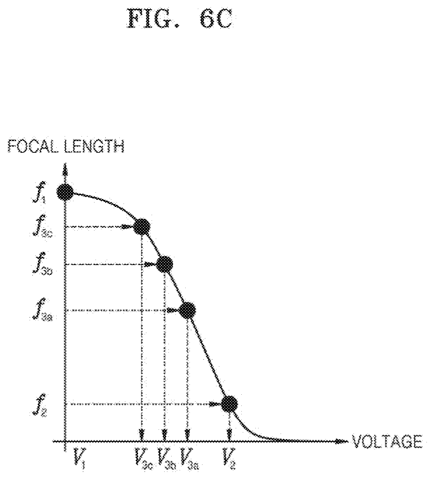

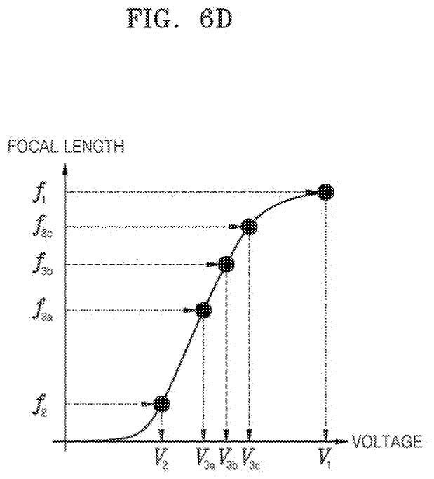

In an embodiment of the disclosure, the electronic device 1000 may set the plurality of depth sections S₁, S₂, S₃, S₄, and S₅, and may segment the depth areas 411, 412, 433a, 433b, and 433c for providing the same focal length, based on the setting. The electronic device 1000 may represent objects (or object parts) to have the same focal length in an output image, the objects corresponding to a similar depth range in the input image 410. By doing so, the electronic device 1000 may output an image having multiple depths over a plurality of focal planes. Hereinafter, with reference to FIGS. 5 to 6B, an operation of determining focal lengths of a plurality of lenses and voltage values to be applied to the plurality of lenses, based on segmented depth areas 411, 412, 433a, 433b, and 433c, will now be described in detail.

FIG. 5 is a diagram for describing an operation in which the electronic device 1000 determines focal lengths of a plurality of lenses, according to an embodiment of the disclosure.

Referring to FIGS. 4A and 5, the electronic device 1000, according to an embodiment of the disclosure, may determine respective focal lengths of a plurality of lenses of a liquid-crystal lens. The electronic device 1000 may determine the respective focal lengths of the plurality of lenses, based on the segmented depth areas 431, 432, 433a, 433b, and 433c of the depth map 420. In an embodiment of the disclosure, a plurality of lenses may have sizes and/or arrays which are different from pixels in the display 110. In this case, one lens may overlap a plurality of pixels, and the electronic device 1000 may determine a focal length to differ according to areas within one lens.

In an embodiment of the disclosure, a liquid-crystal lens 520 may include a first lens area 521 corresponding to the first depth area 431, a second lens area 522 corresponding to the second depth area 432, and a third lens area 523 corresponding to the third depth area 433. A lens that corresponds to the first lens area 521 among the plurality of lenses may be referred to as a first lens. A lens that corresponds to the second lens area 522 among the plurality of lenses may be referred to as a second lens. A lens that corresponds to the third lens area 523 among the plurality of lenses may be referred to as a third lens.

According to an embodiment of the disclosure, as the third depth area 433 is provided as the plurality of depth areas 433a, 433b, and 433c, the third lens area 523 may include a 3-1 lens area 523a corresponding to the 3-1 depth area 433a, a 3-2 lens area 523b corresponding to the 3-2 depth area 433b, and a 3-3 lens area 523c corresponding to the 3-3 depth area 433c.

In an embodiment of the disclosure, the electronic device 1000 may determine focal lengths of lenses that correspond to each of the plurality of depth areas 431, 432, 433a, 433b, and 433c. The electronic device 1000 may determine a first focal length f₁ in the first lens area 521 corresponding to the first depth area 431. The electronic device 1000 may determine a second focal length f₂ in the second lens area 522 corresponding to the second depth area 432. The electronic device 1000 may determine a third focal length f₃ in the third lens area 523 corresponding to the third depth area 433. For example, the electronic device 1000 may determine a 3-1 focal length f₃ₐ in the 3-1 lens area 523a corresponding to the 3-1 depth area 433a. The electronic device 1000 may determine a 3-2 focal length f₃b in the 3-2 lens area 523b corresponding to the 3-2 depth area 433b. The electronic device 1000 may determine a 3-3 focal length f_{3c} in the 3-3 lens area 523c corresponding to the 3-3 depth area 433c.

The electronic device 1000 may determine the first focal length f₁ as a focal length at which a focal plane (i.e., a first focal plane 511) in the first lens area 521 is formed on the display 110. Here, it may be described that the electronic device 1000 has determined the first focal length f₁ to be set to infinity.

The electronic device 1000 may determine the second focal length f₂ as a focal length at which a focal plane (i.e., a second focal plane 512) in the second lens area 522 is formed in front of the display 110 (i.e., the first focal plane 511). In other words, the electronic device 1000 may determine the second focal length f₂ as the focal plane at which the second focal plane 512 is formed closer to the user 300 than the display 110.

The electronic device 1000 may determine a depth (or position) of the second focal plane 512, based on a depth at which an image corresponding to the second depth area 432 is to be displayed. For example, when an object included in the second depth area 432 is displayed with a relatively small depth difference from the reference value, the electronic device 1000 may determine the second focal length f₂ so as to allow the position of the second focal plane 512 to be formed at a depth relatively close to the first focal plane 511. On the other hand, when an object included in the second depth area 432 is displayed with a relatively great depth difference from the reference value, the electronic device 1000 may determine the second focal length f₂ so as to allow the position of the second focal plane 512 to be formed at a depth relatively remote from the first focal plane 511. In one or more examples, a relatively small depth difference may be less than or equal to a difference threshold, and a relatively great depth difference may be greater than the difference threshold. In one or more examples, a relatively close depth may be less than or equal to a distance threshold, and a relatively remote depth may be greater than the distance threshold.

The electronic device 1000 may determine the third focal length f₃ as a focal plane at which a focal plane (i.e., a third focal plane 513) in the third lens area 523 is formed behind the display 110 (i.e., the first focal plane 511). In other words, the electronic device 1000 may determine the third focal length f₃ as the focal plane at which the third focal plane 513 is formed farther from the user 300 than the display 110.

The electronic device 1000 may determine a depth (or position) of the third focal plane 513, based on a depth at which an image corresponding to the third depth area 433 is to be displayed. For example, when an object included in the third depth area 433 is displayed with a relatively small depth difference from the reference value, the electronic device 1000 may determine the third focal length f₃ so as to allow the position of the third focal plane 513 to be formed at a depth relatively close to the first focal plane 511. On the other hand, when an object included in the third depth area 433 is displayed with a relatively great depth difference from the reference value, the electronic device 1000 may determine the third focal length f₃ so as to allow the position of the third focal plane 513 to be formed at a depth relatively remote from the first focal plane 511.

The 3-1 depth area 433a, the 3-2 depth area 433b, and the 3-3 depth area 433c may have depths that are sequentially remote from the reference value. In order to allow a 3-1 focal plane 513a, a 3-2 focal plane 513b, and a 3-3 focal plane 513c to be sequentially remote from the first focal plane 511, the electronic device 1000 may determine the 3-1 focal length f₃ₐ, the 3-2 focal length f_{3b}, and the 3-3 focal length f_{3c}, respectively.

According to an embodiment of the disclosure, the electronic device 1000 may control the liquid-crystal lens 520 to set the plurality of focal planes 511, 512, 513a, 513b, and 513c located at different depths, according to areas. Here, the electronic device 1000 may set the plurality of focal planes 511, 512, 513a, 513b, and 513c, according to each of depths of objects to be displayed.

Hereinafter, with reference to FIGS. 6A and 6B, the liquid-crystal lens 520 in which focal lengths of a plurality of lenses vary according to voltage applied to the plurality of lenses vary will now be described in detail, and with reference to FIGS. 6C and 6D, an operation of determining voltage values to be applied to a plurality of lenses which correspond to focal lengths of the plurality of lenses will be described in detail.

FIG. 6A is a diagram for describing a configuration of the lens array 120 of the electronic device 1000 according to an embodiment of the disclosure. FIG. 6B is a diagram for describing a configuration of the lens array 120 of the electronic device 1000, according to an embodiment of the disclosure.

Referring to FIG. 6A, in an embodiment of the disclosure, the lens array 120 may include a first base substrate 121, a first electrode layer 122, a liquid-crystal lens 123, a second electrode layer 124, and a second base substrate 125. The first electrode layer 122, the liquid-crystal lens 123, and the second electrode layer 124 may be arranged between the first base substrate 121 and the second base substrate 125.

In an embodiment of the disclosure, each of the first base substrate 121 and the second base substrate 125 may be a transparent insulating substrate or a transparent insulating film. For example, each of the first base substrate 121 and the second base substrate 125 may include a glass material, a quartz material, or a light-transmitting plastic material.

In an embodiment of the disclosure, a first electrode layer may include a metal electrode. For example, the metal electrode may include aluminum (Al), chromium (Cr), and gold (Au), but materials of the metal electrode are not limited thereto. In an embodiment of the disclosure, a second electrode layer may include a transparent electrode. For example, the transparent electrode may include indium tin oxide (ITO), but materials of the transparent electrode are not limited thereto.

In an embodiment of the disclosure, the liquid-crystal lens 123 may be arranged between the first electrode layer 122 and the second electrode layer 124. As an electric field is formed in the liquid-crystal lens 123 due to a difference between voltage applied to the first electrode layer 122 and voltage applied to the second electrode layer 124, a liquid-crystal alignment of the liquid-crystal lens 123 may be changed.

In an embodiment of the disclosure, the liquid-crystal lens 123 may include a plurality of lenses 123a1 and 123a2 and a resin layer covering the plurality of lenses 123a1 and 123a2. In an embodiment of the disclosure, the plurality of lenses 123a1 and 123a2 may include a plurality of liquid crystal molecules 123c1 and 123c2. The liquid crystal molecules 123c1 and 123c2 included in the plurality of lenses 123a1 and 123a2 may be distributed over an entire area of the plurality of lenses 123a1 and 123a2 with a uniform density.

In an embodiment of the disclosure, the liquid-crystal lens 123 may be controlled such that an alignment of the plurality of liquid crystal molecules 123c1 and 123c2 included in the plurality of lenses 123a1 and 123a2 is changed according to applied voltage. According to an alignment state of the plurality of liquid crystal molecules 123c1 and 123c2, a refraction degree of light incident on the liquid-crystal lens 123 may be controlled.

According to an embodiment of the disclosure, the electronic device 1000 may control a refraction degree of light incident on each of the plurality of lenses 123a1 and 123a2, by controlling voltage applied to each of the plurality of lenses 123a1 and 123a2. Alternatively, the electronic device 1000 may control a refraction degree of incident light for each area of the plurality of lenses 123a1 and 123a2, by controlling voltage applied to each area of the plurality of lenses 123a1 and 123a2.

In an embodiment of the disclosure, a liquid-crystal alignment form of the lens 123a1 to which a random first voltage value (hereinafter, referred to as the first voltage value V1) is applied may be different from a liquid-crystal alignment form of the lens 123a2 to which a random second voltage value (hereinafter, referred to as the second voltage value V2) that is different from the first voltage value V1 is applied. For example, an alignment angle of the liquid crystal molecule 123c1 in the lens 123a1 to which the first voltage value V1 is applied may be different from an alignment angle of the liquid crystal molecule 123c2 in the lens 123a2 to which the second voltage value V2 is applied.

Accordingly, a refractive index of the lens 123a1 to which the first voltage value V1 is applied may be different from a refractive index of the lens 123a2 to which the second voltage value V2 is applied. A difference between the refractive index of the lens 123a1 and a refractive index of a resin layer 123b to which the first voltage value V1 is applied may be different from a difference between the refractive index of the lens 123a2 and the refractive index of the resin layer 123b to which the second voltage value V2 is applied. For example, a refraction degree of light LT1 that passes through the lens 123a1 to which the first voltage value V1 is applied may be less than a refraction degree of light LT2 that passes through the lens 123a2 to which the second voltage value V2 is applied. Accordingly, a focal length of the lens 123a1 to which the first voltage value V1 is applied may be greater than a focal length of the lens 123a2 to which the second voltage value V2 is applied.

FIG. 6A illustrates an example of a liquid-crystal alignment form of the lens 123a1 to which the first voltage value V1 is applied and a liquid-crystal alignment form of the lens 123a2 to which the second voltage value V2 is applied, and the lenses 123a1 and 123a2 may have various liquid-crystal alignment forms according to a liquid-crystal alignment scheme (e.g., a twisted nematic (TN) mode, a vertical alignment (VA) mode, etc.) or types of the liquid crystal molecules 123c1 and 123c2.

Referring to FIG. 6B, in an embodiment of the disclosure, the lens array 120 may include the first base substrate 121, the first electrode layer 122, the liquid-crystal lens 123, the second electrode layer 124, and the second base substrate 125. The liquid-crystal lens 123 may include a plurality of lenses 123a and a resin layer 123b1 or 123b2 covering the plurality of lenses 123a.

In an embodiment of the disclosure, the resin layer 123b1 or 123b2 may include a plurality of liquid crystal molecules 123c1′ or 123c2′. The plurality of liquid crystal molecules 123c1′ or 123c2′ included in the resin layer 123b1 or 123b2 may be distributed over an entire area of the resin layer 123b1 or 123b2 with a uniform density.

In an embodiment of the disclosure, the liquid-crystal lens 123 may be controlled such that an alignment of the plurality of liquid crystal molecules 123c1′ or 123c2′ included in the resin layer 123b1 or 123b2 is changed according to applied voltage. According to an alignment state of the plurality of liquid crystal molecules 123c1′ or 123c2′, a refraction degree of light incident on the liquid-crystal lens 123 may be controlled.

According to an embodiment, the electronic device 1000 may control voltage to be applied to each of the plurality of lenses 123a, and thus, may control voltage to be applied to each of areas of the resin layer 123b1 or 123b2. As voltage to be applied is controlled for each of the areas of the resin layer 123b1 or 123b2, a refraction degree of incident light may be controlled for each of the liquid-crystal lens 123.

In an embodiment of the disclosure, a liquid-crystal alignment form of the resin layer 123b1 to which the first voltage value V1 is applied may be different from a liquid-crystal alignment form of the resin layer 123b2 to which the second voltage value V2 that is different from the first voltage value V1 is applied. For example, an alignment angle of the liquid crystal molecules 123c1′ in the resin layer 123b1 to which the first voltage value V1 is applied may be different from an alignment angle of the liquid crystal molecules 123c2′ in the resin layer 123b2 to which the second voltage value V2 is applied.

Accordingly, a refractive index of the resin layer 123b1 to which the first voltage value V1 is applied may be different from a refractive index of the resin layer 123b2 to which the second voltage value V2 is applied. A difference between the refractive index of the resin layer 123b1 and a refractive index of the lens 123a to which the first voltage value V1 is applied may be different from a difference between the refractive index of the resin layer 123b2 and the refractive index of the lens 123a to which the second voltage value V2 is applied. For example, a refraction degree of light LT1′ that passes through the lens 123a to which the first voltage value V1 is applied may be less than a refraction degree of light LT2′ that passes through the lens 123a to which the second voltage value V2 is applied. Accordingly, a focal length of the lens 123a to which the first voltage value V1 is applied may be greater than a focal length of the lens 123a to which the second voltage value V2 is applied.

FIG. 6B illustrates an example of a liquid-crystal alignment form of the resin layer 123b1 to which the first voltage value V1 is applied and a liquid-crystal alignment form of the resin layer 123b2 to which the second voltage value V2 is applied, and the lenses 123a1 and 123a2 may have various liquid-crystal alignment forms according to a liquid-crystal alignment scheme (e.g., a twisted nematic (TN) mode, a vertical alignment (VA) mode, etc.) or types of the liquid crystal molecules 123c1′ and 123c2′.

FIG. 6C is a diagram for describing an operation in which the electronic device 1000 obtains voltage values to be applied to a plurality of lenses, according to an embodiment of the disclosure. FIG. 6D is a diagram for describing an operation in which the electronic device 1000 obtains voltage values to be applied to a plurality of lenses, according to an embodiment of the disclosure.

Referring to FIGS. 6C and 6D, in an embodiment of the disclosure, the electronic device 1000 may determine voltage values V1, V2, V3a, V3b, and V3c to be applied to a plurality of lenses, based on determined focal lengths f₁, f₂, f₃ₐ, f_{3b}, and f_{3c} of the plurality of lenses.

In an embodiment of the disclosure, the electronic device 1000 may obtain a graph about voltage value-focal length. Based on the obtained graph, the electronic device 1000 may determine a voltage value to be applied to a lens, according to a focal length of the lens. Also, in an embodiment of the disclosure, the electronic device 1000 may obtain a look-up table of pairs of a voltage value and a focal length. Based on the obtained look-up table, the electronic device 1000 may determine a voltage value to be applied to a lens, according to a focal length of the lens.

Referring to FIG. 6C, in an embodiment of the disclosure, a voltage value to be applied to a lens may be in inverse proportion to a focal length of the lens. That is, when the voltage value to be applied to the lens increases, the focal length of the lens may decrease. In more detail, when the voltage value to be applied to the lens increases, a difference between a refractive index of the lens and a refractive index of a resin layer increases, such that a refraction degree of light that passes through the lens may increase.

Referring to FIGS. 5 and 6C, the electronic device 1000 may determine to apply the first voltage value V₁ for setting the first focal length f₁ to infinity to the first lens area 521. For example, the electronic device 1000 may determine not to apply a voltage to the first lens area 521. That is, the electronic device 1000 may determine the first voltage value V₁ to 0V.

The electronic device 1000 may determine to apply the second voltage value V₂ to the second lens area 522, the second voltage value V₂ being for allowing the second focal plane 512 to be formed closer to the user 300 than the display 110. To this end, the electronic device 1000 may determine to apply the second voltage value V₂ to the second lens area 522 so as to allow the second focal length f₂ to be less than a distance between the display 110 and the liquid-crystal lens.

The electronic device 1000 may determine to apply the third voltage value V₃ to the third focal plane 513, the third voltage value V₃ being for allowing the third focal plane 513 to be formed farther from the user 300 than the display 110. To this end, the electronic device 1000 may determine to apply the third voltage value V₃ to the third lens area 523 so as to allow the third focal length f₃ to be greater than the distance between the display 110 and the liquid-crystal lens. The electronic device 1000 may form the third focal length f₃ to be greater than the second focal length f₂.

In an embodiment of the disclosure, based on the graph about voltage value-focal length of FIG. 6C, the electronic device 1000 may determine the second voltage value V₂, which is to be applied the second lens area 522, to be a value greater than the third voltage value V₃ to be applied to the third lens area 523.

The electronic device 1000 may determine to apply a 3-1 voltage value V₃ₐ, a 3-2 voltage value V_{3b}, and a 3-3 voltage value V_{3c} respectively to the 3-1 lens area 523a, the 3-2 lens area 523b, and the 3-3 lens area 523c so as to allow the 3-1 focal plane 513a, the 3-2 focal plane 513b, and the 3-3 focal plane 513c to be sequentially remote from the first focal plane 511. To this end, the electronic device 1000 may determine the 3-1 voltage value V₃ₐ, a 3-2 voltage value V_{3b}, and a 3-3 voltage value V_{3c} for forming the 3-1 focal length f₃ₐ, the 3-2 focal length f_{3b}, and the 3-3 focal length f_{3c} to sequentially increase.

In an embodiment of the disclosure, based on the graph about voltage value-focal length of FIG. 6C, the electronic device 1000 may determine the 3-1 voltage value V₃ₐ to be applied to the 3-1 lens area 523a, the 3-2 voltage value V_{3b} to be applied to the 3-2 lens area 523b, and the 3-3 voltage value V_{3c} to be applied to the 3-3 lens area 523c, to be values that sequentially decrease.

Referring to FIG. 6D, in an embodiment of the disclosure, a voltage value to be applied to a lens may be in proportion to a focal length of the lens. That is, when the voltage value to be applied to the lens increases, the focal length of the lens may increase. In more detail, when the voltage value to be applied to the lens increases, a difference between a refractive index of the lens and a refractive index of a resin layer decreases, such that a refraction degree of light that passes through the lens may decrease.

Referring to FIGS. 5 and 6D, the electronic device 1000 may determine to apply the first voltage value V₁ for setting the first focal length f₁ to infinity to the first lens area 521. For example, the electronic device 1000 may determine to apply the first voltage value V₁ to the first lens area 521 so as to align liquid crystal molecules at a maximum alignment angle. In the disclosure, when liquid crystal molecules are aligned at a maximum alignment angle, it may mean that an alignment state of the liquid crystal molecules is set to be a maximally-aligned state.

The electronic device 1000 may form the third focal length f₃ to be greater than the second focal length f₂. In an embodiment of the disclosure, based on the graph about voltage value-focal length of FIG. 6D, the electronic device 1000 may determine the second voltage value V₂, which is to be applied the second lens area 522, to be a value less than the third voltage value V₃ to be applied to the third lens area 523.

The electronic device 1000 may form the 3-1 focal length f₃ₐ, the 3-2 focal length f_{3b}, and the 3-3 focal length f_{3c} to sequentially increase. In an embodiment of the disclosure, based on the graph about voltage value-focal length of FIG. 6D, the electronic device 1000 may determine the 3-1 voltage value V₃ₐ to be applied to the 3-1 lens area 523a, the 3-2 voltage value V_{3b} to be applied to the 3-2 lens area 523b, and the 3-3 voltage value V_{3c} to be applied to the 3-3 lens area 523c, to be values that sequentially increase.

The graphs of FIGS. 6C and 6D are examples, and a voltage value-focal length relation may vary according to a liquid-crystal alignment scheme (e.g., a twisted nematic (TN) mode, a vertical alignment (VA) mode, etc.) or types of liquid crystal molecules.

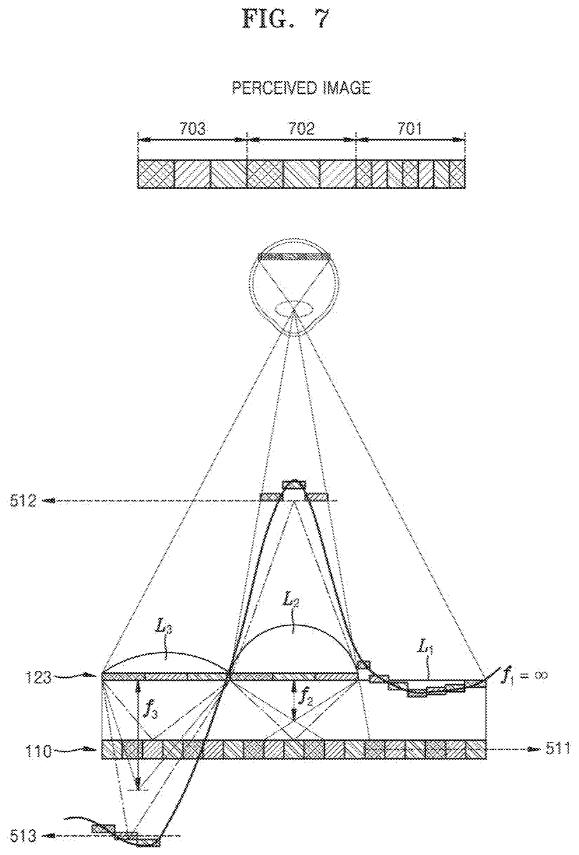

FIG. 7 is a diagram for describing an operation in which the electronic device 1000 provides an image that is represented in multiple depths over a plurality of different focal planes, according to an embodiment of the disclosure.

FIG. 7 is a diagram for describing images that are provided respectively via a first lens L₁ corresponding to the first lens area 521 (see FIG. 5) among the plurality of lenses, a second lens L₂ corresponding to the second lens area 522 (see FIG. 5), and a third lens L₃ corresponding to the third lens area 523 (see FIG. 5). FIG. 7 briefly illustrates one first lens L₁, one second lens L₂, and one third lens L₃ in the configuration of the liquid-crystal lens 123.

In an embodiment of the disclosure, the electronic device 1000 may provide an image corresponding to the first depth area 431 (see FIG. 5) via the first lens L₁. Hereinafter, the image corresponding to the first depth area 431 (see FIG. 5) may be referred to as a first depth image 701. Light that displays the first depth image 701 may pass through the first lens L₁ and may be perceived by a user.

The electronic device 1000 may apply the first voltage value V₁ (see FIG. 6C or 6D) for setting the first focal length f₁ to infinity to the first lens L₁. In other words, the electronic device 1000 may apply, to the first lens L₁, the first voltage value V₁ (see FIG. 6C or 6D) for forming the first focal plane 511 at the display 110. As a refractive index of the first lens L₁ is equal to a refractive index of a resin layer, the light that passes through the first lens L₁ is not be refracted. The electronic device 1000 may provide the first depth image 701 as a 2D image. The electronic device 1000 may provide the 2D image to the user without a change, the 2D image being displayed on the display 110. Also, the electronic device 1000 may provide the 2D image as an image that has a focus formed on the display 110. Accordingly, the electronic device 1000 may provide the 2D image with a high resolution and a high sharpness.

In an embodiment of the disclosure, the electronic device 1000 may provide an image corresponding to the second depth area 432 (see FIG. 5) via the second lens L₂. Hereinafter, the image corresponding to the second depth area 432 (see FIG. 5) may be referred to as a second depth image 702. Light that displays the second depth image 702 may pass through the second lens L₂ and may be perceived by a user.

The electronic device 1000 may apply the second voltage value V₂ (see FIG. 6C or 6D) to the second lens L₂, the second voltage value V₂ being for forming the second focal length f₂ to be less than a distance between the liquid-crystal lens 123 and the display 110. In other words, the electronic device 1000 may apply the second voltage value V₂ (see FIG. 6C or 6D) to the second lens L₂, the second voltage value V₂ being for forming the second focal plane 512 located closer than the display 110. Due to a difference between a refractive index of the second lens L₂ and a refractive index of a resin layer, light that passes through the second lens L₂ may be refracted. The electronic device 1000 may provide the second depth image 702 as a 3D image. In this regard, light that passes through the second lens L₂ may provide the second depth image 702 as a real image.

The second lens L₂ that provides the second depth image 702 located at a depth closer than the display 110 may be controlled to form the second focal plane 512 located at a depth closer than the display 110. Accordingly, the electronic device 1000 may increase a sharpness of an image displayed at a depth closer than the display 110.

In an embodiment of the disclosure, the electronic device 1000 may provide an image corresponding to the third depth area 433 (see FIG. 5) via the third lens L₃. Hereinafter, the image corresponding to the third depth area 433 (see FIG. 5) may be referred to as a third depth image 703. Light that displays the third depth image 703 may pass through the third lens L₃ and may be perceived by a user.

The electronic device 1000 may apply the third voltage value V₃ (see FIG. 6C or 6D) to the third lens L₃, the third voltage value V₃ being for forming the third focal length f₃ to be greater than the distance between the liquid-crystal lens 123 and the display 110. In other words, the electronic device 1000 may apply the third voltage value V₃ (see FIG. 6C or 6D) to the third lens L₃, the third voltage value V₃ being for forming the third focal plane 513 located remote from the display 110. Due to a difference between a refractive index of the third lens L₃ and a refractive index of a resin layer, light that passes through the third lens L₃ may be refracted. The electronic device 1000 may provide the third depth image 703 as a 3D image. In this regard, light that passes through the third lens L₃ may provide the third depth image 703 as a virtual image.

The third lens L₃ that provides the third depth image 703 located at a depth remote from the display 110 may be controlled to form the third focal plane 513 located at a depth remote from the display 110. Accordingly, the electronic device 1000 may increase a sharpness of an image displayed at a depth remote from the display 110.

When a focal length of a lens is set as a distance between the liquid-crystal lens 123 and the display 110, light that passes through one lens may display only one pixel. On the other hand, according to an embodiment of the disclosure, as the second focal length f₂ and the third focal length f₃ are set to be less or greater than the distance between the liquid-crystal lens 123, light that passes through one second lens L₂ and one third lens L₃ may display a plurality of pixels together. Accordingly, the electronic device 1000 may increase a resolution of a 3D image.

According to an embodiment of the disclosure, the electronic device 1000 may display an image having multiple depths over the focal planes 511, 512, and 513, by providing the focal planes 511, 512, and 513 having different depths. Accordingly, the electronic device 1000 may improve a resolution over an entire depth range, and objects at all depths in an image may be clearly provided.

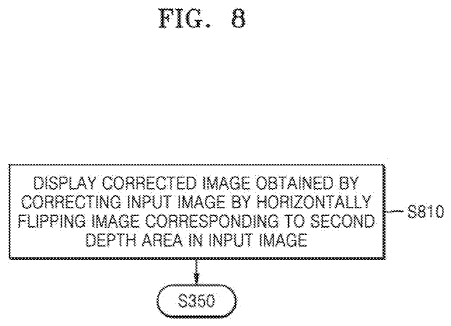

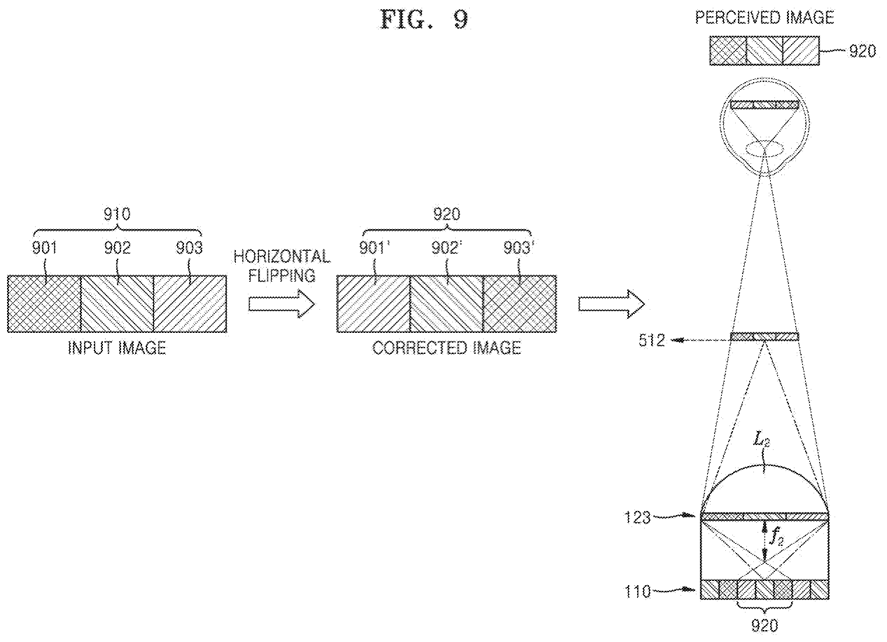

FIG. 8 is a flowchart for describing an operation in which the electronic device 1000 displays a corrected image, according to an embodiment of the disclosure. FIG. 9 is a flowchart for describing an operation in which the electronic device 1000 displays a corrected image, according to an embodiment of the disclosure.

Referring to FIG. 8, the method, performed by the electronic device 1000, of providing a 3D image may further include operation S810. In an embodiment of the disclosure, operation S810 may be executed by at least one processor included in the electronic device 1000.

After operation S810 shown in FIG. 8 is performed, operation S350 shown in FIG. 3 may be performed. Operation S810 shown in FIG. 8 may be performed while operations S310 to S340 shown in FIG. 3 are performed, or may be performed before or after operations S310 to S340 shown in FIG. 3 are performed.

In operation S810 of FIG. 8, the electronic device 1000 according to an embodiment of the disclosure may display a corrected image obtained by correcting an input image by horizontally flipping an image corresponding to a second depth area in the input image. The image corresponding to the second depth area may correspond to an area displayed at a depth closer than the display 110. Hereinafter, the image corresponding to the second depth area may be referred to as the second depth image. The second depth image may be provided via a second lens (or a second lens area) of which second focal plane is formed at a depth closer than the display 110.

As an image corresponding to a first depth area is provided from light that passes through a lens having a focal length set to infinity, the image that passes through the lens and is displayed on the display 110 without being refracted may be changelessly perceived by a user. As an image corresponding to a third depth area is provided from light that passes through a lens having a focal length greater than a distance to the display 110, the image may be provided as a virtual image. Accordingly, the image corresponding to the third depth area may be changelessly perceived by the user, in which an image that corresponds to an optical focus area of the lens and is of the image displayed on the display 110 is not flipped.

On the other hand, as an image corresponding to the second depth area is provided from light that passes through a lens having a focal length less than the distance to the display 110, the image may be provided as a real image. Accordingly, the image corresponding to the second depth area may be perceived by the user, in which an image that corresponds to an optical focus area of the lens and is of the image displayed on the display 110 is horizontally flipped.

Accordingly, in an embodiment of the disclosure, the electronic device 1000 may perform correction only on the image corresponding to the second depth area by horizontally flipping the image, and may not perform correction of horizontally flipping the image corresponding to the first depth area and the image corresponding to the third depth area in the input image. That is, in operation S810, the electronic device 1000 may display the image corresponding to the first depth area and the image corresponding to the third depth area without correction, and may display the image corresponding to the second depth area as a corrected image that is horizontally flipped.

Also referring to FIG. 9, in an embodiment of the disclosure, a second depth image 910 may be an image provided via light that passes through the second lens L₂. The second focal length f₂ of the second lens L₂ may be less than the distance between the display 110 and the liquid-crystal lens 123. The second focal plane 512 of the second lens L₂ may be formed at a depth (or position) closer to a user than the display 110.

Light that passes through the second lens L₂ may provide a real image. The light that passes through the second lens L₂ may provide an image obtained by horizontally flipping an image displayed on the display 110, according to an optical feature of the second lens L₂.

In an embodiment of the disclosure, the electronic device 1000 may perform correction by horizontally flipping a second depth image 910 of the input image in advance, and thus, may obtain a corrected image 920 (also referred to as the corrected second depth image 920) in which the second depth image 910 is horizontally flipped. For example, the second depth image 910 may include a first pixel 901, a second pixel 902, and a third pixel 903 which are arranged in parallel in a right direction. In the second depth image 910, the first pixel 901 may display blue, the second pixel 902 may display red, and the third pixel 903 may display green. That is, in the second depth image 910, blue, red, and green may be sequentially displayed in the right direction.

The electronic device 1000 may generate a corrected image by performing correction by horizontally flipping the first pixel 901, the second pixel 902, and the third pixel 903 in the second depth image 910. The corrected second depth image 920 of the corrected image includes a first pixel 901′, a second pixel 902′, and a third pixel 903′ which are arranged in parallel in the right direction, in which the first pixel 901′ may display green, the second pixel 902′ may display red, and the third pixel 903′ may display blue. That is, in the corrected second depth image 920, green, red, and blue may be sequentially displayed in the right direction.

According to an embodiment of the disclosure, even when an image that is horizontally flipped from an image displayed on the display 110 is provided to the second focal plane 512 due to the optical feature of the second lens L₂, the electronic device 1000 displays, on the display 110, a corrected image that has been horizontally flipped in advance, and thus, an image 930 that is finally perceived by a user may be equal (or may correspond) to the input image 910.

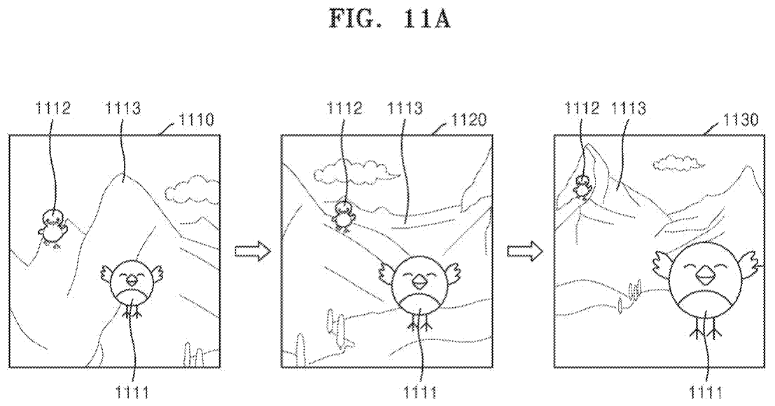

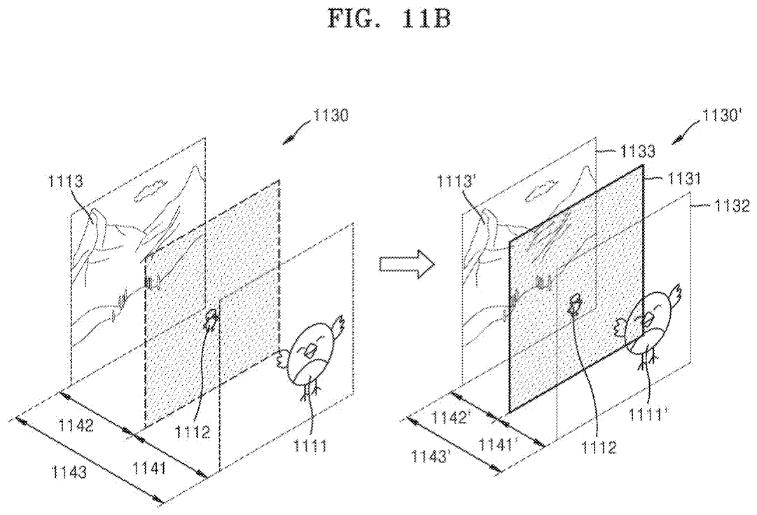

FIG. 10 is a flowchart for describing an operation in which the electronic device 1000 changes a range of depth areas, according to an embodiment of the disclosure. FIG. 11A is a diagram illustrating an example of consecutive frames included in an input image, according to an embodiment of the disclosure. FIG. 11B is a flowchart for describing a method, performed by the electronic device 1000, of changing a range of depth areas, according to an embodiment of the disclosure.

Referring to FIG. 10, the method, performed by the electronic device 1000, of providing a 3D image may further include operation S1010. In an embodiment of the disclosure, operation S1010 may be performed by at least one processor included in the electronic device 1000.

Operation S1010 shown in FIG. 10 may be performed after operation S310 shown in FIG. 3 is performed. Operation S320 shown in FIG. 3 may be performed after operation S1010 shown in FIG. 10 is performed.

In operation S1010 of FIG. 10, the electronic device 1000, according to an embodiment of the disclosure, may change a range of a plurality of depth areas in some frames among consecutive frames, based on movement of at least one object in the consecutive frames included in an input image.

FIG. 11A illustrates an example in which an input image includes a first frame 1110, a second frame 1120, and a third frame 1130 which are consecutive frames. Also referring to FIG. 11A, for example, the first, second, and third frames 1110, 1120, and 1130 may respectively include a first object 1111 located at a relatively small depth (i.e., a close range), a second object 1112 located at a medium depth (i.e., a medium range), and a third object 1113 located at a relatively great depth (i.e., a remote range). FIG. 11A illustrates an example in which the first object 1111 and the second object 1112 are each a bird, and the third object 1113 is a mountain. The second object 1112 is located at a depth of a reference value, and thus, may be included in a first depth area, the first object 1111 is located closer than the depth of the reference value, and thus, may be included in a second depth area, and the third object 1113 is located farther than the depth of the reference value, and thus, may be included in a third depth area.

According to an embodiment of the disclosure, in the first frame 1110, the second frame 1120, and the third frame 1130 which are consecutive frames, all the first object 1111, the second object 1112, and the third object 1113 may move. Accordingly, respective depth values of the first object 1111, the second object 1112, and the third object 1113 may be changed in the first frame 1110, the second frame 1120, and the third frame 1130.

For example, the first object 1111 may become closer to a user from the first frame 1110 toward the third frame 1130. That is, the first object 1111 may move to be located at a smaller depth.

For example, the second object 1112 may become farther from the user from the first frame 1110 toward the third frame 1130. That is, the second object 1112 may move to be located at a greater depth.

For example, the third object 1113 may become farther from the user from the first frame 1110 toward the third frame 1130. That is, the third object 1113 may move to be located at a greater depth.

For example, from the first frame 1110 toward the third frame 1130, a depth difference among the first object 1111, the second object 1112, and the third object 1113 may increase. The first object 1111 may rapidly come forward as it gets closer to the user rapidly. The second object 1112 and the third object 1113 may rapidly move back as they get farther from the user rapidly.

Also referring to FIG. 11B, based on movement of at least one object in consecutive frames, the electronic device 1000 may change a range of a plurality of depth areas in some frames among the consecutive frames. FIG. 11B illustrates an example in which a range of a plurality of depth areas are changed in the third frame 1130 of FIG. 11A.

The electronic device 1000 may identify that a distance difference among the first object 1111, the second object 1112, and the third object 1113 is sharply changed in the third frame 1130, according to movements of the first, second, and third objects 1111, 1112, and 1113. As the distance difference among the first object 1111, the second object 1112, and the third object 1113 sharply increases, the electronic device 1000 may determine that a strong 3D effect that may cause visual fatigue such as dizziness to a user may be provided if the distance difference is changelessly represented in an output image.

The electronic device 1000 may narrow a range of a depth section in the third frame 1130. For example, the electronic device 1000 may represent a depth value as an integer value between 0 and 255 in a depth map corresponding to the first frame and the second frame 1120, and may represent a reference value as 125. In a depth map corresponding the third frame 1130, the electronic device 1000 may equally maintain the reference value as 125 but may narrow a range of a depth section as an integer value between 100 and 150.

Accordingly, a depth difference 1141′ between a first object 1111′ and the second object 1112 according to the narrowed depth map may be less than a depth difference 1141 between the first object 1111 and the second object 1112 according to an original depth map. A depth difference 1142′ between the second object 1112 and a third object 1113′ according to the narrowed depth map may be less than a depth difference 1142 between the second object 1112 and the third object 1113 according to the original depth map. A depth difference 1143′ between the first object 1111′ and the third object 1113′ according to the narrowed depth map may be less than a depth difference 1143 between the first object 1111 and the third object 1113 according to the original depth map.

The electronic device 1000 may narrow depth representation in a final image 1130′, based on the narrowed depth map. Accordingly, the electronic device 1000 may provide the final image 1130′ in which the extent to which the first object 1111′ comes forward from the display 110 is decreased, compared to the input image 1130. Also, the electronic device 1000 may provide the final image 1130′ in which the extent to which the third object 1113′ moves back from the display 110 is decreased, compared to the input image 1130.

According to an embodiment of the disclosure, the electronic device 1000 may control a range of a depth section, and thus, may adjust a 3D effect of an image that is actually provided. For example, as shown in FIG. 11B, the electronic device 1000 may provide the final image 1130′ in which a 3D effect is overall decreased, and thus, may provide a 3D image that does not cause visual fatigue such as dizziness to the user.

In an embodiment of the disclosure, the electronic device 1000 may determine voltage values to be applied to a plurality of lenses, based on a depth map in which a depth section is changed.

For example, the electronic device 1000 may determine a focal length (e.g., a first focal length) of a corresponding lens (e.g., a first lens) and a voltage value (e.g., a first voltage value) to be applied to the corresponding lens, so as to allow a first focal plane 1131 to be formed based on a depth at which the second object 1112 is to be represented in the final image 1130′.

For example, the electronic device 1000 may determine a focal length (e.g., a second focal length) of a corresponding lens (e.g., a second lens) and a voltage value (e.g., a second voltage value) to be applied to the corresponding lens, so as to allow a second focal plane 1132 to be formed based on a depth at which the first object 1111′ is to be represented in the final image 1130′.

For example, the electronic device 1000 may determine a focal length (e.g., a third focal length) of a corresponding lens (e.g., a third lens) and a voltage value (e.g., a third voltage value) to be applied to the corresponding lens, so as to allow a third focal plane 1133 to be formed based on a depth at which the third object 1113′ is to be represented in the final image 1130′.

According to an embodiment of the disclosure, the electronic device 1000 may provide the focal planes 1131, 1132, and 1133 having different depths, and thus, may provide the final image 1130′ having multiple depths represented over the plurality of focal planes 1131, 1132, and 1133. In this regard, the electronic device 1000 may determine depths of the plurality of focal planes 1131, 1132, and 1133 by reflecting corrected depth representation. Accordingly, even when the electronic device 1000 corrects depth representation to adjust a 3D effect of an image, the electronic device 1000 may improve a resolution in an entire depth range in the image. Also, even when the electronic device 1000 corrects depth representation to adjust a 3D effect of an image, objects at all depths in the image may be clearly provided.

FIG. 11B illustrates an example in which correction of narrowing a depth section is performed, but the electronic device 1000 may perform correction of extending the depth section so as to increase a 3D effect or may perform correction of changing a depth area corresponding to a reference point.

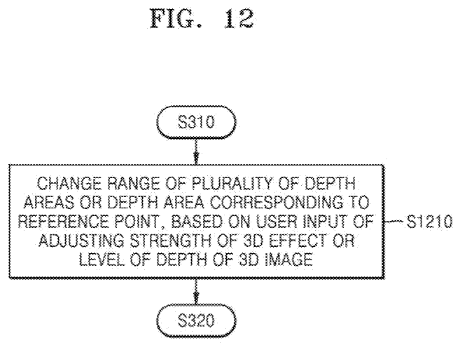

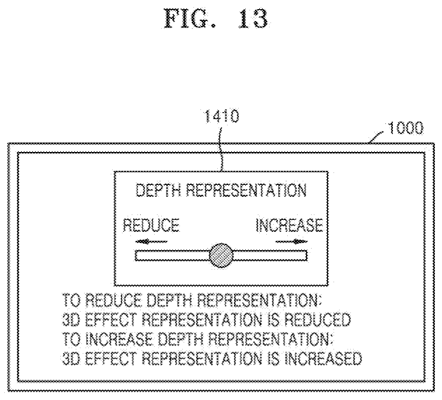

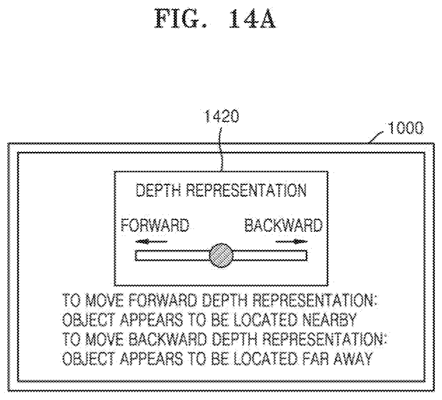

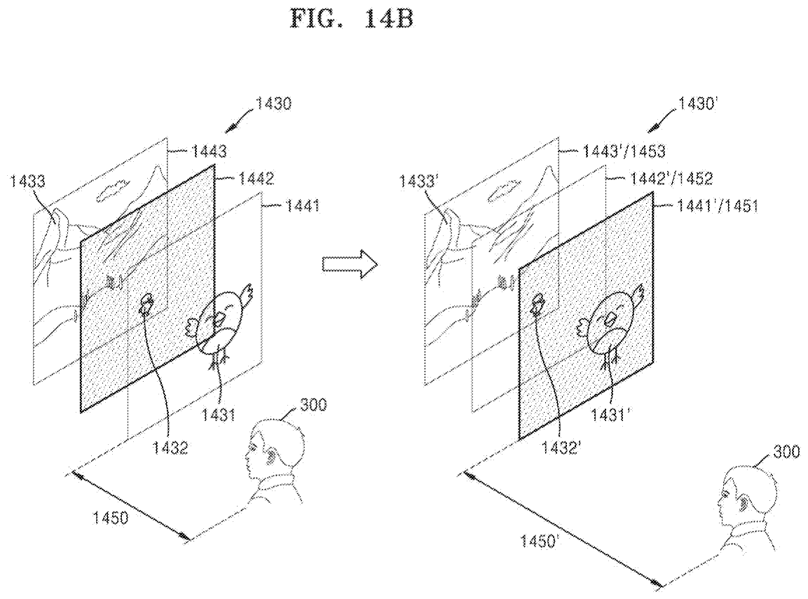

FIG. 12 is a flowchart for describing an operation in which the electronic device 1000 changes a range of depth areas or a depth area corresponding to a reference point, according to an embodiment of the disclosure. FIG. 13 is a diagram for describing an operation in which the electronic device 1000 changes a range of depth areas, according to an embodiment of the disclosure. FIG. 14A is a diagram for describing an operation in which the electronic device 1000 changes a depth area corresponding to a reference point, according to an embodiment of the disclosure. FIG. 14B is a diagram for describing an operation in which the electronic device 1000 changes a depth area corresponding to a reference point, according to an embodiment of the disclosure.

Referring to FIG. 12, the method, performed by the electronic device 1000, of providing a 3D image may further include operation S1210. In an embodiment of the disclosure, operation S1210 may be performed by the at least one processor included in the electronic device 1000.

Operation S1210 shown in FIG. 12 may be performed after operation S310 shown in FIG. 3 is performed. Operation S320 shown in FIG. 3 may be performed after operation S1210 shown in FIG. 12 is performed.

In operation S1210 of FIG. 12, the electronic device 1000, according to an embodiment of the disclosure, may change a range of a plurality of depth areas or a depth area corresponding to a reference point, based on a user input of adjusting a strength of a 3D effect or a level of a depth of the 3D image.

For example, when the electronic device 1000 receives a user input of adjusting a strength of a 3D effect of the 3D image, the electronic device 1000 may change a range of a plurality of depth areas, based on the user input. An operation thereof will be described in detail below with reference to FIG. 13.

For example, when the electronic device 1000 receives a user input of adjusting a level of a depth of the 3D image, the electronic device 1000 may change a depth area corresponding to a reference point, based on the user input. An operation thereof will be described in detail below with reference to FIGS. 14A and 14B.

Referring to FIG. 13, in an embodiment of the disclosure, the electronic device 1000 may provide a user interface 1410 capable of adjusting a strength of a 3D effect of a 3D image. For example, the electronic device 1000 may provide the user interface 1410 capable of reducing depth expression so as to decrease a strength of a 3D effect or expanding the depth expression so as to increase the strength of the 3D effect.

In an embodiment of the disclosure, the electronic device 1000 may obtain a user input of requesting adjustment in a strength of a 3D effect via the user interface 1410. For example, the electronic device 1000 may obtain a user input of requesting reduction in depth expression so as to decrease a strength of a 3D effect. Alternatively, for example, the electronic device 1000 may obtain a user input of requesting expansion in the depth expression so as to increase the strength of the 3D effect.

In an embodiment of the disclosure, the electronic device 1000 may change a range of a plurality of depth areas, according to a user input of requesting adjustment in a strength of a 3D effect. For example, the electronic device 1000 may change a range of a depth section in a process of generating a depth map about an input image. The electronic device 1000 may provide an image to which a corrected depth section is reflected, based on the depth map in which the depth section is changed.

For example, when the electronic device 1000 obtains a user input of requesting reduction in depth expression, the electronic device 1000 may narrow a range of a depth section in a process of generating a depth map about an input image. That is, the electronic device 1000 may provide an image in which a depth difference between objects is decreased.

For example, when the electronic device 1000 obtains a user input of requesting expansion in depth expression, the electronic device 1000 may increase a range of a depth section in a process of generating a depth map about an input image. That is, the electronic device 1000 may provide an image in which a depth difference between objects is increased.

As an example in which a final image is provided based on a changed range of a plurality of depth areas is described above with reference to FIG. 11B, detailed descriptions thereof are not provided here.

According to an embodiment of the disclosure, the electronic device 1000 may determine voltage values to be applied to a plurality of lenses, based on a depth map in which a depth section is changed. For example, when a range of a depth section is narrowed as a user input of requesting reduction in depth expression is obtained, the electronic device 1000 may determine voltage values to be applied to a plurality of lenses so as to allow a position of a second focal plane to be close to a first focal plane or to allow a position of a third focal plane to be close to the first focal plane. For example, when the range of the depth section is increased as a user input of requesting an increase in depth expression is obtained, the electronic device 1000 may determine voltage values to be applied to the plurality of lenses so as to allow the position of the second focal plane to be remote from the first focal plane or to allow the position of the third focal plane to be remote from the first focal plane.

According to an embodiment of the disclosure, the electronic device 1000 may determine depths of a plurality of focal planes by reflecting corrected depth expression. Accordingly, even when depth expression is corrected to adjust a 3D effect of an image according to a user input, the electronic device 1000 may improve a resolution in an entire depth range in the image. Also, even when depth expression is corrected to adjust a 3D effect of an image according to a user input, the electronic device 1000 may clearly provide objects at all depths in the image.

Referring to FIG. 14A, in an embodiment of the disclosure, the electronic device 1000 may provide a user interface 1420 capable of adjusting a level of a depth of a 3D image. For example, the electronic device 1000 may provide the user interface 1420 capable of moving forward depth expression so as to decrease a level of a depth or moving backward depth expression so as to increase a level of a depth.

In an embodiment of the disclosure, the electronic device 1000 may obtain a user input of requesting adjustment in a level of a depth. For example, the electronic device 1000 may obtain a user input corresponding to a request of moving forward depth expression so as to decrease a level of a depth. Alternatively, for example, the electronic device 1000 may obtain a user input corresponding to a request of moving back depth expression so as to increase a level of a depth.

In an embodiment of the disclosure, the electronic device 1000 may change a depth area corresponding to a reference point among a plurality of depth areas, according to a user input of requesting adjustment in a level of a depth. That is, the electronic device 1000 may change an area corresponding to a first depth area among a plurality of areas segmented based on a plurality of depth sections.

For example, according to a user input corresponding to a request of moving forward depth expression, the electronic device 1000 may change a third depth area as the first depth area, the third depth area being located at a depth greater than the first depth area in an original depth map according to an input image. In this regard, the electronic device 1000 may overall decrease depths of all depth areas. The electronic device 1000 may provide a final image in which objects are overall located close, compared to the input image.

For example, according to a user input corresponding to a request of moving backward depth expression, the electronic device 1000 may change a second depth area as the first depth area, the second depth area being located at a depth less than the first depth area in the original depth map according to the input image. In this regard, the electronic device 1000 may overall increase depths of all depth areas. The electronic device 1000 may provide a final image in which objects are overall located distant, compared to the input image.

According to an embodiment of the disclosure, the electronic device 1000 may provide focal planes having different depths, and thus, may provide an image having multiple depths represented over the plurality of focal planes. In this regard, the electronic device 1000 may determine depths of the plurality of focal planes, based on depth expression corrected according to a user input. Accordingly, even when the electronic device 1000 corrects depth representation to adjust a level of a depth of an image according to a user input, the electronic device 1000 may improve a resolution in an entire depth range in the image. Even when depth expression is corrected to adjust a level of a depth of an image according to a user input, the electronic device 1000 may clearly provide objects at all depths in the image.

Also referring to FIG. 14B, for example, an original depth map according to an input image 1430 may include a first area 1441 corresponding to a first depth section, a second area 1442 corresponding to a second depth section, and a third area 1443 corresponding to a third depth section. A first object 1431 is included in the first area 1441, a second object 1432 is included in the second area 1442, and a third object 1433 is included in the third area 1443. FIG. 14B illustrates an example in which the first object 1431 and the second object 1432 are each a bird, and the third object 1433 is a mountain.

In the original depth map according to the input image 1430, the second area 1442 including the second object 1432 may be determined as a first depth area. That is, a depth at which the second object 1432 is located may be a reference value. In the original depth map according to the input image 1430, the first area 1441 including the first object 1431 is located at a depth less than the second object 1432, and thus, may be determined as a second depth area. In the original depth map according to the input image 1430, the third area 1443 including the third object 1433 is located at a depth greater than the second object 1432, and thus, may be determined as a third depth area.

For example, the electronic device 1000 may receive a user input corresponding to a request of moving backward depth expression so as to increase a level of a depth. According to the received user input, the electronic device 1000 may change the first depth area as a first area 1441′ including a first object 1431′. That is, the electronic device 1000 may change the first area 1441′ from the second depth area to the first depth area. The electronic device 1000 may change the reference value as a depth at which the first object 1431′ is located. A depth 1450′ of the first object 1431′ in a changed depth map may be greater than a depth 1450 of the first object 1431 in the original depth map according to the input image 1430.

The electronic device 1000 may change a 3-1 depth area as a second area 1442′ including a second object 1432′, and may change a 3-2 depth area as a third area 1443′ including a third object 1433′. That is, the electronic device 1000 may change the second area 1442′ from the first depth area to the 3-1 depth area, and may change the third area 1443′ from the third depth area to the 3-2 depth area located at a greater depth. A depth of the second object 1432′ and a depth of the third object 1433′ in the changed depth map may be respectively greater than a depth of the second object 1432 and a depth of the third object 1433 in the original depth map according to the input image 1430.

Accordingly, according to the input image 1430, the first object 1431 is located closer than the display 110, the second object 1432 is located at the display 110, and the third object 1433 is located farther than the display 110, but, according to a final image 1430′ corrected based on a user input, it may be provided that the first object 1431′ is located at the display 110, the second object 1432′ is located farther than the display 110, and the third object 1433′ is located farther than the display 110 and the second object 1432′.

In an embodiment of the disclosure, the electronic device 1000 may determine focal lengths of a plurality of lenses and voltage values to be respectively applied to the plurality of lenses, based on a depth map in which depths of depth areas are overall changed. That is, the electronic device 1000 may determine a focal length of a corresponding lens and a voltage value to be applied to the corresponding lens, so as to allow focal planes corresponding to the depths of the depth areas to be formed in the final image 1430′.

For example, the electronic device 1000 may determine a focal length (e.g., a first focal length) of a corresponding lens (e.g., a first lens) and a voltage value (e.g., a first voltage value) to be applied to the corresponding lens, so as to allow a first focal plane 1451 located at the display 110 to be formed in an area displaying the first object 1431′. For example, the electronic device 1000 may determine focal lengths (e.g., third focal lengths) of corresponding lenses (e.g., third lenses) and voltage values (e.g., third voltage values) to be applied to the corresponding lenses, so as to allow a 3-1 focal plane 1452 located farther than the display 110 to be formed in an area displaying the second object 1432′ and to allow a 3-2 focal plane 1453 located farther than the 3-1 focal plane to be formed in an area displaying the third object 1433′.

According to an embodiment of the disclosure, the electronic device 1000 may provide the focal planes 1451, 1452, and 1453 having different depths, and thus, may provide the image 1430′ having multiple depths represented over the plurality of focal planes 1451, 1452, and 1453. Here, the electronic device 1000 may determine depths of the plurality of focal planes 1451, 1452, and 1453, based on corrected depth expression. Accordingly, even when the electronic device 1000 adjusts a level of a depth according to a user input, the electronic device 1000 may improve a resolution in an entire depth range in an image. Also, even when a level of a depth is adjusted according to a user input, the electronic device 1000 may clearly provide objects at all depths in the image.

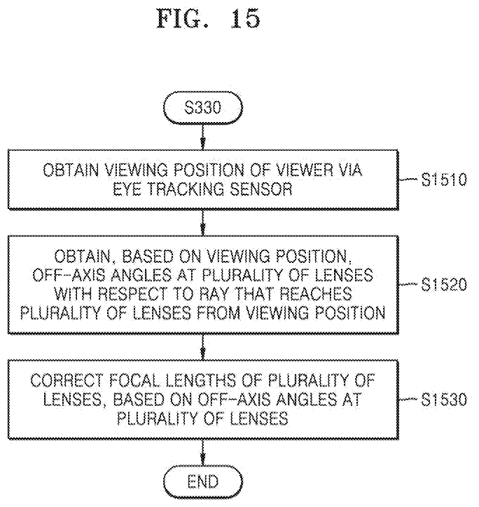

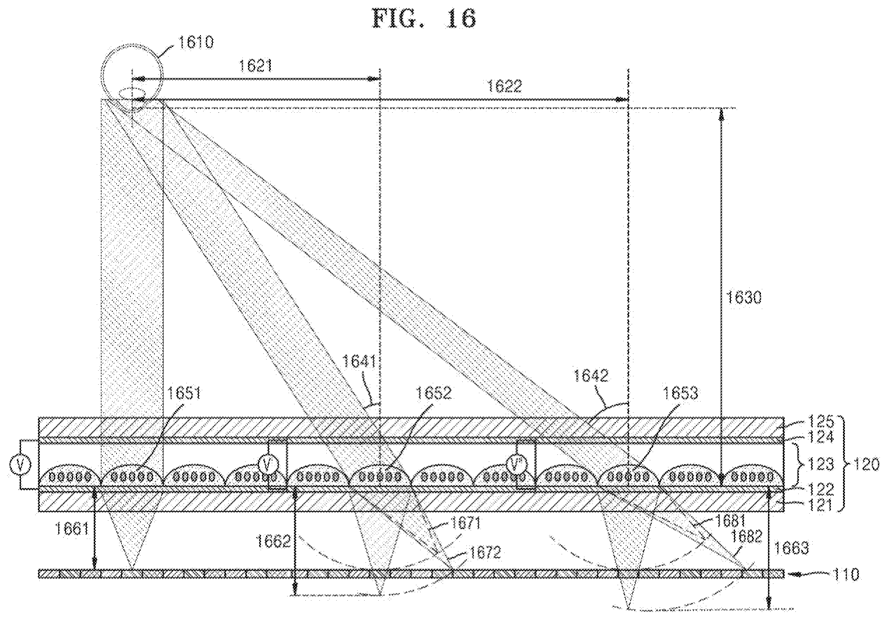

FIG. 15 is a flowchart for describing an operation in which the electronic device 1000 corrects a focal length of a lens, based on an off-axis angle, according to an embodiment of the disclosure. FIG. 16 is a flowchart for describing an operation in which the electronic device 1000 corrects focal lengths of a plurality of lenses, based on off-axis angles at the plurality of lenses, according to an embodiment of the disclosure.

Referring to FIG. 15, the method, performed by the electronic device 1000, of providing a 3D image may further include operation S1510 to operation S1530. In an embodiment of the disclosure, operation S1510 to operation S1530 may be performed by the at least one processor included in the electronic device 1000.

Operation S1510 shown in FIG. 15 may be performed after operation S310 shown in FIG. 3 is performed. Operation S340 shown in FIG. 3 may be performed after operation S1530 shown in FIG. 15 is performed.

In operation S1510 of FIG. 15, the electronic device 1000, according to an embodiment of the disclosure, may obtain a viewing position of a viewer via an eye tracking sensor.

In an embodiment of the disclosure, the electronic device 1000 may further include the eye tracking sensor. The electronic device 1000 may track in real time the viewing position of a user (i.e., the viewer) via the eye tracking sensor. For example, the electronic device 1000 may obtain the viewing position of the user in a 3D space, via the eye tracking sensor.

In operation S1520 of FIG. 15, the electronic device 1000, according to an embodiment of the disclosure, may obtain, based on the viewing position, off-axis angles at a plurality of lenses with respect to a ray reaching to the plurality of lenses from the viewing position. In the disclosure, an off-axis angle indicates the angle by which a ray deviates from an optical axis that is a center axis of a lens when the ray is incident on the lens.

In an embodiment of the disclosure, the electronic device 1000 may calculate respective off-axis angles at a plurality of lenses, based on information of distances between a user's viewpoint on a screen and the lenses, and information of distances between a viewing position of the user and the lenses. The greater the distance between a lens and a user's gaze is, the greater the off-axis angle may become. For example, when the user's gaze is toward the center of the screen of the electronic device 1000, the off-axis angle may increase toward an outer part of the screen.

In operation S1530 of FIG. 15, the electronic device 1000, according to an embodiment of the disclosure, may correct focal lengths of the plurality of lenses, based on the off-axis angles at the plurality of lenses.

In an embodiment of the disclosure, a position of a focus formed at a ray that passes through an outer part of a lens may be different from a position of a focus formed at a ray that passes through a center of the lens. Accordingly, a focus depth formed at the ray that passes through the outer part of the lens may be different from a focus depth formed at the ray that passes through the center of the lens. In this case, the electronic device 1000 may provide an image in which a sharpness deteriorates in the outer part of the screen which is remote from the user's gaze.

In general, a focal length of a lens may be determined based on a ray that passes through a center of the lens. The electronic device 1000, according to an embodiment of the disclosure, may correct respective focal lengths of the plurality of lenses, based on the off-axis angles at the plurality of lenses, so that focuses of the plurality of lenses may be formed at more exact positions, and an image with an improved sharpness may be provided.

Hereinafter, with reference to FIG. 16, an operation of correcting a focal length of a lens, based on an off-axis angle, will now be described in detail.

Referring to FIG. 16, in an embodiment of the disclosure, the electronic device 1000 may obtain a viewing position of a user, via an eye tracking sensor. For example, the electronic device 1000 may obtain the viewing position in a 3D space. The viewing position in the 3D space may include 2D coordinate information corresponding to a viewpoint of the user on a plane formed by the screen and distance information between the user and the screen.

In an embodiment of the disclosure, the electronic device 1000 may obtain, based on a viewing position, respective off-axis angles at a plurality of lenses 1651, 1652, and 1653 with respect to light that reaches from an eye 1610 of the user to the plurality of lenses 1651, 1652, and 1653. With reference to FIG. 16, a procedure in which a focal length of a lens (hereinafter, referred to as the first peripheral lens 1652) remote from the viewpoint of the user by a first distance 1621 and a focal length of a lens (hereinafter, referred to as the second peripheral lens 1653) remote from the viewpoint of the user by a second distance 1622 among the plurality of lenses 1651, 1652, and 1653 included in the liquid-crystal lens 123 are corrected will be representatively described.

A lens (hereinafter, referred to as the center lens 1651) located in a user's gaze direction corresponds to a lens through which a ray emitted from the eye 1610 of the user passes through the center, and thus, an off-axis angle at the center lens 1651 is 0 degrees.

An off-axis angle 1641 (hereinafter, referred to as the first off-axis angle 1641) at the first peripheral lens 1652 may be determined from the first distance 1621 between the user's viewpoint and the first peripheral lens 1652 and a distance 1630 between the eye 1610 of the user and the first peripheral lens 1652 based on a normal line direction of the screen. The first off-axis angle 1641 at the first peripheral lens 1652 may be calculated from two pieces of distance information by using the arctan function.

An off-axis angle 1642 (hereinafter, referred to as the second off-axis angle 1642) at the second peripheral lens 1653 may be determined from the second distance 1622 between the user's viewpoint and the second peripheral lens 1653 and the distance 1630 between the eye 1610 of the user and the second peripheral lens 1653 based on the normal line direction of the screen. The second off-axis angle 1642 at the second peripheral lens 1653 may be calculated from two pieces of distance information by using the arctan function. The second off-axis angle 1642 at the second peripheral lens 1653 may be greater than the first off-axis angle 1641 at the first peripheral lens 1652.

A case may be assumed, in which a focal length of the first peripheral lens 1652 is set to be equal to a distance between the liquid-crystal lens 123 and the display 110 so as to allow a focus of the first peripheral lens 1652 to be formed at one pixel in the display 110. In this case, a ray that passes through the center of the first peripheral lens 1652 is transmitted as a straight line, and thus, is correctly formed at a focus-set position (e.g., a depth), but, a ray 1671 that is incident with the first off-axis angle 1641 is incident on a boundary of the first peripheral lens 1652, and thus, may be formed at position (e.g., a depth) for which focus is different. For example, a focus of the ray that passes through the center of the first peripheral lens 1652 is correctly set at one pixel in the display 110, but, the ray 1671 that is incident with the first off-axis angle 1641 is incident on the boundary of the first peripheral lens 1652, and thus, a focus may be formed at a depth closer than the display 110. Accordingly, light provided via the first peripheral lens 1652 may provide a distorted or blurry image.

Equally, a case may be assumed, in which a focal length of the second peripheral lens 1653 is set to be equal to the distance between the liquid-crystal lens 123 and the display 110 so as to allow a focus of the second peripheral lens 1653 to be formed at one pixel in the display 110. In this case, a ray that passes through the center of the second peripheral lens 1653 is transmitted as a straight line, and thus, is correctly formed at a focus-set position (e.g., a depth), but, a ray 1681 that is incident with the second off-axis angle 1642 is incident on a boundary of the second peripheral lens 1653, and thus, may be formed at position (e.g., a focus depth) for which focus is different. For example, a focus of the ray that passes through the center of the second peripheral lens 1653 is correctly set at one pixel in the display 110, but, the ray 1681 that is incident with the second off-axis angle 1642 is incident on the boundary of the second peripheral lens 1653, and thus, a focus may be formed at a depth closer than the display 110. Accordingly, light provided via the second peripheral lens 1653 may provide a distorted or blurry image. Here, when an off-axis angle increases, a difference to a focus depth formed by a ray may increase, compared to the ray that passes through the lens center. That is, light provided via the second peripheral lens 1653 may provide an image that is further distorted or blurry than light provided via the first peripheral lens 1652.

In an embodiment of the disclosure, the electronic device 1000 may correct respective focal lengths of the plurality of lenses 1651, 1652, and 1653, based on off-axis angles at the plurality of lenses 1651, 1652, and 1653. According to an embodiment of the disclosure, the electronic device 1000 may perform correction by increasing a focal length of a lens on which a ray emitted from the eye 1610 of the user is incident with an angle. According to an embodiment of the disclosure, when an off-axis angle of a lens on which a ray is incident from the eye 1610 of the user increases, the electronic device 1000 may perform correction by further increasing a focal length.

For example, a focal length of the first peripheral lens 1652 may be determined based on a ray being incident on the center of the first peripheral lens 1652, and thus, may be determined to be equal to the distance between the liquid-crystal lens 123 and the display 110 so as to allow a focus to be formed at one pixel in the display 110. Here, the electronic device 1000 may correct the focal length of the first peripheral lens 1652 by considering the first off-axis angle 1641 of a ray incident on the first peripheral lens 1652. For example, the electronic device 1000 may perform correction by increasing the focal length so as to allow the ray incident with the first off-axis angle 1641 to pass through the first peripheral lens 1652 and to form a focus at one pixel in the display 110. Hereinafter, the corrected focal length of the first peripheral lens 1652 is referred to as a first corrected length 1662.

For example, a focal length of the second peripheral lens 1653 may be determined based on a ray being incident on the center of the second peripheral lens 1653, and thus, may be determined to be equal to the distance between the liquid-crystal lens 123 and the display 110 so as to allow a focus to be formed at one pixel in the display 110. Here, the electronic device 1000 may correct the focal length of the second peripheral lens 1653 by considering the second off-axis angle 1642 of a ray incident on the second peripheral lens 1653. For example, the electronic device 1000 may perform correction by increasing the focal length so as to allow the ray incident with the second off-axis angle 1642 to pass through the second peripheral lens 1653 and to form a focus at one pixel in the display 110. Hereinafter, the corrected focal length of the second peripheral lens 1653 is referred to as a second corrected length 1663.

In this regard, as the second off-axis angle 1642 of a ray incident on the second peripheral lens 1653 is greater than the first off-axis angle 1641 of a ray incident on the first peripheral lens 1652, a focus depth that has to be corrected at the second peripheral lens 1653 may be greater than a focus depth that has to be corrected at the first peripheral lens 1652. Therefore, the electronic device 1000 may correct the second corrected length 1663 to be longer than the first corrected length 1662.

In an embodiment of the disclosure, the electronic device 1000 may determine voltage values to be applied to the plurality of lenses 1651, 1652, and 1653, based on the focal lengths 1662 and 1663 of the plurality of lenses 1652 and 1653 which are corrected by considering off-axis angles. For example, a voltage value V to be applied to the center lens 1651 may be determined to be a voltage value for setting a focal length of the center lens 1651 as a distance to the display 110. For example, a voltage value V′ to be applied to the first peripheral lens 1652 may be determined to be a voltage value for setting a focal length of the first peripheral lens 1652 as the first corrected length 1662 that is increased, compared to the focal length 1661 of the center lens 1651. For example, a voltage value V″ to be applied to the second peripheral lens 1653 may be determined to be a voltage value for setting a focal length of the second peripheral lens 1653 as the second corrected length 1663 that is increased, compared to the focal length 1661 of the center lens 1651.

According to an embodiment of the disclosure, as the voltage value V′ corresponding to the first corrected length 1662 is applied to the first peripheral lens 1652, a ray 1672 that is incident on the first peripheral lens 1652 may form a focus at one pixel in the display 110. Accordingly, distortion may be decreased and a sharpness may be increased in an image that the electronic device 1000 provides via the first peripheral lens 1652. According to an embodiment of the disclosure, as the voltage value V″ corresponding to the second corrected length 1663 is applied to the second peripheral lens 1653, a ray 1682 that is incident on the second peripheral lens 1653 may form a focus at one pixel in the display 110. Accordingly, distortion may be decreased and a sharpness may be increased in an image that the electronic device 1000 provides via the second peripheral lens 1653.

As light having passed through a lens is not correctly focused on a focal plane in an outer part of a screen at which an off-axis angle increases, lens aberration forming image distortion may occur. In this case, crosstalk may occur, in which a boundary of an object is not clear and an afterimage occurs causing blurriness due to input images respectively provided to the left eye and the right eye incorrectly, such that a quality-degraded image may be provided. However, according to an embodiment of the disclosure, the electronic device 1000 may correct focal lengths of lenses by considering respective off-axis angles, and thus, may prevent quality degradation due to the crosstalk at the outer part of the screen.

FIG. 16 illustrates an example of depths at which focuses are formed in respective lenses, and a position (or depth) at which a focus is formed in each lens may vary according to a display-target image (e.g., 2D image or 3D image) and a depth of a display-target object. For convenience of descriptions, FIG. 16 illustrates the example in which focuses of all lenses are formed at the same depth, however, focus depths may be differently formed according to positions of the lenses so as to provide focal planes at different depths.

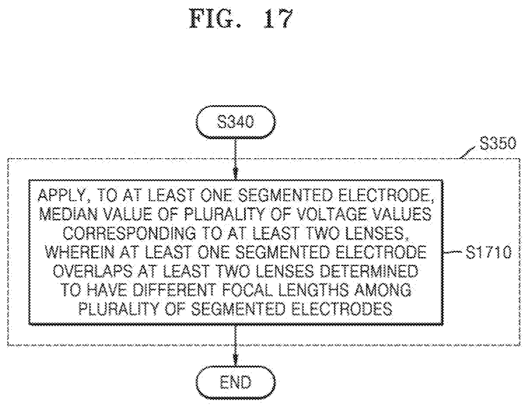

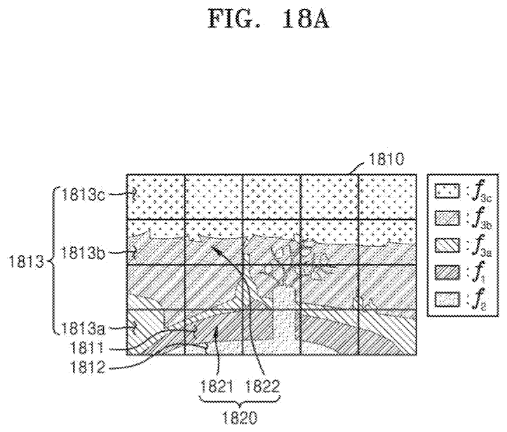

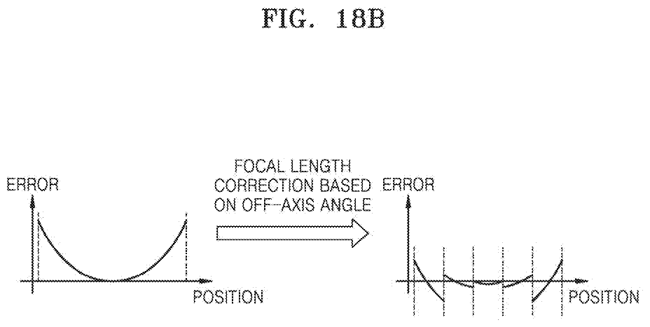

FIG. 17 is a flowchart for describing an operation in which the electronic device 1000 applies voltage to a plurality of segmented electrodes included in the lens array 120, according to an embodiment of the disclosure. FIG. 18A is a diagram for describing a plurality of segmented electrodes included in the lens array 120 of the electronic device 1000, according to an embodiment of the disclosure. FIG. 18B is a diagram for describing an operation in which the electronic device 1000 applies voltage to a plurality of segmented electrodes, according to an embodiment of the disclosure.

Referring to FIG. 17, the method, performed by the electronic device 1000, of providing a 3D image may further include operation S1710. In an embodiment of the disclosure, operation S1710 may be performed by the at least one processor included in the electronic device 1000.

Operation S1710 shown in FIG. 17 particularly specifies operation S350 shown in FIG. 3. Operation S340 shown in FIG. 3 may be performed after operation S1710 shown in FIG. 17 is performed.

In operation S1710 of FIG. 17, the electronic device 1000, according to an embodiment of the disclosure, may apply, to at least one segmented electrode, a median value of a plurality of voltage values corresponding to at least two lenses, wherein the at least one segmented electrode overlaps the at least two lenses determined to have different focal lengths among the plurality of segmented electrodes.

In an embodiment of the disclosure, at least one of a first electrode layer or a second electrode layer included in the lens array 120 may include the plurality of segmented electrodes. For example, the first electrode layer may be configured as segmented electrodes, and the second electrode layer may be configured as an electrode formed on an entire surface of a liquid-crystal lens. In this regard, a common voltage may be applied to the second electrode layer, and voltage values to be respectively applied to the segmented electrodes may be controlled on the first electrode layer. Alternatively, for example, the first electrode layer may be configured as an electrode formed on an entire surface of the liquid-crystal lens, and the second electrode layer may be configured as segmented electrodes. In this regard, a common voltage may be applied to the first electrode layer, and voltage values to be respectively applied to the segmented electrodes may be controlled on the second electrode layer. Alternatively, for example, both the first electrode layer and the second electrode layer may be configured as segmented electrodes.

FIG. 18A illustrates an example of a liquid-crystal lens 1810 in which a plurality of lens areas 1811, 1812, and 1813 are defined, and a first electrode layer 1820 configured as segmented electrodes 1821 and 1822. FIG. 18A illustrates an example in which the first electrode layer 1820 is configured as the segmented electrodes 1821 and 1822 in 5 rows and 4 columns. However, an embodiment of the disclosure is not limited thereto, and an array form and the number of the segmented electrodes 1821 and 1822 configuring the first electrode layer 1820 may be variously set.

In an embodiment of the disclosure, the segmented electrodes 1821 and 1822 may include electrodes that are equally segmented. That is, a horizontal width and a vertical width of each of the segmented electrodes 1821 and 1822 may be equal to each other.

In an embodiment of the disclosure, one or more segmented electrodes among the segmented electrodes 1821 and 1822 may overlap two or more of a first lens area 1811, a second lens area 1812, or a third lens area 1813.

For example, the segmented electrode 1821 located at the fourth column and second row may overlap the first lens area 1811 ought to have a first focal length f₁, the second lens area 1812 ought to have a second focal length f₂, and a 3-1 lens area 1813a ought to have a 3-1 focal length f₃ₐ. The electronic device 1000 may determine to apply, to the segmented electrode 1821 located at the fourth column and second row, a median value (e.g., an average value) of a first voltage value to be applied to the first lens area 1811 so as to have the first focal length f₁, a second voltage value to be applied to the second lens area 1812 so as to have the second focal length f₂, and a third voltage value to be applied to the 3-1 lens area 1813a so as to have the 3-1 focal length f₃ₐ.

In an embodiment of the disclosure, one or more of the second lens area 1812 or the third lens area 1813 may be provided as a plurality of lens areas having different focal lengths. For example, when it is assumed that the third lens area 1813 is provided as 3-1 to 3-3 lens areas 1813a, 1813b, and 1813c having different focal lengths, one or more segmented electrodes among the segmented electrodes 1821 and 1822 may overlap two or more of the 3-1 to 3-3 lens areas 1813a, 1813b, and 1813c.

For example, the segmented electrode 1822 located at the second column and second row may overlap the 3-2 lens area 1813b ought to have a 3-2 focal length f_{3b} and the 3-3 lens area 1813c ought to have a 3-3 focal length f_{3c}. The electronic device 1000 may determine to apply, to the segmented electrode 1822 located at the second column and second row, a median value (e.g., an average value) of a 3-2 voltage value to be applied to the 3-2 lens area 1813b so as to have the 3-2 focal length f_{3b} and a 3-3 voltage value to be applied to the 3-3 lens area 1813c so as to have the 3-3 focal length f_{3c}.

According to an embodiment of the disclosure, the electronic device 1000 may determine to apply a voltage value according to a larger lens area in a segmented electrode that overlaps two or more different lens areas.

Referring to FIG. 18B, in an embodiment of the disclosure, the electronic device 1000 may obtain, based on a viewing position of a user, off-axis angles at a plurality of lenses with respect to a ray that reaches the plurality of lenses from the viewing position, and may correct focal lengths of the plurality of lenses, based on the off-axis angles. For example, the electronic device 1000 may correct the focal lengths of the plurality of lenses to focal lengths in which an error of a focal depth may be solved. As a process of correcting focal lengths of lenses, based on off-axis angles, is described with reference to FIG. 16, detailed descriptions thereof are not provided here.

The graph in the left in FIG. 18A indicates, when it is assumed that a user's gaze faces a center of a screen, an error of a focus depth which occurs according to a position in a particular direction of the display 110. In an outer part of the screen which is distant from the user's gaze, an off-axis angle of the ray that reaches the screen from the viewing position of the user may increase. A ray may pass through a boundary of a lens that is among a plurality of lenses in a liquid-crystal lens and is located in the outer part of the screen. In the outer part of the screen, an off-axis angle of the ray at the lens increases, and thus, an error of a focus depth may increase. In the disclosure, an error of a focus depth may indicate a difference between a focus depth formed in a ray passing through a center of a lens and a focus depth formed in a ray passing through a boundary of the lens with a particular off-axis angle. As shown in the left graph, an error of a focus depth may sharply increase in the outer part of the screen.

In an embodiment of the disclosure, the electronic device 1000 may determine voltage values to be applied to a plurality of lenses, based on corrected focal lengths of the lenses. For example, the first electrode layer and/or the second electrode layer may be configured as segmented electrodes, and the focal lengths of the lenses may be controlled by controlling the voltage values to be respectively applied to the plurality of lenses. In this regard, a plurality of lenses may overlap one segmented electrode. According to an embodiment of the disclosure, the electronic device 1000 may determine a voltage value to be applied to a corresponding segmented electrode as a median value of voltage values that are calculated from corrected focal lengths of lenses overlapping the corresponding segmented electrode.

The graph in the right in FIG. 18A indicates an error of a focus depth which occurs according to a position in a particular direction when the electronic device 1000 provides five segmented electrodes arranged in a particular direction (e.g., a column direction) of a display and applies a median value of voltage values of lenses overlapping each of the segmented electrodes. As shown in the right graph, according to an embodiment of the disclosure, a voltage value capable of correcting a medium level of an error of a focus depth which occurs in overlapping lenses may be applied to each segmented electrode. The electronic device 1000 may control a voltage value applied to each segmented electrode, and thus, may minimize an error of a focus depth which occurs in each segmented electrode. Accordingly, the electronic device 1000 may provide an image with a high sharpness and low distortion over an entire surface of a screen, regardless of a viewing position of a user.

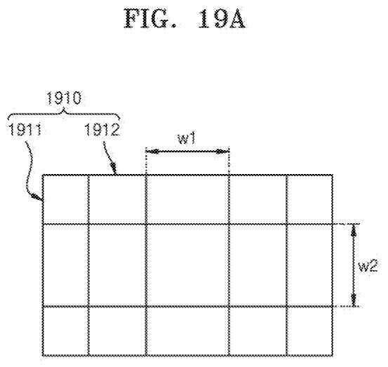

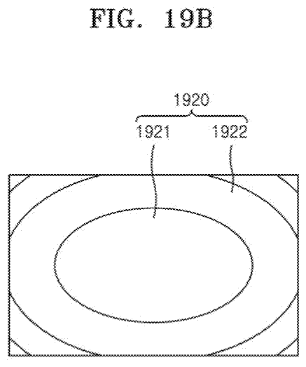

FIG. 19A is a diagram for describing a plurality of segmented electrodes included in the lens array 120 of the electronic device 1000, according to an embodiment of the disclosure. FIG. 19B is a diagram for describing a plurality of segmented electrodes included in the lens array 120 of the electronic device 1000, according to an embodiment of the disclosure.

Referring to FIG. 19A, in an embodiment of the disclosure, at least one of a first electrode layer or a second electrode layer included in the lens array 120 may include a plurality of segmented electrodes. FIG. 19A illustrates an example of a first electrode layer 1910 configured as segmented electrodes 1911 and 1912. FIG. 19A illustrates an example in which the first electrode layer 1910 is configured as the segmented electrodes 1911 and 1912 in 5 rows and 4 columns.

In an embodiment of the disclosure, the segmented electrodes 1911 and 1912 may include electrodes that are not equally segmented. That is, a horizontal width w1 and a vertical width w2 of each of the segmented electrodes 1911 and 1912 may vary according to a position of a segmented electrode.

In an embodiment of the disclosure, the horizontal width w1 and/or the vertical width w2 may decrease from the center toward the boundary in the segmented electrodes 1911 and 1912. The horizontal width w1 of the segmented electrodes 1911 arranged on the same row may decrease from the center toward the boundary. The vertical width w2 of the segmented electrodes 1912 arranged on the same column may decrease from the center toward the boundary. A size of each of the segmented electrodes 1911 and 1912 may decrease from the center toward the boundary.

An error of a focus depth which occurs due to an off-axis angle may sharply increase toward the outer part of the screen. According to an embodiment of the disclosure, the electronic device 1000 may provide the segmented electrodes 1911 and 1912 of which size decreases toward the outer part of the screen, and thus, may finely correct an error of a focus depth which occurs in the outer part. Accordingly, compared to segmented electrodes that are equally segmented, an error of a focus depth in the outer part may be further decreased.

Referring to FIG. 19B, in an embodiment of the disclosure, at least one of a first electrode layer or a second electrode layer included in the lens array 120 may include a plurality of segmented electrodes. FIG. 19B illustrates an example of a first electrode layer 1920 configured as segmented electrodes 1921 and 1922.

In an embodiment of the disclosure, the segmented electrodes 1921 and 1922 may include electrodes that are segmented into a concentric circle array. In an embodiment of the disclosure, in the concentric circle array of the segmented electrodes 1921 and 1922, a difference between radii of two circles formed by neighboring segmented electrodes 1921 and 1922 may decrease toward the outer part.

An error of a focus depth which occurs due to an off-axis angle may sharply increase toward the outer part of the screen. According to an embodiment of the disclosure, the electronic device 1000 may provide the segmented electrodes 1921 and 1922 of which size decreases toward the outer part of the screen, and thus, may finely correct an error of a focus depth which occurs in the outer part. Accordingly, compared to segmented electrodes that are equally segmented, an error of a focus depth in the outer part may be further decreased.

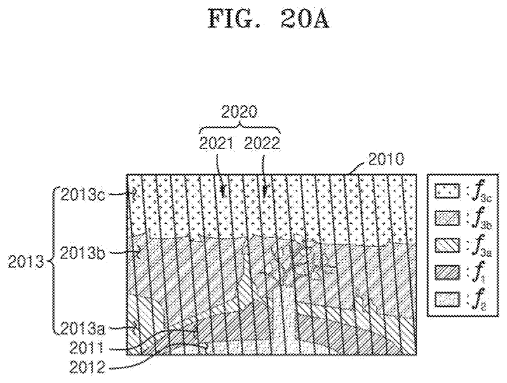

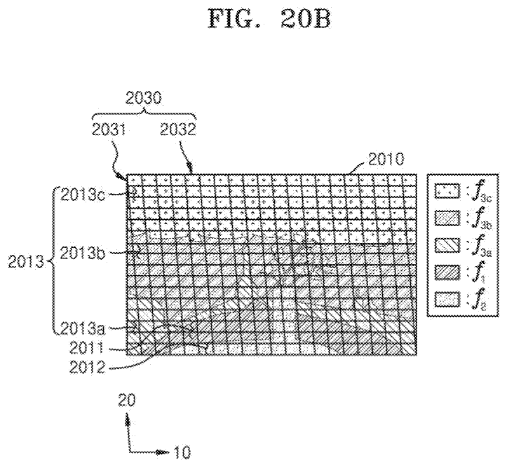

FIG. 20A is a diagram for describing a plurality of lenticular lenses included in the lens array 120 of the electronic device 1000, according to an embodiment of the disclosure. FIG. 20B is a diagram for describing a plurality of lenticular lenses included in the lens array 120 of the electronic device 1000, according to an embodiment of the disclosure.

Referring to FIG. 20A, in an embodiment of the disclosure, a plurality of lenses 2020 included in a liquid-crystal lens 2010 may include a plurality of lenticular lens configured as lenticular-shape lenses. FIG. 20A illustrates an example of a plurality of lens areas 2011, 2012, 2013a, 2013b, and 2013c defined in the liquid-crystal lens 2010 and a plurality of lenses 2021 and 2022 included in the liquid-crystal lens 2010.

In an embodiment of the disclosure, the plurality of lenses 2020 may include the lenses 2021 and 2022 arranged in a row direction. However, an embodiment of the disclosure is not limited thereto, and the plurality of lenses 2020 may include lenses arranged in a column direction.

In an embodiment of the disclosure, the plurality of lenses 2020 may be slantingly arranged, compared to a plurality of pixels included in the display 110. In this regard, slanted arrangement may indicate that each of the plurality of lenses 2020 does not overlap pixels located at a certain row or a certain column among the plurality of pixels included in the display 110 but overlaps pixels located at different rows or columns.

For example, when the plurality of lenses 2020 are arranged in a row direction, each of the plurality of lenses 2020 may not overlap only pixels located at a certain column among the plurality of pixels but may also overlap pixels located at different columns. When the plurality of lenses 2020 are arranged in a row direction, each of the plurality of lenses 2020 may extend in a direction that is slant by a preset angle with respect to a column direction.

In an embodiment of the disclosure, one or more lenses 2020 may include two or more of a first lens area 2011, a second lens area 2012, or a third lens area 2013. In an embodiment of the disclosure, the third lens area 2013 may be provided as a plurality of lens areas (e.g., a 3-1 lens area 2013a, a 3-2 lens area 2013b, and a 3-3 lens area 2013c), and two or more of the 3-1 lens area 2013a, the 3-2 lens area 2013b, and the 3-3 lens area 2013c may be included in the one or more lenses 2020.

In an embodiment of the disclosure, the electronic device 1000 may determine respective focal lengths (f₁, f₂, f₃ₐ, f_{3b}, and f_{3c} of a plurality of lens areas 2011, 2012, 2013a, 2013b, and 2013c, and based on the determination, may determine voltage values to be respectively applied to the plurality of lens areas 2011, 2012, 2013a, 2013b, and 2013c. The electronic device 1000 may control a voltage value to be applied, according to an area of the lens including the plurality of lens areas 2011, 2012, 2013a, 2013b, and 2013c. Accordingly, the electronic device 1000 may control a focal length for each lens area in one lens.

Referring to FIG. 20B, in an embodiment of the disclosure, a plurality of lenses 2030 included in the liquid-crystal lens 2010 may include a plurality of lenticular lens configured as lenticular-shape lenses. FIG. 20B illustrates an example of the plurality of lens areas 2011, 2012, 2013a, 2013b, and 2013c defined in the liquid-crystal lens 2010 and a plurality of lenses 2031 and 2032 included in the liquid-crystal lens 2010.

In an embodiment of the disclosure, the plurality of lenses 2030 may include the lenses 2031 arranged in a first direction 10 and the lenses 2032 arranged in a second direction 20 perpendicular to the first direction 10. For example, the first direction 10 may correspond to a row direction, and the second direction 20 may correspond to a direction that is slant by a preset angle with respect to the row direction. Alternatively, for example, the first direction 10 may correspond to a column direction, and the second direction 20 may correspond to a direction that is slant by a preset angle with respect to the column direction.

In an embodiment of the disclosure, the electronic device 1000 may provide the plurality of lenses 2030 in a 2D array, and thus, may provide not only a horizontal parallax but also provide a vertical parallax. Accordingly, compared to a case of providing lenses in a one-dimensional array, the electronic device 1000 may provide images with further various views. Therefore, the electronic device 1000 may provide different images according to not only horizontal viewpoints but also to vertical viewpoints, and thus, may provide a 3D image with an improved 3D effect.

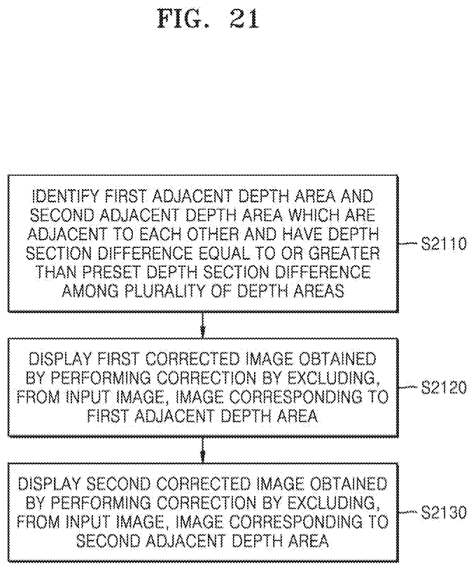

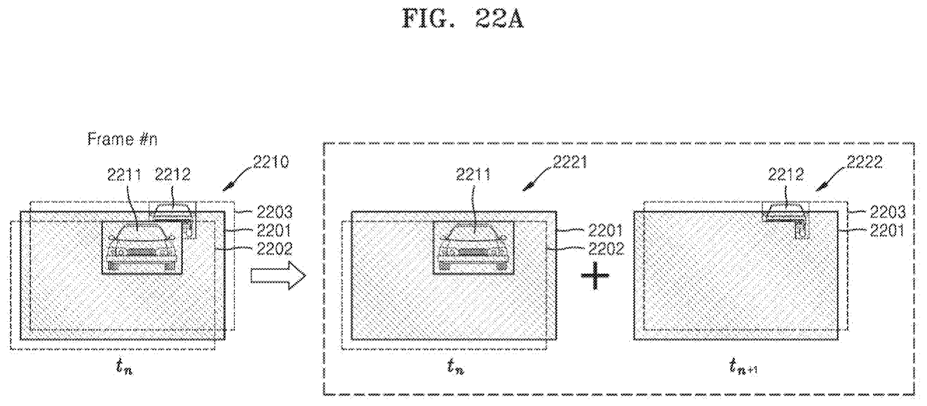

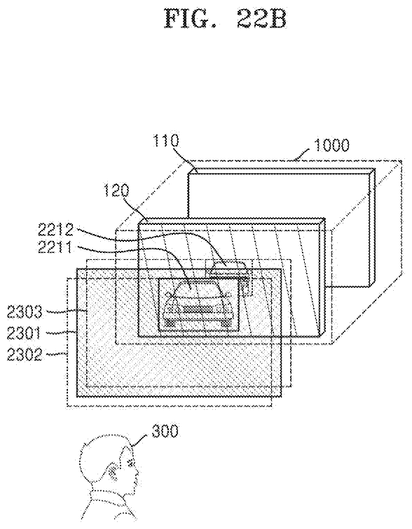

FIG. 21 is a flowchart for describing an operation in which the electronic device 1000 displays corrected images based on temporal multiplexing, according to an embodiment of the disclosure. FIG. 22A is a flowchart for describing an operation in which the electronic device 1000 displays corrected images based on temporal multiplexing, according to an embodiment of the disclosure. FIG. 22B is a flowchart for describing an operation in which the electronic device 1000 displays corrected images based on temporal multiplexing, according to an embodiment of the disclosure.

Referring to FIG. 21, the method, performed by the electronic device 1000, of providing a 3D image may further include operation S2110 to operation S2130. In an embodiment of the disclosure, operation S2110 to operation S2130 may be performed by the at least one processor included in the electronic device 1000.

Each of operation S2110 to operation S2130 shown in FIG. 21 may be performed while operation S310 to operation S350 shown in FIG. 3 are performed, or may be performed before or after operation S310 to operation S350 are performed.

In operation S2110 of FIG. 21, the electronic device 1000 according to an embodiment of the disclosure may identify a first adjacent depth area and a second adjacent depth area which are adjacent to each other and have a depth section difference equal to or greater than a preset depth section difference among a plurality of depth areas.

In an embodiment of the disclosure, the first electrode layer and/or the second electrode layer included in the lens array 120 may be configured as the plurality of segmented electrodes. Voltage may be applied to at least a portion of the first adjacent depth area and the second adjacent depth area by a segmented electrode.

In operation S2120 of FIG. 21, the electronic device 1000, according to an embodiment of the disclosure may display a first corrected image obtained by performing correction by excluding, from an input image, an image corresponding to the first adjacent depth area. For example, the electronic device 1000 may perform correction by excluding, from the input image, an object included in the first adjacent depth area, and thus, may obtain the first corrected image in which the object included in the first adjacent depth area is excluded and an object included in the second adjacent depth area is included.

In operation S2130 of FIG. 21, the electronic device 1000, according to an embodiment of the disclosure, may display a second corrected image obtained by performing correction by excluding, from the input image, an image corresponding to the second adjacent depth area. For example, the electronic device 1000 may perform correction by excluding, from the input image, an object included in the second adjacent depth area, and thus, may obtain the second corrected image in which the object included in the second adjacent depth area is excluded and an object included in the first adjacent depth area is included.

According to an embodiment of the disclosure, the electronic device 1000 may display the input image as the first corrected image and the second corrected image separately, and thus, may separately display the object included in the first adjacent depth area and the object included in the second adjacent depth area. Accordingly, even when a depth difference between the object included in the first adjacent depth area and the object included in the second adjacent depth area is great, it is possible to provide a 3D image in which both objects are clearly represented.

Referring to FIGS. 22A and 22B, in an embodiment of the disclosure, an input image may include a plurality of frames. FIG. 22A illustrates an example of nth frame 2210 among the plurality of frames (where n is a natural number). For example, the nth frame 2210 may include a first object 2211 located closer to a user than a reference point 2201 and a second object 2212 located farther from the user than the reference point 2201. FIG. 22A illustrates the example in which both the first object 2211 and the second object 2212 are vehicles.

As the first object 2211 is located closer to the user than the reference point 2201, the first object 2211 may be included in a second depth area 2202 of a depth map. As the second object 2212 is located farther from the user than the reference point 2201, the second object 2212 may be included in a third depth area 2203 of the depth map. In the nth frame 2210, the first object 2211 and the second object 2212 may be located adjacent to each other. The electronic device 1000 may determine, in the depth map, the second depth area 2202 in which the first object 2211 is displayed as the first adjacent depth area, and may determine, in the depth map, the third depth area 2203 in which the second object 2212 is displayed as the second adjacent depth area. Hereinafter, the first adjacent depth area will be described by using the same reference numeral as the second depth area 2202, and the second adjacent depth area will be described by using the same reference numeral as the third depth area 2203.

The electronic device 1000 may perform correction by excluding, from the nth frame 2210, the second adjacent depth area 2203 that is the second object 2212, and thus, may obtain (or generate) a first corrected image 2221 in which the second object 2212 is excluded and the first object 2211 is included. The electronic device 1000 may perform correction by excluding, from the nth frame 2210, the first adjacent depth area 2202 that is the first object 2211, and thus, may obtain (or generate) a second corrected image 2222 in which the first object 2211 is excluded and the second object 2212 is included.

In an embodiment of the disclosure, the electronic device 1000 may display the first corrected image 2221 corrected from the nth frame 2210 at a first time tₙ at which the nth frame 2210 is displayed. In this regard, the electronic device 1000 may apply a voltage value for forming a focal plane at a depth closer than the display 110 to lenses that correspond to the first adjacent depth area 2202 among the plurality of lenses. As the focal plane located closer than the display 110 is formed in an image that displays the first object 2211, the electronic device 1000 may provide the first object 2211 that is clearly represented via the first corrected image 2221.

In an embodiment of the disclosure, the electronic device 1000 may display the second corrected image 2222 corrected from the nth frame 2210 at a second time tₙ₊₁ at which an n+1th frame is displayed. In this regard, the electronic device 1000 may apply a voltage value for forming a focal plane at a depth farther than the display 110 to lenses that correspond to the second adjacent depth area 2203 among the plurality of lenses. As the focal plane located farther than the display 110 is formed in an image that displays the second object 2212, the electronic device 1000 may provide the second object 2212 that is clearly represented via the second corrected image 2222. The electronic device 1000 may omit a display of an image corresponding to the n+1th frame in the obtained input image.

As shown in FIG. 22B, in an embodiment of the disclosure, a user 300 may perceive the first corrected image 2221 provided at the first time tₙ and the second corrected image 2222 provided at the second time tₙ₊₁ as an image including the first object 2211 located at the depth closer than the display 110 (or, a first focal plane 2301) and the second object 2212 located at the depth farther than the display 110 (or, the first focal plane 2301). The user 300 may perceive the image in which the first object 2211 is displayed over a second focal plane 2302 located closer than the display 110 and the second object 2212 is displayed over a third focal plane 2303 located farther than the display 110.

According to an embodiment of the disclosure, even when a depth difference between adjacent objects in an input image is great, the electronic device 1000 may separately display the two objects via consecutive images. Accordingly, the electronic device 1000 may form focal planes respectively corresponding to depths of the two objects in the consecutive images, and thus, may provide a final image in which a 3D effect between the two objects is improved and a sharpness is also improved. On the other hand, unlike to an embodiment of the disclosure, if the electronic device 1000 concurrently displays adjacent objects, and applies, to corresponding segmented electrodes, a median value of voltage values for forming focal planes appropriate for adjacent objects, the electronic device 1000 may form the same focal plane at adjacent objects having a great depth difference, thereby providing an image with a degraded sharpness.

In an embodiment of the disclosure, not only the nth frame 2210 but also the n+1th frame may include both the first object 2211 and the second object 2212. The electronic device 1000 may obtain (or generate), from the nth frame 2210, the first corrected image 2221 in which the second object 2212 is excluded and the first object 2211 is included, and may obtain (or generate), from the n+1th frame, the second corrected image 2222 in which the first object 2211 is excluded and the second object 2212 is included. The electronic device 1000 may display the first corrected image 2221 corrected from the nth frame 2210 at the first time tₙ at which the nth frame 2210 is displayed, and may display the second corrected image 2222 corrected from the n+1th frame at the second time tₙ₊₁ at which the n+1th frame is displayed.

In an embodiment of the disclosure, the first object 2211 and the second object 2212 are all displayed in frames after the n+1th frame, and when a depth difference between the first object 2211 and the second object 2212 is great, the first corrected image 2221 in which the second object 2212 is excluded and the second corrected image 2222 in which the first object 2211 is excluded may be alternately displayed.

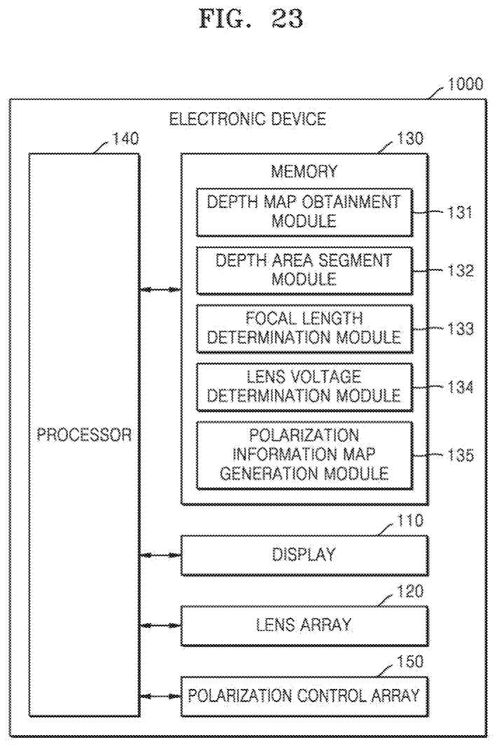

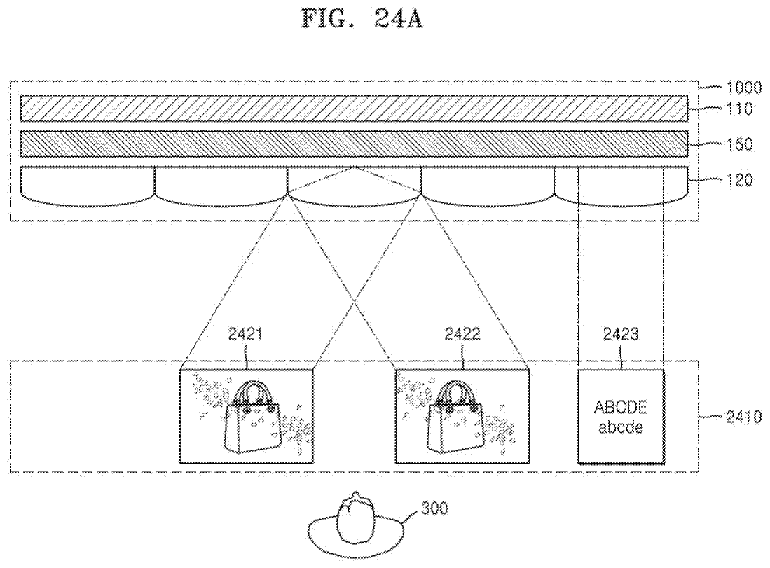

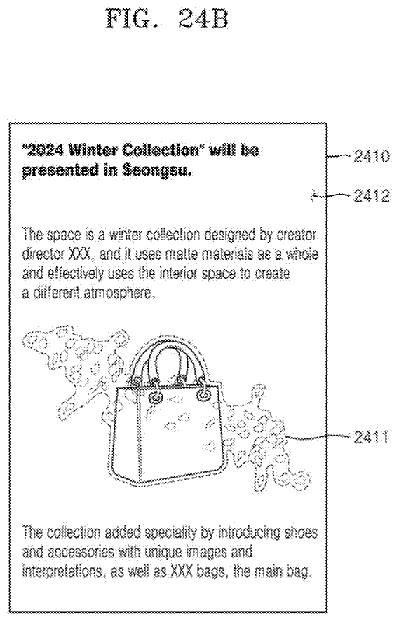

FIG. 23 is a block diagram for describing a configuration of the electronic device 1000, according to an embodiment of the disclosure. FIG. 24A is a diagram for describing an operation in which the electronic device 1000 provides an image, according to an embodiment of the disclosure. FIG. 24B illustrates an example of an image displayed via the electronic device 1000, according to an embodiment of the disclosure.

Referring to FIG. 23, in an embodiment of the disclosure, the electronic device 1000 may include the display 110, the lens array 120, the polarization control array 150, the memory 130, and the processor 140. The electronic device 1000 may be embodied with more elements than the elements shown in FIG. 23 or may be embodied with fewer elements than the shown elements. The display 110, the lens array 120, the polarization control array 150, the memory 130, and the processor 140 may be electrically and/or physically connected to each other. As the display 110, the lens array 120, the memory 130, and the processor 140 are described above with reference to FIG. 2, redundant descriptions thereof are not provided here.

The electronic device 1000 may control a polarization angle of polarized light incident on the polarization control array 150. According to an embodiment of the disclosure, the electronic device 1000 may control the polarization angle by varying a polarization angle differently for each area of the polarization control array 150 on which the polarized light is incident.

In an embodiment of the disclosure, the electronic device 1000 may generate a polarization information map, based on a received input image. The electronic device 1000 may control the polarization control array 150, based on the polarization information map. The electronic device 1000 may control the polarization control array 150 such that voltage may be applied or may not be applied for each cell of the polarization control array 150, in response to the polarization information map.

For example, the electronic device 1000 may not change a polarization angle incident on a first control area (for example, an area in which a 2D is to be displayed) of the polarization control array 150, and may change, by a preset polarization angle, a polarization angle incident on a second control area (for example, an area in which a 3D is to be displayed) of the polarization control array 150. The electronic device 1000 may control the polarization control array 150 so as to allow different liquid-crystal alignments in the first control area and the second control area of the polarization control array 150. In the disclosure, the first control area may be referred to as a 2D control area, and the second control area may be referred to as a 3D control area.

In an embodiment of the disclosure, the polarization control array 150 may indicate a liquid crystal spatial light modulator (LCSLM). Alternatively, the polarization control array 150 may be generated by removing a color filter and a black matrix from a liquid-crystal display, but the disclosure is not limited thereto.

In an embodiment of the disclosure, the polarization control array 150 may include a liquid-crystal layer that is driven in a vertical alignment (VA) manner. Alternatively, in an embodiment of the disclosure, the polarization control array 150 may include a liquid-crystal layer that is driven in a Twisted Nematic (TN) manner. However, an embodiment of the disclosure is not limited thereto.

In an embodiment of the disclosure, the memory 130 may store various types of modules that may be used to provide an output image to a user via the display 110. For example, the memory 130 may store the depth map obtainment module 131, the depth area segment module 132, the focal length determination module 133, the lens voltage determination module 134, and a polarization information map generation module 135. However, not all modules shown in FIG. 23 are necessary modules. The memory 130 may further store more modules than the modules shown in FIG. 23. As the depth map obtainment module 131, the depth area segment module 132, the focal length determination module 133, and the lens voltage determination module 134 are described above with reference to FIG. 2, redundant descriptions thereof are not provided here.

In an embodiment of the disclosure, the polarization information map generation module 135 may store instructions for generating a polarization information map including polarization information requested for each area (e.g., each cell) so as to control the polarization control array 150 for each area (e.g., each cell). The polarization information map generation module 135 may receive an input image. The polarization information map generation module 135 may generate a polarization information map, based on the received input image.

The polarization information map, according to an embodiment of the disclosure, may include a 2D area and a 3D area, the 2D area corresponding to an area of the input image which is to be perceived as a 2D image to a user and the 3D area corresponding to an area of the input image which is to be perceived as a 3D image.

In an embodiment of the disclosure, based on the polarization information map, the electronic device 1000 may not apply a voltage to the 3D control area (or the second control area) corresponding to the 3D area of the polarization control array 150 and may apply a voltage to the 2D control area (or the first control area) corresponding to the 2D area of the polarization control array 150.

In an embodiment of the disclosure, based on the polarization information map, the electronic device 1000 may not apply a voltage to the 2D control area (or the first control area) corresponding to the 2D area of the polarization control array 150 and may apply a voltage to the 3D control area (or the second control area) corresponding to the 3D area of the polarization control array 150. Whether to apply a voltage to the 2D control area or the 3D control area may vary, according to a liquid-crystal alignment manner of the polarization control array 150.

According to an embodiment of the disclosure, the electronic device 1000 may control a refraction degree of light at the lens array 120 by controlling a polarization direction of the light at the polarization control array 150. Polarization direction of light may be controlled in such a manner that the light is not refracted in the lens array 120 in the 2D control area of the polarization control array 150. Polarization direction of light may be controlled in such a manner that the light is refracted in the lens array 120 in the 3D control area of the polarization control array 150.

According to an embodiment of the disclosure, the electronic device 1000 may not apply a voltage to the 2D control area and may apply a voltage to the 3D control area. Alternatively, according to an embodiment of the disclosure, the electronic device 1000 may apply a voltage to the 2D control area and may not apply a voltage to the 3D control area. The application may vary according to an alignment manner (e.g., a TN mode, a VA mode, etc.) of liquid crystals that configure the polarization control array, types of liquid crystal molecules, etc.

In this regard, according to an embodiment of the disclosure, the electronic device 1000 may provide a 2D image by controlling the lens array in such a manner that light that has passed through the 2D control area of the polarization control array 150 is not refracted in the lens array 120 and maintains a straight path. The electronic device 1000 may provide a 3D image having multiple depths represented over a plurality of focal planes at different depths, by providing the lens array 120 in such a manner that a refraction degree of light that has passed through the 3D control area of the polarization control array 150 is differently set in the lens array 120 according to each area. That is, the electronic device 1000 may control depths (or positions) of focal planes with respect to a plurality of lenses, respectively, by controlling respective focal lengths of the plurality of lenses included in the lens array 120. Here, the electronic device 1000 may control the respective focal lengths and the depths (or positions) of the focal planes with respect to the plurality of lenses, by adjusting a voltage value to be applied to the lens array 120 for each of the plurality of lenses.

According to an embodiment of the disclosure, the electronic device 1000 may not apply a voltage to lenses corresponding to the 2D control area of the polarization control array 150. In this regard, the electronic device 1000 may apply relatively high voltage to lenses that require a small focal length to be formed among lenses corresponding to the 3D control area of the polarization control array 150 compared to lenses that require a long focal length to be formed, and may apply relatively low voltage to lenses that require a great focal length to be formed compared to lenses that require a short focal length to be formed. Alternatively, according to an embodiment of the disclosure, the electronic device 1000 may apply a voltage for an array of maximum alignment angle to lenses among lenses corresponding to the 2D control area of the polarization control array 150. In this regard, the electronic device 1000 may apply relatively high voltage to lenses that require a great focal length to be formed among lenses corresponding to the 3D control area of the polarization control array 150, and may apply relatively low voltage to lenses that require a small focal length to be formed. In one or more examples, a relatively low voltage is less than or equal to a voltage threshold, and a relatively high voltage is greater than the voltage threshold.

According to an embodiment of the disclosure, according to a polarization direction of light being maintained or changed (e.g., 90-degree rotation) in the polarization control array 150, the light may not be refracted in the lens array 120 and may provide a 2D image, or may be refracted in the lens array 120 and may provide a 3D image. That is, it may be determined that light that passes through the polarization control array 150 is to provide any one of a 2D image and a 3D image, according to whether voltage is applied in the polarization control array 150.

Accordingly, in an embodiment of the disclosure, the electronic device 1000 may determine whether to perform 2D or 3D representation in an image by controlling whether to change a polarization direction of light in the polarization control array 150 according to an area thereof, and may control respective focal lengths of lenses in the lens array 120, such that a focal plane onto which an image is projected is provided as a plurality of focal planes having different depths, and thus, the image represented over the plurality of focal planes may be provided. That is, the electronic device 1000 may control whether to change liquid-crystal alignment in the polarization control array 150 according to an area of the polarization control array 150 so as to determine whether to perform 2D or 3D representation in an image. Also, the electronic device 1000 may control respective focal lengths of a plurality of lenses in the lens array 120 so as to determine respective depths of focal planes onto which an image is projected.

A process in which a refractive index of a lens is changed by changing only liquid-crystal alignment of a liquid-crystal lens in the lens array 120 without changing a polarization direction of light in the polarization control array 150 may require relatively high power consumption. That is, a method of switching a 2D image and a 3D image by controlling liquid-crystal alignment of a liquid-crystal lens may require relatively high power consumption. On the other hand, according to an embodiment of the disclosure, as a process in which a polarization direction of light is maintained or changed by maintaining or changing liquid-crystal alignment in the polarization control array 150 requires relatively low power consumption, a method of switching a 2D image and a 3D image via the polarization control array 150 may require relatively low power consumption. For example, the process of changing a refractive index of a lens by changing only liquid-crystal alignment of a liquid-crystal lens in the lens array 120 without changing a polarization direction of light in the polarization control array 150 requires power consumption of about 5 W, the process of maintaining or changing a polarization direction of light by maintaining or changing liquid-crystal alignment in the polarization control array 150 may require power consumption of only about 0.5 W.

Also, according to an embodiment of the disclosure, the electronic device 1000 may represent a 2D image or a 3D image via voltage control in the polarization control array 150, and may allow the 3D image to be represented over focal planes having different depths via voltage control in the lens array 120, thereby providing a final image with improved resolution and sharpness.

Referring to FIGS. 24A and 24B, the electronic device 1000 In an embodiment of the disclosure may display an output image 2410 via the display 110. In an embodiment of the disclosure, the output image 2410 provided by the electronic device 1000 may be an image that provides a 3D effect to the user 300.

In an embodiment of the disclosure, the output image 2410 provided by the electronic device 1000 may be an image whose portion is capable of providing the 3D effect to the user 300. As shown in FIG. 24B, the output image 2410 provided by the electronic device 1000 may be a combination of an area 2411 that is three-dimensionally displayed and an area 2412 that is two-dimensionally displayed.

In an embodiment of the disclosure, the electronic device 1000 may allow the user 300 to feel binocular disparity by respectively providing different output images 2421 and 2422 to a left eye and a right eye of the user 300. The user 300 may feel the binocular disparity as the output images 2421 and 2422 provided to the left eye and the right eye are different from each other, and thus, may feel a 3D effect of an object.

In an embodiment of the disclosure, the electronic device 1000 may provide the same output image 2423 to each of the left eye and the right eye, and thus, the user 300 may perceive a 2D shape. That is, the electronic device 1000 may provide a 2D image having a depth value corresponding to a reference value.

For example, the electronic device 1000 may provide an area of the output image 2410 which requires a 3D effect as a 3D image, and may provide an area that does not require a 3D effect or an area such as text that requires high resolution as a 2D image. In this case, the electronic device 1000 is capable of providing small-sized text with relatively high resolution, and thus, may provide an area with high resolution, the area requiring recognition of information.

However, an embodiment of the disclosure is not limited thereto, and the output image 2410 provided by the electronic device 1000 may be a 3D image for an entire area, or the output image 2410 provided by the electronic device 1000 may be a 2D image for an entire area.

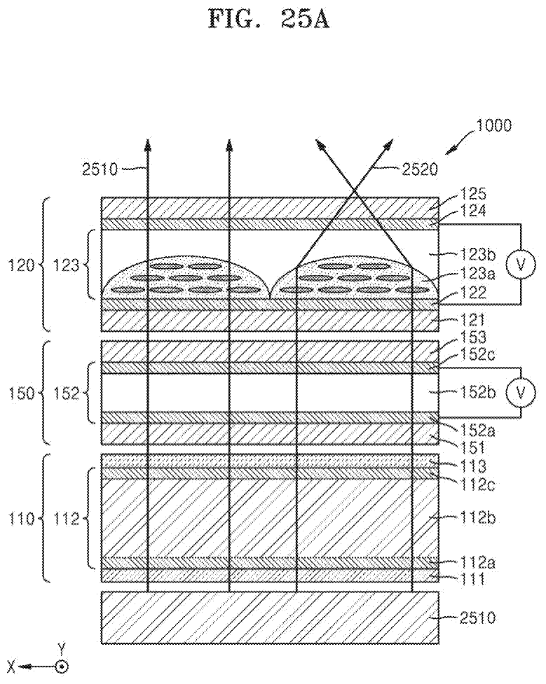

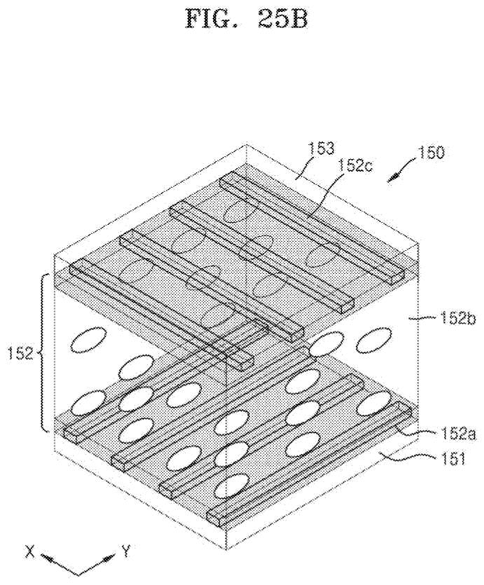

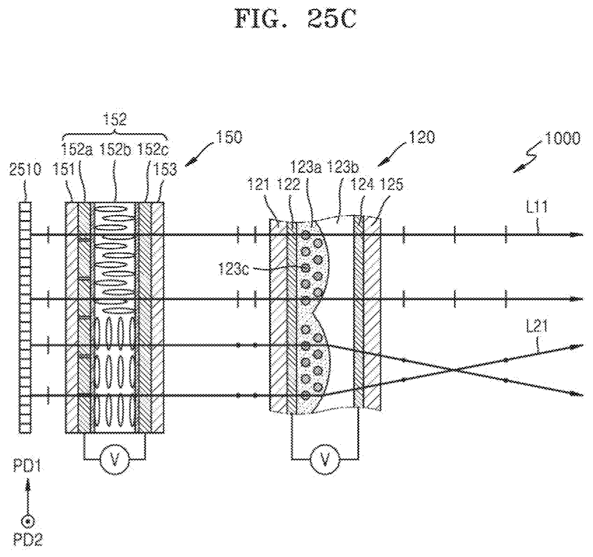

FIG. 25A is a diagram for describing a configuration of the electronic device 1000 according to an embodiment of the disclosure. FIG. 25B is a diagram for describing a configuration of the polarization control array 150 of the electronic device 1000, according to an embodiment of the disclosure. FIG. 25C is a diagram for describing voltage control of the polarization control array 150 and the lens array 120 of the electronic device 1000, according to an embodiment of the disclosure.

Referring to FIG. 25A, the electronic device (1000), according to an embodiment of the disclosure, may include a backlight unit 2510, the display 110, the polarization control array 150, and the lens array 120.

The backlight unit 2510 may be arranged below the display 110. The backlight unit 2510 may provide light to the display 110. Light emitted from the backlight unit 2510 may have a constant optical wavelength range. For example, light emitted from the backlight unit 2510 may be ultra-violet (UV) light or blue light. When light is emitted from the backlight unit 2510, the electronic device (1000) may further include a light guide plate for guiding light to one surface (e.g., side surface) of the backlight unit 2510.

The display 110 may form an image by modulating light emitted from the backlight unit 2510. In an embodiment of the disclosure, the display 110 may be the liquid-crystal display (LCD) 110. The display 110, according to an embodiment of the disclosure, may include a first polarization plate 111, a first liquid-crystal cell 112, and a second polarization plate 113. The first liquid-crystal cell 112 may be arranged between the first polarization plate 111 and the second polarization plate 113. In the disclosure, the first polarization plate 111 may be referred to as a lower polarization plate, and the second polarization plate 113 may be referred to as an upper polarization plate. In the disclosure, the first liquid-crystal cell 112 may be referred to as a main cell or a lower cell.

The first polarization plate 111 may transmit light of first polarization and may absorb light of other polarizations, and the second polarization plate 113 may transmit light of second polarization and may absorb light of other polarizations. An optical axis of the first polarization plate 111 may be perpendicular to an optical axis of the second polarization plate 113. For example, the optical axis of the first polarization plate 111 may correspond to a vertical direction of a liquid-crystal panel, i.e., Y direction on the drawing, and the optical axis of the second polarization plate 113 may correspond to a horizontal direction of a liquid-crystal panel, i.e., X direction on the drawing.

In an embodiment of the disclosure, the first liquid-crystal cell 112 may include a first electrode layer 112a (or first upper electrode), a first liquid-crystal layer 112b, and a second electrode layer 112c (or first lower electrode). The first liquid-crystal layer 112b may be arranged between the first electrode layer 112a and the second electrode layer 112c. An electric field may be formed in the first liquid-crystal layer 112b due to a difference in voltage applied to the first electrode layer 112a and the second electrode layer 112c, and thus, liquid-crystal alignment of the first liquid-crystal layer 112b may be changed.

In an embodiment of the disclosure, the first electrode layer 112a may include a plurality of driving electrodes separate from each other. The driving electrodes may receive driving voltage. The first electrode layer 112a may include a transparent conductive material. The second electrode layer 112c may be an electrode formed on an entire surface of the display 110. The second electrode layer 112c may receive common voltage. The second electrode layer 112c may include a transparent conductive material.

The first liquid-crystal layer 112b may include a plurality of liquid-crystal molecules. The plurality of liquid-crystal molecules included in the first liquid-crystal layer 112b may be distributed with the same density over an entire area of the first liquid-crystal layer 112b.

The first liquid-crystal layer 112b may be controlled in such a manner that alignment of the liquid-crystal molecules configuring the first liquid-crystal layer 112b may be changed, according to voltage applied to the first liquid-crystal cell 112. The first liquid-crystal layer 112b may control light incident on the first liquid-crystal layer 112b, according to an alignment state of the liquid-crystal molecules. For example, the first liquid-crystal layer 112b may change or may not change a polarization direction of light incident on the first liquid-crystal layer 112b, according to an alignment state of the liquid-crystal molecules.

In an embodiment of the disclosure, the first liquid-crystal layer 112b may be arrayed in a normally white mode. The first liquid-crystal layer 112b may transmit light that is incident while voltage is not applied, and may not transmit light that is incident while voltage is applied. For example, the first liquid-crystal layer 112b may be arrayed in a TN mode. When voltage is not applied to the first liquid-crystal cell 112, the liquid-crystal molecules of the first liquid-crystal layer 112b may be arranged in parallel to the first polarization plate 111 and the second polarization plate 113 so as to be gradually twisted (or warped) in a direction from the first polarization plate 111 to the second polarization plate 113. When voltage is applied to the first liquid-crystal cell 112, an alignment direction of the liquid-crystal molecules of the first liquid-crystal layer 112b may be changed in such a manner that the liquid-crystal molecules of the first liquid-crystal layer 112b are arrayed in a direction perpendicular to the first polarization plate 111 and the second polarization plate 113.

In an embodiment of the disclosure, the first liquid-crystal layer 112b may be arrayed in a normally black mode. The first liquid-crystal layer 112b may not transmit light that is incident while voltage is not applied, and may transmit light that is incident while voltage is applied. For example, the first liquid-crystal layer 112b may be arrayed in a VN mode. When voltage is not applied to the first liquid-crystal cell 112, the liquid-crystal molecules of the first liquid-crystal layer 112b may be arranged in a direction perpendicular to the first polarization plate 111 and the second polarization plate 113. When voltage is applied to the first liquid-crystal cell 112, an alignment direction of the liquid-crystal molecules of the first liquid-crystal layer 112b may be changed in such a manner that the liquid-crystal molecules of the first liquid-crystal layer 112b are arrayed in parallel to the first polarization plate 111 and the second polarization plate 113.

Although not shown, the display 110 may further include a color filter provided on the second polarization plate 113. Although not shown, the display 110 may further include a thin-film transistor (TFT) for driving each pixel.

In an embodiment of the disclosure, the polarization control array 150 may include a first base substrate 151 (or a first lower base substrate), a second liquid-crystal cell 152, and a second base substrate 153 (or a first upper base substrate).

According to an embodiment of the disclosure, each of the first base substrate 151 and the second base substrate 153 may be a transparent insulating substrate or a transparent insulating film. For example, each of the first base substrate 151 and the second base substrate 153 may include a glass material, a quartz material, or a light-transmitting plastic material.

The second liquid-crystal cell 152 may be arranged between the first base substrate 151 and the second base substrate 153. In the disclosure, the second liquid-crystal cell 152 may be referred to as a first upper liquid-crystal cell or a polarization switching cell.

In an embodiment of the disclosure, the second liquid-crystal cell 152 may further include a first electrode layer 152a (or a second lower electrode layer), a second liquid-crystal layer 152b, and a second electrode layer 152c (or a second upper electrode layer). The second liquid-crystal layer 152b may be arranged between the first electrode layer 152a and the second electrode layer 152c. As an electric field is formed in the second liquid-crystal layer 152b due to a difference between voltage applied to the first electrode layer 152a and voltage applied to the second electrode layer 152c, a liquid-crystal alignment of the second liquid-crystal layer 152b may be changed.

Referring to FIG. 25B, in an embodiment of the disclosure, the first electrode layer 152a may include a plurality of lower electrodes arrayed in an X direction. Each of the plurality of lower electrodes may extend in a Y direction perpendicular to the X direction. The second electrode layer 152c may include a plurality of upper electrodes arrayed in a Y direction. Each of the plurality of upper electrodes may extend in an X direction.

The second liquid-crystal layer 152b may include a plurality of liquid crystal molecules. The plurality of liquid crystal molecules included in the second liquid-crystal layer 152b may be distributed over an entire area of the second liquid-crystal layer 152b.

The second liquid-crystal layer 152b may be controlled in such a manner that alignment of the liquid-crystal molecules configuring the second liquid-crystal layer 152b may be changed, according to applied voltage. The second liquid-crystal layer 152b may control light incident on the second liquid-crystal layer 152b, according to an alignment state of the liquid-crystal molecules. For example, the second liquid-crystal layer 152b may change or may not change a polarization direction of light incident on the second liquid-crystal layer 152b, according to an alignment state of the liquid-crystal molecules.

In an embodiment of the disclosure, the second liquid-crystal layer 152b may transmit light that is incident while voltage is not applied, and may not transmit light that is incident while voltage is applied. For example, the second liquid-crystal layer 152b may be arrayed in a TN mode. When voltage is not applied to the second liquid-crystal cell 152, the liquid-crystal molecules of the second liquid-crystal layer 152b may be arranged in parallel to the first base substrate 151 and the second base substrate 153 so as to be gradually twisted (or warped) in a direction from the first base substrate 151 to the second base substrate 153. When voltage is applied to the second liquid-crystal cell 152, an alignment direction of the liquid-crystal molecules of the second liquid-crystal layer 152b may be changed in such a manner that the liquid-crystal molecules of the second liquid-crystal layer 152b are arrayed in a direction perpendicular to the first base substrate 151 and the second base substrate 153.

In an embodiment of the disclosure, the second liquid-crystal layer 152b may not transmit light that is incident while voltage is not applied, and may transmit light that is incident while voltage is applied. For example, the second liquid-crystal layer 152b may be arrayed in a VN mode. When voltage is not applied to the second liquid-crystal cell 152, the liquid-crystal molecules of the second liquid-crystal layer 152b may be arranged in a direction perpendicular to the first base substrate 151 and the second base substrate 153. When voltage is applied to the second liquid-crystal cell 152, an alignment direction of the liquid-crystal molecules of the second liquid-crystal layer 152b may be changed in such a manner that the liquid-crystal molecules of the second liquid-crystal layer 152b are arrayed in parallel to the first base substrate 151 and the second base substrate 153.

In an embodiment of the disclosure, the polarization control array 150 may further include a first high resistance film arranged between the first electrode layer 152a and the second liquid-crystal layer 152b and a second high resistance film arranged between the second electrode layer 152c and the second liquid-crystal layer 152b. The first high resistance film may be arranged on the first base substrate 151 so as to cover the first electrode layer 152a. The second high resistance film may be arranged below the second base substrate 153 so as to cover the second electrode layer 152c. A voltage difference between cells may be finely adjusted via the first high resistance film and the second high resistance film.

Referring back to FIG. 25A, in an embodiment of the disclosure, the lens array 120 may include the first base substrate 121 (or a third lower base substrate), the first electrode layer 122 (or a third lower electrode layer), the liquid-crystal lens 123, the second electrode layer 124 (or a third upper electrode layer), and the second base substrate 125 (or a third upper base substrate). The liquid-crystal lens 123 may be arranged between the first electrode layer 122 and the second electrode layer 124.

In an embodiment of the disclosure, the liquid-crystal lens 123 may include the lenses 123a and the resin layer 123b. The resin layer 123b may cover the lenses 123a.

In an embodiment of the disclosure, the lenses 123a may include a material having a birefringence characteristic. For example, each of the lenses 123a may include a plurality of liquid-crystal molecules. The plurality of liquid-crystal molecules included in each of the lenses 123a may be distributed over an entire area of the lenses 123a with a uniform density. The lenses 123a may have anisotropy. The liquid-crystal molecules included in the lenses 123a may be arrayed in a particular direction. In the lenses 123a, a refractive index of the liquid-crystal molecules on a long-axis direction may be different from a refractive index in a direction other than the long-axis direction. A refractive index of the lenses 123a may vary according to a polarization direction of incident light.

The refractive index of the lenses 123a may be equal to a refractive index of the resin layer 123b according to a polarization direction of incident light, and in this case, light that has passed through the lenses 123a may not be refracted. Light 2510 that is not refracted may provide a 2D image to a user. The refractive index of the lenses 123a may be different from the refractive index of the resin layer 123b according to a polarization direction of incident light, and in this case, light that has passed through the lenses 123a may be refracted. Light 2520 that is refracted may provide a 3D image to the user.

Accordingly, in an embodiment of the disclosure, the electronic device 1000 may control whether a polarization direction of light is to be changed or not in the polarization control array 150, thereby determining whether to perform 2D or 3D representation in an image.

Also referring to FIG. 25C, light that passes through the display 110 and then is incident on the polarization control array 150 may pass through the upper polarization plate 113 of the display 110, and thus, may have a first polarization direction PD1 corresponding to a polarization direction of the upper polarization plate 113.

In an embodiment of the disclosure, according to a liquid-crystal alignment of the polarization control array 150, a 2D image may be provided when voltage is applied to the polarization control array 150, and a 3D image may be provided when voltage is not applied to the polarization control array 150. On the other hand, in an embodiment of the disclosure, according to a liquid-crystal alignment of the polarization control array 150, a 3D image may be provided when voltage is applied to the polarization control array 150, and a 2D image may be provided when voltage is not applied to the polarization control array 150. Hereinafter, each embodiment of the disclosure will be described in detail.

First, in an embodiment of the disclosure, when voltage is not applied to the second liquid-crystal cell 152 of the polarization control array 150, a polarization direction of light incident on the polarization control array 150 may be maintained. For example, a polarization direction of light L11 that has passed through the polarization control array 150 may be maintained in the first polarization direction PD1.

In an embodiment of the disclosure, when voltage is applied to the polarization control array 150, a polarization direction of light incident on the polarization control array 150 may be changed. For example, a polarization direction of light L21 that has passed through the polarization control array 150 may be changed to a second polarization direction PD2 perpendicular to the first polarization direction PD1 on a plane in parallel to the first and second base substrates 151 and 153.

Here, the polarization control array 150, according to an embodiment of the disclosure, may have a liquid-crystal alignment of a VA mode.

In an embodiment of the disclosure, when voltage is not applied to the second liquid-crystal cell 152 of the polarization control array 150, a polarization direction of light incident on the polarization control array 150 may be changed. For example, the polarization direction of light L21 that has passed through the polarization control array 150 may be changed to the second polarization direction PD2 perpendicular to the first polarization direction PD1 on a plane in parallel to the first and second base substrates 151 and 153.

In an embodiment of the disclosure, when voltage is applied to the polarization control array 150, a polarization direction of light incident on the polarization control array 150 may be maintained. For example, the polarization direction of light L11 that has passed through the polarization control array 150 may be maintained in the first polarization direction PD1.

Here, the polarization control array 150, according to an embodiment of the disclosure, may have a liquid-crystal alignment of a TN mode.

The lens 123a may have a birefringence characteristic. The lens 123a may include an optically anisotropic material. A refractive index of the lens 123a may vary according to a polarization direction of light that has entered the lens 123a. For example, a refractive index (an axial refractive index n_e) of the lens 123a in a long-axis direction of liquid crystal molecules 123c may be different from a refractive index (an orthotropic refractive index n_o) of the lens 123a in a direction of the liquid crystal molecules 123c, the direction (e.g., a direction perpendicular to the long-axis direction) other than the long-axis direction.

A refractive index of the lens 123a may vary according to a polarization direction of incident light. For example, the refractive index of the lens 123a may have an axial refractive index n_e or an orthotropic refractive index n_o according to a polarization direction of incident light.

First, according to an embodiment of the disclosure, when light L11 incident on the lens array 120 has the first polarization direction PD1, a polarization direction of the light L11 incident on the lens array 120 may be perpendicular to a long-axis direction of the liquid crystal molecules 123c. Accordingly, the light L11 that is polarized to be perpendicular to the long-axis direction of the liquid crystal molecules 123c is incident, and thus, the lens 123a may have the orthotropic refractive index n_o.

According to an embodiment of the disclosure, a refractive index of the resin layer 123b may be substantially the same as the orthotropic refractive index n_o of the lens 123a. Accordingly, when the light L11 incident on the lens array 120 has the first polarization direction PD1, the lens 123a has the orthotropic refractive index n_o, so that the lens 123a has the same refractive index as the resin layer 123b, and thus, the light L11 having passed through the lens 123a may not be refracted. That is, light having passed through the polarization control array 150 in which voltage is not applied to the second liquid-crystal cell 152 may not be refracted while passing through the liquid-crystal lens 123. The light L11 that is not refracted while passing through the liquid-crystal lens 123 may provide a 2D image to a user.

According to an embodiment of the disclosure, when light L21 incident on the lens array 120 has the second polarization direction PD2, a polarization direction of the light L21 incident on the lens array 120 may be in parallel to the long-axis direction of the liquid crystal molecules 123c. Accordingly, the light L11 that is polarized to be in parallel to the long-axis direction of the liquid crystal molecules 123c is incident, and thus, the lens 123a may have the axial refractive index n_e.

According to an embodiment of the disclosure, a refractive index of the resin layer 123b may be substantially the same as the orthotropic refractive index n_o of the lens 123a. Accordingly, when the light L21 incident on the lens array 120 has the second polarization direction PD2, the lens 123a has the axial refractive index n_e, so that the lens 123a has a refractive index different from the resin layer 123b, and thus, the light L21 having passed through the lens 123a may be refracted. That is, light having passed through the polarization control array 150 in which voltage is applied to the second liquid-crystal cell 152 may be refracted while passing through the liquid-crystal lens 123. The light L21 that is refracted while passing through the liquid-crystal lens 123 may provide a 3D image to the user. A refractive index of the lens 123a may vary according to voltage applied to the lens 123a, and thus, a refraction degree of the light L21 having the second polarization direction PD2 may vary while passing through the lens array 120. Therefore, the lens array 120 may control focal lengths of the lenses 123a by controlling voltage values to be respectively applied to the lenses 123a.

Unlike to what is shown in FIG. 25C, according to an embodiment of the disclosure, when light incident on the lens array 120 has the second polarization direction PD2, the lens 123a may have the orthotropic refractive index n_o. Accordingly, the lens 123a may have the same refractive index as the resin layer 123b, and thus, light having passed through the lens 123a may not be refracted. The light that is not refracted while passing through the liquid-crystal lens 123 may provide a 2D image to a user.

Alternatively, unlike to what is shown in FIG. 25C, according to an embodiment of the disclosure, when light incident on the lens array 120 has the first polarization direction PD1, the lens 123a may have the axial refractive index n_e. Accordingly, the lens 123a may have a refractive index different from the resin layer 123b, and thus, light having passed through the lens 123a may be refracted. The light that is refracted while passing through the liquid-crystal lens 123 may provide a 3D image to the user.

In an embodiment of the disclosure, a refractive index of the lens 123a may vary according to voltage applied to the lens 123a. When voltage is applied to the lens 123a, a liquid-crystal alignment of the lens 123a varies, and thus, an axial refractive index n_e and an orthotropic refractive index n_o may be changed. According to a voltage value applied to the lens 123a, an axial refractive index n_e and an orthotropic refractive index n_o of the lens 123a may vary.

According to an embodiment of the disclosure, the electronic device 1000 may control voltage values to be respectively applied to the plurality of lenses 123a, and thus, may control a refraction degree of light that passes through each of the plurality of lenses 123a. By doing so, the electronic device 1000 may control a focal length and a depth (or position) of a focal plane for each of the plurality of lenses 123a. Therefore, the electronic device 1000 may provide a 3D image having multiple depths represented over a plurality of focal planes at different depths.

In an embodiment of the disclosure, the electronic device 1000 may determine whether to perform 2D or 3D representation in an image by controlling whether to change a polarization direction of light in the polarization control array 150 according to an area thereof, and may control respective focal lengths of lenses in the lens array 120, such that a focal plane onto which an image is projected is provided as a plurality of focal planes having different depths, and thus, the image represented over the plurality of focal planes may be provided.

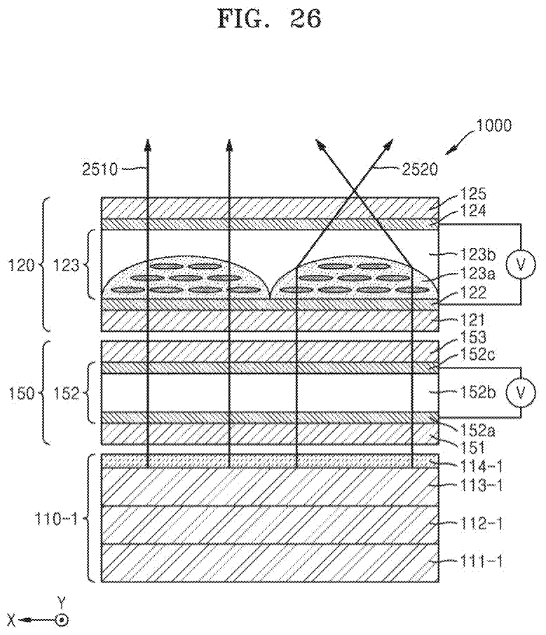

FIG. 26 is a diagram for describing a configuration of the electronic device 1000, according to an embodiment of the disclosure.

Referring to FIG. 26, the electronic device 1000 according to an embodiment of the disclosure may include a display 110-1, a polarization control array 150, and the lens array 120. As the polarization control array 150 and the lens array 120 are described with reference to FIG. 25A, redundant descriptions thereof are not provided here.

In an embodiment of the disclosure, the display 110-1 may be an organic light-emitting diode (OLED) display. The display 110-1 may include a base layer 111-1, a circuit device layer 112-1 arranged on the base layer 111-1, a display device layer 113-1 arranged on the circuit device layer 112-1, and an upper polarizer 114-1 arranged on the display device layer 113-1.

The base layer 111-1 may include a synthetic resin film. A synthetic resin layer may be formed on a work substrate used in the manufacture of the display 110-1. Afterward, a conductive layer, an insulating layer, or the like may be formed on the synthetic resin layer. When the work substrate is removed, the synthetic resin layer may correspond to the base layer 111-1. The synthetic resin layer may be a polyimide-based resin layer, and materials therefor are not particularly limited. In addition, the base layer 111-1 may include a glass substrate, a metal substrate, an organic/inorganic composite material substrate, etc.

The circuit device layer 112-1 may include at least one insulating layer and a circuit device. Hereinafter, the insulating layer included in the circuit device layer 112-1 is referred to as an intermediate insulating layer. The intermediate insulating layer may include at least one inorganic film and/or at least one organic film. The circuit device may include a signal line, a pixel driving circuit, etc. The circuit device layer 112-1 may be formed via processes of forming an insulating layer, a semiconductor layer, and a conductive layer via coding, deposition, etc., and processes of patterning the insulating layer, the semiconductor layer, and the conductive layer via a photo-lithography procedure.

The display device layer 113-1 may include a light-emitting device. The display device layer 113-1 may include organic light-emitting diodes as the light-emitting device. The display device layer 113-1 may further include an organic film such as a pixel-defining film.

In an embodiment of the disclosure, an upper insulating layer may be further included on the display device layer 113-1. The upper insulating layer may include a thin-film encapsulation layer for encapsulating a pixel device layer. The upper insulating layer may further include functional layers such as a capping layer, an anti-reflection layer, a refractive index adjustment layer, etc.

The upper polarizer 114-1 may transmit light of a particular polarization and may absorb light of other polarizations. Accordingly, light that is polarized in a particular direction may be incident on the polarization control array 150.

In order to solve the aforementioned technical issues, in an embodiment of the disclosure, an electronic device is provided.

In an embodiment of the disclosure, the plurality of instructions, when executed by the at least one processor 140 individually or collectively, may cause the electronic device 1000 to obtain a depth map about an input image (e.g., a depth map corresponding to an input image). The electronic device 1000 may segment the depth map into a plurality of depth areas. The electronic device 1000 may determine, based on a lens formula, focal lengths of a plurality of lenses corresponding to each of the plurality of depth areas. The electronic device 1000 may obtain voltage values to be applied to the plurality of lenses, respectively, based on the determined focal lengths of the plurality of lenses. The electronic device 1000 may provide an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

In an embodiment of the disclosure, the plurality of depth areas may include at least two of a first depth area corresponding to a reference point, a second depth area having a depth less than the reference point, or a third depth area having a depth greater than the reference point.

In an embodiment of the disclosure, the electronic device 1000 may determine a focal length of a first lens in a first lens area corresponding to the first depth area so as to allow a focal plane in the first lens area to be set at the display 110.

In an embodiment of the disclosure, the electronic device 1000 may determine a focal length of a second lens in a second lens area corresponding to the second depth area so as to allow a focal plane in the second lens area to be set closer to a viewer than the display 110.

In an embodiment of the disclosure, the electronic device 1000 may determine a focal length of a third lens in a third lens area corresponding to the third depth area so as to allow a focal plane in the third lens area to be set farther from the viewer than the display 110.

In an embodiment of the disclosure, the electronic device 1000 may display a corrected image obtained by correcting the input image by horizontally flipping an image corresponding to the second depth area in the input image.

In an embodiment of the disclosure, the electronic device 1000 may further include an eye tracking sensor. The electronic device 1000 may obtain a viewing position of a viewer via the eye tracking sensor. The electronic device 1000 may obtain, based on the viewing position, off-axis angles at the plurality of lenses with respect to light that reaches the plurality of lenses from the viewing position. The electronic device 1000 may correct the focal lengths of the plurality of lenses, based on the off-axis angles at the plurality of lenses.

In an embodiment of the disclosure, the electronic device 1000 may, based on the off-axis angles at the plurality of lenses, increase a focal length of each of the plurality of lenses when a corresponding off-axis angle increases.

In an embodiment of the disclosure, the electronic device 1000 may, based on movement of at least one object in consecutive frames included in the input image, change a range of the plurality of depth areas in one or more frames among the consecutive frames.

In an embodiment of the disclosure, the electronic device 1000 may change the range of the plurality of depth areas or change a depth area corresponding to a reference point, based on a user input of adjusting a strength of a 3D effect or a level of a depth of the 3D image.

In an embodiment of the disclosure, the lens array 120 may further include a first electrode layer and a second electrode layer facing each other with the plurality of lenses therebetween, Each of the first electrode layer and the second electrode layer may include a plurality of split electrodes. In an embodiment of the disclosure, the electronic device 1000 may apply, to at least one segmented electrode, a median value of a plurality of voltage values corresponding to at least two lenses, wherein the at least one segmented electrode overlaps the at least two lenses determined to have different focal lengths among the plurality of segmented electrodes.

In an embodiment of the disclosure, the electronic device 1000 may identify a first neighboring depth area and a second neighboring depth area that are adjacent to each other and have a depth section difference equal to or greater than a preset depth section difference among the plurality of depth areas. The electronic device 1000 may display a first corrected image obtained by performing correction by excluding, from the input image, an image corresponding to the first neighboring depth area. The electronic device 1000 may display a second corrected image obtained by performing correction by excluding, from the input image, an image corresponding to the second neighboring depth area.

In an embodiment of the disclosure, the electronic device 1000 may further include the polarization control array 150 arranged between the display 110 and the lens array (120) and configured to control a polarization direction of light provided from the display 110. The electronic device 1000 may control whether to change a liquid-crystal alignment in the polarization control array 150 according to an area of the polarization control array 150, so as to determine whether to perform 2D or 3D representation in the image. The electronic device 1000 may control focal lengths of the plurality of lenses in the lens array 120 with respect to each of the plurality of lenses so as to determine respective depths of the focal planes onto which the image is projected.

In an embodiment of the disclosure, the plurality of lenses may be arrayed in each of a first direction and a second direction perpendicular to the first direction.

In an embodiment of the disclosure, the electronic device 1000 may determine a focal length for each area of one or more lenses respectively corresponding to the plurality of depth areas, based on the lens formula. The electronic device 1000 may obtain voltage values to be applied respectively to areas of one or more lenses, based on focal lengths of the areas of the one or more lenses. The electronic device 1000 may apply a voltage to each of the plurality of lenses, based on the voltage values to be applied respectively to the areas of the one or more lenses.

In order to solve the aforementioned technical issues, in an embodiment of the disclosure, an operating method of the electronic device 1000 is provided.

In an embodiment of the disclosure, the operating method of the electronic device 1000 may include obtaining a depth map about an input image (e.g., a depth map corresponding to an input image) (S310).

In an embodiment of the disclosure, the operating method of the electronic device 1000 may include segmenting the depth map into a plurality of depth areas, based on a plurality of depth sections (S320).

In an embodiment of the disclosure, the operating method of the electronic device 1000 may include determining, based on a lens formula, focal lengths of a plurality of lenses corresponding to each of the plurality of depth areas (S330).

In an embodiment of the disclosure, the operating method of the electronic device 1000 may include obtaining voltage values to be applied to the plurality of lenses, respectively, based on the determined focal lengths of the plurality of lenses (S340).

In an embodiment of the disclosure, the operating method of the electronic device 1000 may include providing an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses (S350).

In an embodiment of the disclosure, the determining of the focal lengths of the plurality of lenses (S330) may include determining a focal length of a first lens in a first lens area corresponding to the first depth area so as to allow a focal plane in the first lens area to be set at the display (110).

In an embodiment of the disclosure, the determining of the focal lengths of the plurality of lenses (S330) may include determining a focal length of a second lens in a second lens area corresponding to the second depth area so as to allow a focal plane in the second lens area to be set closer to a viewer than the display (110).

In an embodiment of the disclosure, the determining of the focal lengths of the plurality of lenses (S330) may include determining a focal length of a third lens in a third lens area corresponding to the third depth area so as to allow a focal plane in the third lens area to be set farther from the viewer than the display (110).

In an embodiment of the disclosure, the operating method of the electronic device 1000 may include displaying a corrected image obtained by correcting the input image by horizontally flipping an image corresponding to the second depth area in the input image (S810).

In an embodiment of the disclosure, the operating method of the electronic device 1000 may include obtaining a viewing position of a viewer via the eye tracking sensor (S1510).

In an embodiment of the disclosure, the operating method of the electronic device 1000 may include obtaining, based on the viewing position, off-axis angles at the plurality of lenses with respect to a ray that reaches the plurality of lenses from the viewing position (S1520).

In an embodiment of the disclosure, the operating method of the electronic device 1000 may include correcting the focal lengths of the plurality of lenses, based on the off-axis angles at the plurality of lenses (S1530).

In an embodiment of the disclosure, the operating method of the electronic device 1000 may include, based on movement of at least one object in consecutive frames included in the input image, changing a range of the plurality of depth areas in one or more frames among the consecutive frames (S1010).

In an embodiment of the disclosure, the lens array 120 may further include a first electrode layer and a second electrode layer facing each other with the plurality of lenses therebetween. In an embodiment of the disclosure, at least one of the first electrode layer or the second electrode layer may include a plurality of segmented electrodes.

In an embodiment of the disclosure, the providing of the image represented in the multiple depths over the plurality of different focal planes, by applying the voltage to each of the plurality of lenses, based on the voltage values to be respectively applied to the plurality of lenses (S350) may include applying, to at least one segmented electrode, a median value of a plurality of voltage values corresponding to at least two lenses, wherein the at least one segmented electrode overlaps the at least two lenses determined to have different focal lengths among the plurality of segmented electrodes (S1710).

In an embodiment of the disclosure, the electronic device 1000 may further include the polarization control array 150 arranged between the display 110 and the lens array 120 and configured to control a polarization direction of light provided from the display 110.

In an embodiment of the disclosure, the operating method of the electronic device 1000 may include controlling whether to change a liquid-crystal alignment in the polarization control array 150 according to an area of the polarization control array 150, so as to determine whether to perform 2D or 3D representation in the image.

In an embodiment of the disclosure, the operating method of the electronic device 1000 may include controlling focal lengths of the plurality of lenses in the lens array 120 with respect to each of the plurality of lenses so as to determine respective depths of the focal planes onto which the image is projected.

In order to solve the above-described technical issues, there may be provided a computer-readable recording medium having recorded thereon a program for causing a computer to execute an operating method of an electronic device according to at least one of embodiments of the disclosure.

A program executable by the electronic device described in the disclosure may be implemented as a hardware element, a software element, and/or a combination of hardware elements and software elements The program is executable by any system capable of executing computer-readable instructions.

The software may include a computer program, code, instructions, or a combination of one or more thereof, and may configure the processor to operate as desired or may independently or collectively instruct the processor.

The software may be implemented as a computer program that includes instructions stored in computer-readable storage media. The computer-readable storage media may include, for example, magnetic storage media (e.g., a read-only memory (ROM), a random-access memory (RAM), floppy disks, hard disks, etc.) and optical storage media (e.g., a compact disc ROM (CD-ROM), a digital versatile disc (DVD), etc.). The computer-readable recording medium may be distributed in computer systems connected via a network and may store and execute computer-readable code in a distributed manner. The recording medium is readable by a computer, stored in a memory, and executable by a processor.

The computer-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

The program according to embodiments of the disclosure may be included and provided in a computer program product. The computer program product may be traded as a product between a seller and a buyer.

The computer program product may include a software program and a computer-readable recording medium storing the software program. For example, the computer program product may include a product (e.g., a downloadable application) in the form of a software program electronically distributed via a manufacturer of the electronic device or an electronic market (e.g., Samsung Galaxy Store). For electronic distribution, at least part of the software program may be stored in a storage medium or temporarily generated. In this case, the storage medium may be a storage medium of a server of the manufacturer of the electronic device, a server of the electronic market, or a relay server that temporarily stores the software program.

Although embodiments of the disclosure have been described with the limited embodiments and the drawings, various modifications and changes may be made by one of skill in the art from the above descriptions. For example, appropriate results may be obtained even when the described techniques are performed in a different order, or when elements in a described electronic device, architecture, device, or circuit are coupled or combined in a different manner, or replaced or supplemented by other elements or their equivalents.

What is claimed is:

1. An electronic device for providing a three-dimensional (3D) image, the electronic device comprising:
a display;
a lens array comprising a plurality of lenses;
at least one processor; and
memory storing a plurality of instructions,
wherein the plurality of instructions, when executed by the at least one processor individually or collectively, cause the electronic device to:
obtain a depth map corresponding to an input image,
segment the depth map into a plurality of depth areas,
determine, based on a lens formula, focal lengths of a plurality of lenses corresponding to each of the plurality of depth areas,
obtain voltage values to be applied to the plurality of lenses, respectively, based on the determined focal lengths of the plurality of lenses, and
provide an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

2. The electronic device of claim 1, wherein the plurality of depth areas comprise at least two of a first depth area corresponding to a reference point, a second depth area having a depth less than the reference point, or a third depth area having a depth greater than the reference point, and
the plurality of instructions, when executed by the at least one processor individually or collectively, cause the electronic device to:
determine a focal length of a first lens in a first lens area corresponding to the first depth area to allow a focal plane in the first lens area to be set at the display,
determine a focal length of a second lens in a second lens area corresponding to the second depth area to allow a focal plane in the second lens area to be set closer to a viewer than the display, and
determine a focal length of a third lens in a third lens area corresponding to the third depth area to allow a focal plane in the third lens area to be set farther from the viewer than the display.

3. The electronic device of claim 2, wherein the plurality of instructions, when executed by the at least one processor individually or collectively, cause the electronic device to display a corrected image obtained by correcting the input image by horizontally flipping an image corresponding to the second depth area in the input image.

4. The electronic device of claim 1, further comprising an eye tracking sensor, and
wherein the plurality of instructions, when executed by the at least one processor individually or collectively, cause the electronic device to:
obtain a viewing position of a viewer via the eye tracking sensor,
obtain, based on the viewing position, off-axis angles at the plurality of lenses with respect to light that reaches the plurality of lenses from the viewing position, and
correct the focal lengths of the plurality of lenses based on the off-axis angles at the plurality of lenses.

5. The electronic device of claim 4, wherein the plurality of instructions, when executed by the at least one processor individually or collectively, cause the electronic device to, based on the off-axis angles at the plurality of lenses, perform a correction to increase a focal length of each of the plurality of lenses as a corresponding off-axis angle increases.

6. The electronic device of claim 1, wherein the plurality of instructions, when executed by the at least one processor individually or collectively, cause the electronic device to, based on movement of at least one object in consecutive frames comprised in the input image, change a range of the plurality of depth areas in one or more frames among the consecutive frames.

7. The electronic device of claim 1, wherein the plurality of instructions, when executed by the at least one processor individually or collectively, cause the electronic device to change the range of the plurality of depth areas or change a depth area corresponding to a reference point based on a user input of adjusting a strength of a 3D effect or a level of a depth of the 3D image.

8. The electronic device of claim 1, wherein
the lens array further comprises a first electrode layer and a second electrode layer facing each other with the plurality of lenses therebetween,
at least one of the first electrode layer or the second electrode layer comprises a plurality of segmented electrodes, and
the plurality of instructions, when executed by the at least one processor individually or collectively, cause the electronic device to apply, to at least one segmented electrode from the plurality of segmented electrodes, a median value of a plurality of voltage values corresponding to at least two lenses, wherein the at least one segmented electrode overlaps the at least two lenses determined to have different focal lengths among the plurality of segmented electrodes.

9. The electronic device of claim 1, wherein the plurality of instructions, when executed by the at least one processor individually or collectively, cause the electronic device to:
identify a first neighboring depth area and a second neighboring depth area that are adjacent to each other and have a depth section difference equal to or greater than a preset depth section difference among the plurality of depth areas,
display a first corrected image obtained by performing correction by excluding, from the input image, an image corresponding to the first neighboring depth area, and
display a second corrected image obtained by performing correction by excluding, from the input image, an image corresponding to the second neighboring depth area.

10. The electronic device of claim 1, further comprising a polarization control array arranged between the display and the lens array and configured to control a polarization direction of light provided from the display, and
wherein the plurality of instructions, when executed by the at least one processor individually or collectively, cause the electronic device to:
control whether to change a liquid-crystal alignment in the polarization control array according to an area of the polarization control array to determine whether to perform two-dimensional (2D) or three-dimensional (3D) representation in the image, and
control focal lengths of the plurality of lenses in the lens array with respect to each of the plurality of lenses so as to determine respective depths of the focal planes onto which the image is projected.

11. The electronic device of claim 1, wherein the plurality of lenses are arrayed in each of a first direction and a second direction perpendicular to the first direction.

12. The electronic device of claim 1, wherein the plurality of instructions, when executed by the at least one processor individually or collectively, cause the electronic device to:
determine, based on the lens formula, a focal length for each area of one or more lenses, respectively, corresponding to the plurality of depth areas,
obtain voltage values to be applied, respectively, to areas of the one or more lenses, based on focal lengths of the areas of the one or more lenses, and
apply a voltage to each of the plurality of lenses, based on the voltage values to be applied respectively to the areas of the one or more lenses.

13. An operating method of an electronic device for providing a three-dimensional (3D) image and comprising a display and a lens array comprising a plurality of lenses, the operating method comprising:
obtaining a depth map corresponding to an input image;
segmenting the depth map into a plurality of depth areas, based on a plurality of depth sections;
determining, based on a lens formula, focal lengths of a plurality of lenses corresponding to each of the plurality of depth areas;
obtaining voltage values to be applied to the plurality of lenses, respectively, based on the determined focal lengths of the plurality of lenses; and
providing an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.

14. The operating method of claim 13, wherein
the plurality of depth areas comprise at least two of a first depth area corresponding to a reference point, a second depth area having a depth less than the reference point, or a third depth area having a depth greater than the reference point, and
the determining of the focal lengths of the plurality of lenses comprises:
determining a focal length of a first lens in a first lens area corresponding to the first depth area to allow a focal plane in the first lens area to be set at the display;
determining a focal length of a second lens in a second lens area corresponding to the second depth area to allow a focal plane in the second lens area to be set closer to a viewer than the display; and
determining a focal length of a third lens in a third lens area corresponding to the third depth area to allow a focal plane in the third lens area to be set farther from the viewer than the display.

15. The operating method of claim 14, further comprising:
displaying a corrected image obtained by correcting the input image by horizontally flipping an image corresponding to the second depth area in the input image.

16. The operating method of claim 13, wherein
the electronic device further comprises an eye tracking sensor, and
the operating method further comprises:
obtaining a viewing position of a viewer via the eye tracking sensor;
obtaining, based on the viewing position, off-axis angles at the plurality of lenses with respect to a ray that reaches the plurality of lenses from the viewing position; and
correcting the focal lengths of the plurality of lenses, based on the off-axis angles at the plurality of lenses.

17. The operating method of claim 13, further comprising:
based on movement of at least one object in consecutive frames comprised in the input image, changing a range of the plurality of depth areas in some frames among the consecutive frames.

18. The operating method of claim 13, wherein
the lens array further comprises a first electrode layer and a second electrode layer facing each other with the plurality of lenses therebetween,
at least one of the first electrode layer or the second electrode layer comprises a plurality of segmented electrodes, and
the providing of the image represented in the multiple depths over the plurality of different focal planes, by applying the voltage to each of the plurality of lenses, based on the voltage values to be respectively applied to the plurality of lenses comprises:
applying, to at least one segmented electrode from the plurality of segmented electrodes, a median value of a plurality of voltage values corresponding to at least two lenses, wherein the at least one segmented electrode overlaps the at least two lenses determined to have different focal lengths among the plurality of segmented electrodes.

19. The operating method of claim 13, wherein
the electronic device further comprises a polarization control array arranged between the display and the lens array and configured to control a polarization direction of light provided from the display, and
the operating method further comprises:
controlling whether to change a liquid-crystal alignment in the polarization control array according to an area of the polarization control array, so as to determine whether to perform two-dimensional (2D) or three-dimensional (3D) representation in the image; and
controlling focal lengths of the plurality of lenses in the lens array with respect to each of the plurality of lenses so as to determine respective depths of the focal planes onto which the image is projected.

20. A non-transitory computer-readable recording medium having instructions stored therein, which when executed by a processor in an electronic device cause the electronic device to execute a method comprising:
obtaining a depth map corresponding to an input image;
segmenting the depth map into a plurality of depth areas, based on a plurality of depth sections;
determining, based on a lens formula, focal lengths of a plurality of lenses corresponding to each of the plurality of depth areas;
obtaining voltage values to be applied to the plurality of lenses, respectively, based on the determined focal lengths of the plurality of lenses; and
providing an image represented in multiple depths over a plurality of different focal planes, by controlling, for each of the plurality of lenses, a refraction degree of light passing through the plurality of lenses, by applying a voltage to each of the plurality of lenses, based on the voltage values to be respectively applied to the plurality of lenses.
